(19) United States
(12) Patent Application Publication
(10) Pub. No.: US 2026/0100039 A1
(43) Pub. Date: Apr. 9, 2026

(54) TECHNIQUES FOR MANAGING SENSOR DATA

(71) Applicant: Apple Inc., Cupertino, CA (US)

(72) Inventors: Kartik NARANG, Fremont, CA (US); Zaka U. ASHRAF, Pleasanton, CA (US); Michael A. BEBENITA, San Francisco, CA (US)

(21) Appl. No.: 19/348,494

(22) Filed: Oct. 2, 2025

Related U.S. Application Data
(60) Provisional application No. 63/703,692, filed on Oct. 4, 2024.
(60) Provisional application No. 63/719,521, filed on Nov. 12, 2024.
(60) Provisional application No. 63/754,452, filed on Feb. 5, 2025.
(60) Provisional application No. 63/819,347, filed on Jun. 6, 2025.

(51) Int. Cl. G06V 20/40; G06V 20/52; G06V 40/10; G08B 21/04; H04N 5/77; H04N 5/913; H04N 7/18

(52) U.S. Cl. CPC G06V 20/44; G06V 20/52; G06V 40/10; H04N 7/183; G08B 21/043; H04N 5/77; H04N 5/913

(57) ABSTRACT

The present disclosure generally relates to managing sensor data. Some techniques are for a sensor device to manage sensor data in accordance with some embodiments. Other techniques are for a resident device to manage sensor data in accordance with some embodiments. Other techniques are for managing transmission of sensor data in accordance with some embodiments. Other techniques are for storing and/or analyzing motion of encrypted video data. Other techniques are for managing and/or pre-packetizing multi-resolution video streams. Other techniques are for sending a notification of an event in accordance with some embodiments.

Other techniques are for detecting a fall of a subject using acceleration in accordance with some embodiments. Other techniques are for selectively using an object for detecting a fall of a subject in accordance with some embodiments. Other techniques are for performing fall detection on a device based on environment complexity in accordance with some embodiments. Other techniques are for performing position detection of a subject based on a blurred portion in media content in accordance with some embodiments.

### CROSS-REFERENCE TO RELATED APPLICATIONS

This application claims the benefit of U.S. Provisional Patent Application Ser. No. 63/819,347, entitled “TECHNIQUES FOR MANAGING SENSOR DATA” filed Jun. 6, 2025, of U.S. Provisional Patent Application Ser. No. 63/754,452, entitled “TECHNIQUES FOR MANAGING SENSOR DATA” filed Feb. 5, 2025, of U.S. Provisional Patent Application Ser. No. 63/719,521, entitled “TECHNIQUES FOR MANAGING SENSOR DATA” filed Nov. 12, 2024, and to U.S. Provisional Patent Application Ser. No. 63/703,692, entitled “TECHNIQUES FOR MANAGING SENSOR DATA” filed Oct. 4, 2024, which are hereby incorporated by reference in their entireties for all purposes.

### BACKGROUND

Electronic devices are becoming increasingly interconnected. For example, sensor devices are often capturing sensor data and providing such sensor data to one or more other devices. Ensuring that such provision of sensor data is resilient is difficult. Accordingly, there is a need to improve techniques for managing sensor data.

### SUMMARY

Current techniques for managing sensor data are generally ineffective and/or inefficient. For example, some techniques require devices to stream sensor data as sensor data is detected and drop any sensor data that is detected while streaming is not available. This disclosure provides more effective and/or efficient techniques for managing sensor data using examples of a sensor device, a resident device, and a server. It should be recognized that other computer systems can be used with techniques described herein. For example, a sensor device (e.g., a smart watch) can stream sensor data to a user device (e.g., a smart phone) that then stores at least a portion of the sensor data on another user device (e.g., a tablet) using techniques described herein. In addition, techniques optionally complement or replace other techniques for managing sensor data.

Some techniques are described herein for using a circular buffer of a sensor device to temporarily store sensor data after streaming and/or attempting to stream the sensor data to a resident device so that, if at a later time, the resident device requests the sensor data, the sensor data can be provided to the resident device. Other techniques are described herein for a server to hold a source of truth for sensor data that has been analyzed between a source device, a resident device, and/or the server so that the resident device can determine whether the resident device needs to retrieve sensor data from the source device that was previously missed. Other techniques are for detecting a fall of a subject using acceleration of the subject. Other techniques are for selectively using an object for improving confidence of detection of a fall of a subject. Other techniques are for performing fall detection on a device and/or another device based on environment complexity. Other techniques are for performing position detection of a subject based on a blurred portion in media content.

In some embodiments, a method that is performed at a sensor device is described. In some embodiments, the method comprises: capturing sensor data; after capturing the sensor data, streaming, to a resident device separate from the sensor device, the sensor data; after streaming the sensor data, temporarily maintaining, in a buffer of the sensor device, the sensor data; and while temporarily maintaining the sensor data: receiving, from the resident device, a request for the sensor data; and in response to receiving the request for the sensor data, providing, to the resident device, the sensor data.

In some embodiments, a non-transitory computer-readable storage medium storing one or more programs configured to be executed by one or more processors of a sensor device is described. In some embodiments, the one or more programs includes instructions for: capturing sensor data; after capturing the sensor data, streaming, to a resident device separate from the sensor device, the sensor data; after streaming the sensor data, temporarily maintaining, in a buffer of the sensor device, the sensor data; and while temporarily maintaining the sensor data: receiving, from the resident device, a request for the sensor data; and in response to receiving the request for the sensor data, providing, to the resident device, the sensor data.

In some embodiments, a transitory computer-readable storage medium storing one or more programs configured to be executed by one or more processors of a sensor device is described. In some embodiments, the one or more programs includes instructions for: capturing sensor data; after capturing the sensor data, streaming, to a resident device separate from the sensor device, the sensor data; after streaming the sensor data, temporarily maintaining, in a buffer of the sensor device, the sensor data; and while temporarily maintaining the sensor data: receiving, from the resident device, a request for the sensor data; and in response to receiving the request for the sensor data, providing, to the resident device, the sensor data.

In some embodiments, a sensor device is described. In some embodiments, the sensor device comprises one or more processors and memory storing one or more programs configured to be executed by the one or more processors. In some embodiments, the one or more programs includes instructions for: capturing sensor data; after capturing the sensor data, streaming, to a resident device separate from the sensor device, the sensor data; after streaming the sensor data, temporarily maintaining, in a buffer of the sensor device, the sensor data; and while temporarily maintaining the sensor data: receiving, from the resident device, a request for the sensor data; and in response to receiving the request for the sensor data, providing, to the resident device, the sensor data.

In some embodiments, a sensor device is described. In some embodiments, the sensor device comprises means for performing each of the following steps: capturing sensor data; after capturing the sensor data, streaming, to a resident device separate from the sensor device, the sensor data; after streaming the sensor data, temporarily maintaining, in a buffer of the sensor device, the sensor data; and while temporarily maintaining the sensor data: receiving, from the resident device, a request for the sensor data; and in response to receiving the request for the sensor data, providing, to the resident device, the sensor data.

In some embodiments, a computer program product is described. In some embodiments, the computer program product comprises one or more programs configured to be executed by one or more processors of a sensor device. In some embodiments, the one or more programs include instructions for: capturing sensor data; after capturing the sensor data, streaming, to a resident device separate from the sensor device, the sensor data; after streaming the sensor data, temporarily maintaining, in a buffer of the sensor device, the sensor data; and while temporarily maintaining the sensor data: receiving, from the resident device, a request for the sensor data; and in response to receiving the request for the sensor data, providing, to the resident device, the sensor data.

In some embodiments, a method that is performed at a resident device is described. In some embodiments, the method comprises: receiving, from a sensor device, a first list of sensor data stored on the sensor device; receiving, from a server, a second list of sensor data; after receiving the first list and the second list: in accordance with a determination that first sensor data identified in the first list is not identified in the second list, obtaining, from the sensor device, the first sensor data; and in accordance with a determination that the first sensor data identified in the first list is identified in the second list, forgoing obtainment of, from the sensor device, the first sensor data; and in response to obtaining the first sensor data after receiving the first list and the second list and in accordance with a determination that a set of one or more criteria is satisfied with respect to the first sensor data, providing, to the server, the first sensor data.

In some embodiments, a non-transitory computer-readable storage medium storing one or more programs configured to be executed by one or more processors of a resident device is described. In some embodiments, the one or more programs includes instructions for: receiving, from a sensor device, a first list of sensor data stored on the sensor device; receiving, from a server, a second list of sensor data; after receiving the first list and the second list: in accordance with a determination that first sensor data identified in the first list is not identified in the second list, obtaining, from the sensor device, the first sensor data; and in accordance with a determination that the first sensor data identified in the first list is identified in the second list, forgoing obtainment of, from the sensor device, the first sensor data; and in response to obtaining the first sensor data after receiving the first list and the second list and in accordance with a determination that a set of one or more criteria is satisfied with respect to the first sensor data, providing, to the server, the first sensor data.

In some embodiments, a transitory computer-readable storage medium storing one or more programs configured to be executed by one or more processors of a resident device is described. In some embodiments, the one or more programs includes instructions for: receiving, from a sensor device, a first list of sensor data stored on the sensor device; receiving, from a server, a second list of sensor data; after receiving the first list and the second list: in accordance with a determination that first sensor data identified in the first list is not identified in the second list, obtaining, from the sensor device, the first sensor data; and in accordance with a determination that the first sensor data identified in the first list is identified in the second list, forgoing obtainment of, from the sensor device, the first sensor data; and in response to obtaining the first sensor data after receiving the first list and the second list and in accordance with a determination that a set of one or more criteria is satisfied with respect to the first sensor data, providing, to the server, the first sensor data.

In some embodiments, a resident device is described. In some embodiments, the resident device comprises one or more processors and memory storing one or more programs configured to be executed by the one or more processors. In some embodiments, the one or more programs includes instructions for: receiving, from a sensor device, a first list of sensor data stored on the sensor device; receiving, from a server, a second list of sensor data; after receiving the first list and the second list: in accordance with a determination that first sensor data identified in the first list is not identified in the second list, obtaining, from the sensor device, the first sensor data; and in accordance with a determination that the first sensor data identified in the first list is identified in the second list, forgoing obtainment of, from the sensor device, the first sensor data; and in response to obtaining the first sensor data after receiving the first list and the second list and in accordance with a determination that a set of one or more criteria is satisfied with respect to the first sensor data, providing, to the server, the first sensor data.

In some embodiments, a resident device is described. In some embodiments, the resident device comprises means for performing each of the following steps: receiving, from a sensor device, a first list of sensor data stored on the sensor device; receiving, from a server, a second list of sensor data; after receiving the first list and the second list: in accordance with a determination that first sensor data identified in the first list is not identified in the second list, obtaining, from the sensor device, the first sensor data; and in accordance with a determination that the first sensor data identified in the first list is identified in the second list, forgoing obtainment of, from the sensor device, the first sensor data; and in response to obtaining the first sensor data after receiving the first list and the second list and in accordance with a determination that a set of one or more criteria is satisfied with respect to the first sensor data, providing, to the server, the first sensor data.

In some embodiments, a computer program product is described. In some embodiments, the computer program product comprises one or more programs configured to be executed by one or more processors of a resident device. In some embodiments, the one or more programs include instructions for: receiving, from a sensor device, a first list of sensor data stored on the sensor device; receiving, from a server, a second list of sensor data; after receiving the first list and the second list: in accordance with a determination that first sensor data identified in the first list is not identified in the second list, obtaining, from the sensor device, the first sensor data; and in accordance with a determination that the first sensor data identified in the first list is identified in the second list, forgoing obtainment of, from the sensor device, the first sensor data; and in response to obtaining the first sensor data after receiving the first list and the second list and in accordance with a determination that a set of one or more criteria is satisfied with respect to the first sensor data, providing, to the server, the first sensor data.

In some embodiments, a method that is performed at a first device including a sensor is described. In some embodiments, the method comprises: capturing, via the sensor, sensor data; after capturing the sensor data, packetizing the sensor data into multiple packets of a first type; in response to packetizing the sensor data into the multiple packets of the first type, storing the multiple packets of the first type; after storing the multiple packets of the first type and without previously transmitting the multiple packets of the first type outside of the first device, receiving, from a second device separate from the first device, a request for sensor data at a particular time; and in response to receiving the request for sensor data at the particular time and in accordance with a determination that a first portion of the multiple packets of the first type corresponds to the request for sensor data at the particular time: packetizing the first portion of the multiple packets of the first type into multiple packets of a second type, wherein the second type is different from the first type; and transmitting, to the second device, the multiple packets of the second type.

In some embodiments, a non-transitory computer-readable storage medium storing one or more programs configured to be executed by one or more processors of a first device including a sensor is described. In some embodiments, the one or more programs includes instructions for: capturing, via the sensor, sensor data; after capturing the sensor data, packetizing the sensor data into multiple packets of a first type; in response to packetizing the sensor data into the multiple packets of the first type, storing the multiple packets of the first type; after storing the multiple packets of the first type and without previously transmitting the multiple packets of the first type outside of the first device, receiving, from a second device separate from the first device, a request for sensor data at a particular time; and in response to receiving the request for sensor data at the particular time and in accordance with a determination that a first portion of the multiple packets of the first type corresponds to the request for sensor data at the particular time: packetizing the first portion of the multiple packets of the first type into multiple packets of a second type, wherein the second type is different from the first type; and transmitting, to the second device, the multiple packets of the second type.

In some embodiments, a transitory computer-readable storage medium storing one or more programs configured to be executed by one or more processors of a first device including a sensor is described. In some embodiments, the one or more programs includes instructions for: capturing, via the sensor, sensor data; after capturing the sensor data, packetizing the sensor data into multiple packets of a first type; in response to packetizing the sensor data into the multiple packets of the first type, storing the multiple packets of the first type; after storing the multiple packets of the first type and without previously transmitting the multiple packets of the first type outside of the first device, receiving, from a second device separate from the first device, a request for sensor data at a particular time; and in response to receiving the request for sensor data at the particular time and in accordance with a determination that a first portion of the multiple packets of the first type corresponds to the request for sensor data at the particular time: packetizing the first portion of the multiple packets of the first type into multiple packets of a second type, wherein the second type is different from the first type; and transmitting, to the second device, the multiple packets of the second type.

In some embodiments, a first device including a sensor is described. In some embodiments, the first device comprises a sensor, one or more processors, and memory storing one or more programs configured to be executed by the one or more processors. In some embodiments, the one or more programs includes instructions for: capturing, via the sensor, sensor data; after capturing the sensor data, packetizing the sensor data into multiple packets of a first type; in response to packetizing the sensor data into the multiple packets of the first type, storing the multiple packets of the first type; after storing the multiple packets of the first type and without previously transmitting the multiple packets of the first type outside of the first device, receiving, from a second device separate from the first device, a request for sensor data at a particular time; and in response to receiving the request for sensor data at the particular time and in accordance with a determination that a first portion of the multiple packets of the first type corresponds to the request for sensor data at the particular time: packetizing the first portion of the multiple packets of the first type into multiple packets of a second type, wherein the second type is different from the first type; and transmitting, to the second device, the multiple packets of the second type.

In some embodiments, a first device including a sensor is described. In some embodiments, the first device comprises means for performing each of the following steps: capturing, via the sensor, sensor data; after capturing the sensor data, packetizing the sensor data into multiple packets of a first type; in response to packetizing the sensor data into the multiple packets of the first type, storing the multiple packets of the first type; after storing the multiple packets of the first type and without previously transmitting the multiple packets of the first type outside of the first device, receiving, from a second device separate from the first device, a request for sensor data at a particular time; and in response to receiving the request for sensor data at the particular time and in accordance with a determination that a first portion of the multiple packets of the first type corresponds to the request for sensor data at the particular time: packetizing the first portion of the multiple packets of the first type into multiple packets of a second type, wherein the second type is different from the first type; and transmitting, to the second device, the multiple packets of the second type.

In some embodiments, a computer program product is described. In some embodiments, the computer program product comprises one or more programs configured to be executed by one or more processors of a first device including a sensor. In some embodiments, the one or more programs include instructions for: capturing, via the sensor, sensor data; after capturing the sensor data, packetizing the sensor data into multiple packets of a first type; in response to packetizing the sensor data into the multiple packets of the first type, storing the multiple packets of the first type; after storing the multiple packets of the first type and without previously transmitting the multiple packets of the first type outside of the first device, receiving, from a second device separate from the first device, a request for sensor data at a particular time; and in response to receiving the request for sensor data at the particular time and in accordance with a determination that a first portion of the multiple packets of the first type corresponds to the request for sensor data at the particular time: packetizing the first portion of the multiple packets of the first type into multiple packets of a second type, wherein the second type is different from the first type; and transmitting, to the second device, the multiple packets of the second type.

In some embodiments, a method that is performed at a first device is described. In some embodiments, the method comprises: detecting, using data received from a second device external to the first device, an event; after detecting, using the data received from the second device, the event, detecting, using data received from a third device external to the first device and the second device, continuation of the event; and after detecting, using the data received from the third device, the continuation of the event, sending, to a fourth device external to the first device, the second device, and the third device, a notification including an indication of the data received from the second device and the data received from the third device.

In some embodiments, a non-transitory computer-readable storage medium storing one or more programs configured to be executed by one or more processors of a first device is described. In some embodiments, the one or more programs includes instructions for: detecting, using data received from a second device external to the first device, an event; after detecting, using the data received from the second device, the event, detecting, using data received from a third device external to the first device and the second device, continuation of the event; and after detecting, using the data received from the third device, the continuation of the event, sending, to a fourth device external to the first device, the second device, and the third device, a notification including an indication of the data received from the second device and the data received from the third device.

In some embodiments, a transitory computer-readable storage medium storing one or more programs configured to be executed by one or more processors of a first device is described. In some embodiments, the one or more programs includes instructions for: detecting, using data received from a second device external to the first device, an event; after detecting, using the data received from the second device, the event, detecting, using data received from a third device external to the first device and the second device, continuation of the event; and after detecting, using the data received from the third device, the continuation of the event, sending, to a fourth device external to the first device, the second device, and the third device, a notification including an indication of the data received from the second device and the data received from the third device.

In some embodiments, a first device is described. In some embodiments, the first device comprises one or more processors and memory storing one or more programs configured to be executed by the one or more processors. In some embodiments, the one or more programs includes instructions for: detecting, using data received from a second device external to the first device, an event; after detecting, using the data received from the second device, the event, detecting, using data received from a third device external to the first device and the second device, continuation of the event; and after detecting, using the data received from the third device, the continuation of the event, sending, to a fourth device external to the first device, the second device, and the third device, a notification including an indication of the data received from the second device and the data received from the third device.

In some embodiments, a first device is described. In some embodiments, the first device comprises means for performing each of the following steps: detecting, using data received from a second device external to the first device, an event; after detecting, using the data received from the second device, the event, detecting, using data received from a third device external to the first device and the second device, continuation of the event; and after detecting, using the data received from the third device, the continuation of the event, sending, to a fourth device external to the first device, the second device, and the third device, a notification including an indication of the data received from the second device and the data received from the third device.

In some embodiments, a computer program product is described. In some embodiments, the computer program product comprises one or more programs configured to be executed by one or more processors of a first device. In some embodiments, the one or more programs include instructions for: detecting, using data received from a second device external to the first device, an event; after detecting, using the data received from the second device, the event, detecting, using data received from a third device external to the first device and the second device, continuation of the event; and after detecting, using the data received from the third device, the continuation of the event, sending, to a fourth device external to the first device, the second device, and the third device, a notification including an indication of the data received from the second device and the data received from the third device.

In some embodiments, a method that is performed at a device is described. In some embodiments, the method comprises: receiving a first position of a subject at a first time and a second position of the subject at a second time different from the first time; and in response to receiving the first position and the second position: in accordance with a determination that a first set of one or more criteria is satisfied, wherein the first set of one or more criteria includes a criterion that is satisfied when a value computed using an acceleration of a set of one or more points between the first position and the second position exceeds a threshold, outputting an indication that the subject has fallen; and in accordance with a determination that a second set of one or more criteria is satisfied, wherein the second set of one or more criteria includes a criterion that is satisfied when the value computed using the acceleration of the set of one or more points between the first position and the second position is below the threshold, forgoing output of the indication that the subject has fallen.

In some embodiments, a non-transitory computer-readable storage medium storing one or more programs configured to be executed by one or more processors of a device is described. In some embodiments, the one or more programs includes instructions for: receiving a first position of a subject at a first time and a second position of the subject at a second time different from the first time; and in response to receiving the first position and the second position: in accordance with a determination that a first set of one or more criteria is satisfied, wherein the first set of one or more criteria includes a criterion that is satisfied when a value computed using an acceleration of a set of one or more points between the first position and the second position exceeds a threshold, outputting an indication that the subject has fallen; and in accordance with a determination that a second set of one or more criteria is satisfied, wherein the second set of one or more criteria includes a criterion that is satisfied when the value computed using the acceleration of the set of one or more points between the first position and the second position is below the threshold, forgoing output of the indication that the subject has fallen.

In some embodiments, a transitory computer-readable storage medium storing one or more programs configured to be executed by one or more processors of a device is described. In some embodiments, the one or more programs includes instructions for: receiving a first position of a subject at a first time and a second position of the subject at a second time different from the first time; and in response to receiving the first position and the second position: in accordance with a determination that a first set of one or more criteria is satisfied, wherein the first set of one or more criteria includes a criterion that is satisfied when a value computed using an acceleration of a set of one or more points between the first position and the second position exceeds a threshold, outputting an indication that the subject has fallen; and in accordance with a determination that a second set of one or more criteria is satisfied, wherein the second set of one or more criteria includes a criterion that is satisfied when the value computed using the acceleration of the set of one or more points between the first position and the second position is below the threshold, forgoing output of the indication that the subject has fallen.

In some embodiments, a device is described. In some embodiments, the device comprises one or more processors and memory storing one or more programs configured to be executed by the one or more processors. In some embodiments, the one or more programs includes instructions for: receiving a first position of a subject at a first time and a second position of the subject at a second time different from the first time; and in response to receiving the first position and the second position: in accordance with a determination that a first set of one or more criteria is satisfied, wherein the first set of one or more criteria includes a criterion that is satisfied when a value computed using an acceleration of a set of one or more points between the first position and the second position exceeds a threshold, outputting an indication that the subject has fallen; and in accordance with a determination that a second set of one or more criteria is satisfied, wherein the second set of one or more criteria includes a criterion that is satisfied when the value computed using the acceleration of the set of one or more points between the first position and the second position is below the threshold, forgoing output of the indication that the subject has fallen.

In some embodiments, a device is described. In some embodiments, the device comprises means for performing each of the following steps: receiving a first position of a subject at a first time and a second position of the subject at a second time different from the first time; and in response to receiving the first position and the second position: in accordance with a determination that a first set of one or more criteria is satisfied, wherein the first set of one or more criteria includes a criterion that is satisfied when a value computed using an acceleration of a set of one or more points between the first position and the second position exceeds a threshold, outputting an indication that the subject has fallen; and in accordance with a determination that a second set of one or more criteria is satisfied, wherein the second set of one or more criteria includes a criterion that is satisfied when the value computed using the acceleration of the set of one or more points between the first position and the second position is below the threshold, forgoing output of the indication that the subject has fallen.

In some embodiments, a computer program product is described. In some embodiments, the computer program product comprises one or more programs configured to be executed by one or more processors of a device. In some embodiments, the one or more programs include instructions for: receiving a first position of a subject at a first time and a second position of the subject at a second time different from the first time; and in response to receiving the first position and the second position: in accordance with a determination that a first set of one or more criteria is satisfied, wherein the first set of one or more criteria includes a criterion that is satisfied when a value computed using an acceleration of a set of one or more points between the first position and the second position exceeds a threshold, outputting an indication that the subject has fallen; and in accordance with a determination that a second set of one or more criteria is satisfied, wherein the second set of one or more criteria includes a criterion that is satisfied when the value computed using the acceleration of the set of one or more points between the first position and the second position is below the threshold, forgoing output of the indication that the subject has fallen.

In some embodiments, a method that is performed at a device including one or more sensors is described. In some embodiments, the method comprises: receiving an indication of a fall of a subject, wherein the indication of the fall of the subject includes a confidence score associated with the fall of the subject; receiving media content; after receiving the media content, detecting, via the one or more sensors, an object associated with the subject, wherein the object is separate from the subject; and after detecting the object associated with the subject: in accordance with a determination that the object is a first object, increasing the confidence score associated with the fall of the subject; and in accordance with a determination that the object is a second object, forgoing increase of the confidence score associated with the fall of the subject, wherein the second object is different from the first object.

In some embodiments, a non-transitory computer-readable storage medium storing one or more programs configured to be executed by one or more processors of a device including one or more sensors is described. In some embodiments, the one or more programs includes instructions for: receiving an indication of a fall of a subject, wherein the indication of the fall of the subject includes a confidence score associated with the fall of the subject; receiving media content; after receiving the media content, detecting, via the one or more sensors, an object associated with the subject, wherein the object is separate from the subject; and after detecting the object associated with the subject: in accordance with a determination that the object is a first object, increasing the confidence score associated with the fall of the subject; and in accordance with a determination that the object is a second object, forgoing increase of the confidence score associated with the fall of the subject, wherein the second object is different from the first object.

In some embodiments, a transitory computer-readable storage medium storing one or more programs configured to be executed by one or more processors of a device including one or more sensors is described. In some embodiments, the one or more programs includes instructions for: receiving an indication of a fall of a subject, wherein the indication of the fall of the subject includes a confidence score associated with the fall of the subject; receiving media content; after receiving the media content, detecting, via the one or more sensors, an object associated with the subject, wherein the object is separate from the subject; and after detecting the object associated with the subject: in accordance with a determination that the object is a first object, increasing the confidence score associated with the fall of the subject; and in accordance with a determination that the object is a second object, forgoing increase of the confidence score associated with the fall of the subject, wherein the second object is different from the first object.

In some embodiments, a device including one or more sensors is described. In some embodiments, the device including one or more sensors comprises one or more processors and memory storing one or more programs configured to be executed by the one or more processors. In some embodiments, the one or more programs includes instructions for: receiving an indication of a fall of a subject, wherein the indication of the fall of the subject includes a confidence score associated with the fall of the subject; receiving media content; after receiving the media content, detecting, via the one or more sensors, an object associated with the subject, wherein the object is separate from the subject; and after detecting the object associated with the subject: in accordance with a determination that the object is a first object, increasing the confidence score associated with the fall of the subject; and in accordance with a determination that the object is a second object, forgoing increase of the confidence score associated with the fall of the subject, wherein the second object is different from the first object.

In some embodiments, a device including one or more sensors is described. In some embodiments, the device including one or more sensors comprises means for performing each of the following steps: receiving an indication of a fall of a subject, wherein the indication of the fall of the subject includes a confidence score associated with the fall of the subject; receiving media content; after receiving the media content, detecting, via the one or more sensors, an object associated with the subject, wherein the object is separate from the subject; and after detecting the object associated with the subject: in accordance with a determination that the object is a first object, increasing the confidence score associated with the fall of the subject; and in accordance with a determination that the object is a second object, forgoing increase of the confidence score associated with the fall of the subject, wherein the second object is different from the first object.

In some embodiments, a computer program product is described. In some embodiments, the computer program product comprises one or more programs configured to be executed by one or more processors of a device including one or more sensors. In some embodiments, the one or more programs include instructions for: receiving an indication of a fall of a subject, wherein the indication of the fall of the subject includes a confidence score associated with the fall of the subject; receiving media content; after receiving the media content, detecting, via the one or more sensors, an object associated with the subject, wherein the object is separate from the subject; and after detecting the object associated with the subject: in accordance with a determination that the object is a first object, increasing the confidence score associated with the fall of the subject; and in accordance with a determination that the object is a second object, forgoing increase of the confidence score associated with the fall of the subject, wherein the second object is different from the first object.

In some embodiments, a method that is performed at a device is described. In some embodiments, the method comprises: receiving media content corresponding to an environment; and in response to receiving the media content corresponding to the environment: in accordance with a determination that the environment has a first level of complexity, locally detecting motion in the environment; and in accordance with a determination that the environment has a second level of complexity, remotely detecting motion in the environment, wherein the first level of complexity is different from the second level of complexity.

In some embodiments, a non-transitory computer-readable storage medium storing one or more programs configured to be executed by one or more processors of a device is described. In some embodiments, the one or more programs includes instructions for: receiving media content corresponding to an environment; and in response to receiving the media content corresponding to the environment: in accordance with a determination that the environment has a first level of complexity, locally detecting motion in the environment; and in accordance with a determination that the environment has a second level of complexity, remotely detecting motion in the environment, wherein the first level of complexity is different from the second level of complexity.

In some embodiments, a transitory computer-readable storage medium storing one or more programs configured to be executed by one or more processors of a device is described. In some embodiments, the one or more programs includes instructions for: receiving media content corresponding to an environment; and in response to receiving the media content corresponding to the environment: in accordance with a determination that the environment has a first level of complexity, locally detecting motion in the environment; and in accordance with a determination that the environment has a second level of complexity, remotely detecting motion in the environment, wherein the first level of complexity is different from the second level of complexity.

In some embodiments, a device is described. In some embodiments, the device comprises one or more processors and memory storing one or more programs configured to be executed by the one or more processors. In some embodiments, the one or more programs includes instructions for: receiving media content corresponding to an environment; and in response to receiving the media content corresponding to the environment: in accordance with a determination that the environment has a first level of complexity, locally detecting motion in the environment; and in accordance with a determination that the environment has a second level of complexity, remotely detecting motion in the environment, wherein the first level of complexity is different from the second level of complexity.

In some embodiments, a device is described. In some embodiments, the device comprises means for performing each of the following steps: receiving media content corresponding to an environment; and in response to receiving the media content corresponding to the environment: in accordance with a determination that the environment has a first level of complexity, locally detecting motion in the environment; and in accordance with a determination that the environment has a second level of complexity, remotely detecting motion in the environment, wherein the first level of complexity is different from the second level of complexity.

In some embodiments, a computer program product is described. In some embodiments, the computer program product comprises one or more programs configured to be executed by one or more processors of a device. In some embodiments, the one or more programs include instructions for: receiving media content corresponding to an environment; and in response to receiving the media content corresponding to the environment: in accordance with a determination that the environment has a first level of complexity, locally detecting motion in the environment; and in accordance with a determination that the environment has a second level of complexity, remotely detecting motion in the environment, wherein the first level of complexity is different from the second level of complexity.

In some embodiments, a method that is performed at a device is described. In some embodiments, the method comprises: receiving media content; in response to receiving the media content, deblurring the media content to generate deblurred content such that: in accordance with a determination that a first portion of the media content is blurred, deblurring the first portion of the media content; and in accordance with a determination that a second portion of the media content is blurred, deblurring the second portion of the media content, wherein the first portion of the media content is separate from the second portion of the media content; and after deblurring the media content, identifying, using the deblurred content, a pose of a subject.

In some embodiments, a non-transitory computer-readable storage medium storing one or more programs configured to be executed by one or more processors of a device is described. In some embodiments, the one or more programs includes instructions for: receiving media content; in response to receiving the media content, deblurring the media content to generate deblurred content such that: in accordance with a determination that a first portion of the media content is blurred, deblurring the first portion of the media content; and in accordance with a determination that a second portion of the media content is blurred, deblurring the second portion of the media content, wherein the first portion of the media content is separate from the second portion of the media content; and after deblurring the media content, identifying, using the deblurred content, a pose of a subject.

In some embodiments, a transitory computer-readable storage medium storing one or more programs configured to be executed by one or more processors of a device is described. In some embodiments, the one or more programs includes instructions for: receiving media content; in response to receiving the media content, deblurring the media content to generate deblurred content such that: in accordance with a determination that a first portion of the media content is blurred, deblurring the first portion of the media content; and in accordance with a determination that a second portion of the media content is blurred, deblurring the second portion of the media content, wherein the first portion of the media content is separate from the second portion of the media content; and after deblurring the media content, identifying, using the deblurred content, a pose of a subject.

In some embodiments, a device is described. In some embodiments, the device comprises one or more processors and memory storing one or more programs configured to be executed by the one or more processors. In some embodiments, the one or more programs includes instructions for: receiving media content; in response to receiving the media content, deblurring the media content to generate deblurred content such that: in accordance with a determination that a first portion of the media content is blurred, deblurring the first portion of the media content; and in accordance with a determination that a second portion of the media content is blurred, deblurring the second portion of the media content, wherein the first portion of the media content is separate from the second portion of the media content; and after deblurring the media content, identifying, using the deblurred content, a pose of a subject.

In some embodiments, a device is described. In some embodiments, the device comprises means for performing each of the following steps: receiving media content; in response to receiving the media content, deblurring the media content to generate deblurred content such that: in accordance with a determination that a first portion of the media content is blurred, deblurring the first portion of the media content; and in accordance with a determination that a second portion of the media content is blurred, deblurring the second portion of the media content, wherein the first portion of the media content is separate from the second portion of the media content; and after deblurring the media content, identifying, using the deblurred content, a pose of a subject.

In some embodiments, a computer program product is described. In some embodiments, the computer program product comprises one or more programs configured to be executed by one or more processors of a device. In some embodiments, the one or more programs include instructions for: receiving media content; in response to receiving the media content, deblurring the media content to generate deblurred content such that: in accordance with a determination that a first portion of the media content is blurred, deblurring the first portion of the media content; and in accordance with a determination that a second portion of the media content is blurred, deblurring the second portion of the media content, wherein the first portion of the media content is separate from the second portion of the media content; and after deblurring the media content, identifying, using the deblurred content, a pose of a subject.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1A is a block diagram illustrating a compute system in accordance with some embodiments.

FIGS. 1B-1G illustrate the use of Application Programming Interfaces (APIs) to perform operations in accordance with some embodiments.

FIG. 2 is a block diagram illustrating a device with interconnected subsystems in accordance with some embodiments.

FIG. 3 is a flow diagram illustrating a process for a sensor device to manage sensor data in accordance with some embodiments.

FIG. 4 is a flow diagram illustrating a process for a resident device to manage sensor data in accordance with some embodiments.

FIG. 5 is a flow diagram illustrating a process for managing transmission of sensor data in accordance with some embodiments.

FIG. 6 is a block diagram illustrating a system for managing video data in accordance with some embodiments.

FIG. 7 is a block diagram illustrating a process for storing and managing encrypted video segments in accordance with some embodiments.

FIG. 8 is a block diagram illustrating a process for managing multi-resolution video streams in accordance with some embodiments.

FIG. 9 is a block diagram illustrating a process for pre-packetizing and storing encrypted video data in accordance with some embodiments.

FIG. 10 illustrates exemplary user interfaces for detecting an event from sensor data in accordance with some embodiments.

FIG. 11 is a flow diagram illustrating a process for sending a notification of an event in accordance with some embodiments.

FIG. 12 illustrates exemplary processes for detecting that a subject has fallen in accordance with some embodiments.

FIG. 13 illustrates exemplary bounding areas of a subject in accordance with some embodiments.

FIG. 14 illustrates exemplary key point configurations and coordinate relationships in accordance with some embodiments.

FIG. 15 illustrates exemplary object detection results in accordance with some embodiments.

FIG. 16 illustrates an exemplary process for performing fall detection based on environment complexity in accordance with some embodiments.

FIGS. 17A-17C illustrate exemplary position detection using key points after unblurring a blurred portion in accordance with some embodiments.

FIG. 18 is a flow diagram illustrating a process for detecting a fall of a subject using acceleration in accordance with some embodiments.

FIG. 19 is a flow diagram illustrating a process for selectively using an object for detecting a fall of a subject in accordance with some embodiments.

FIG. 20 is a flow diagram illustrating a process for performing motion detection on a device based on environment complexity in accordance with some embodiments.

FIG. 21 is a flow diagram illustrating a process for performing position detection of a subject based on a blurred portion in media content in accordance with some embodiments.

### DETAILED DESCRIPTION

The following description sets forth exemplary processes, parameters, and the like. It should be recognized, however, that such description is not intended as a limitation on the scope of the present disclosure but is instead provided as a description of exemplary embodiments.

Processes described herein can include one or more steps that are contingent upon one or more conditions being satisfied. It should be understood that a process can occur over multiple iterations of the same process with different steps of the process being satisfied in different iterations. For example, if a process requires performing a first step upon a determination that a set of one or more criteria is met and a second step upon a determination that the set of one or more criteria is not met, a person of ordinary skill in the art would appreciate that the steps of the process are repeated until both conditions, in no particular order, are satisfied. Thus, a process described with steps that are contingent upon a condition being satisfied can be rewritten as a process that is repeated until each of the conditions described in the process are satisfied. This, however, is not required of system or computer readable medium claims where the system or computer readable medium claims include instructions for performing one or more steps that are contingent upon one or more conditions being satisfied. Because the instructions for the system or computer readable medium claims are stored in one or more processors and/or at one or more memory locations, the system or computer readable medium claims include logic that can determine whether the one or more conditions have been satisfied without explicitly repeating steps of a process until all of the conditions upon which steps in the process are contingent have been satisfied. A person having ordinary skill in the art would also understand that, similar to a process with contingent steps, a system or computer readable storage medium can repeat the steps of a process as many times as needed to ensure that all of the contingent steps have been performed.

Although the following description uses terms “first,” “second,” etc. to describe various elements, these elements should not be limited by the terms. In some embodiments, these terms are used to distinguish one element from another. For example, a first subsystem could be termed a second subsystem, and, similarly, a second subsystem device or a subsystem device could be termed a first subsystem device, without departing from the scope of the various described embodiments. In some embodiments, the first subsystem and the second subsystem are two separate references to the same subsystem. In some embodiments, the first subsystem and the second subsystem are both subsystems, but they are not the same subsystem or the same type of subsystem.

The terminology used in the description of the various described embodiments herein is for the purpose of describing particular embodiments only and is not intended to be limiting.

As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when,” “upon,” “in response to determining,” “in response to detecting,” or “in accordance with a determination that” depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” or “in accordance with a determination that [the stated condition or event]” depending on the context.

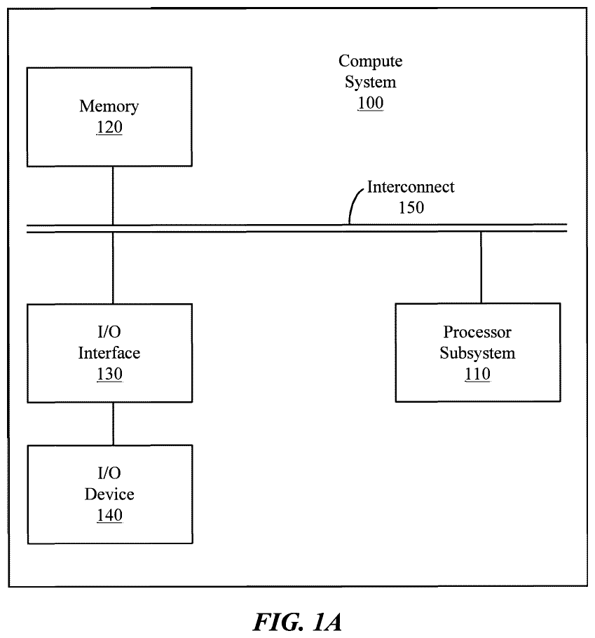

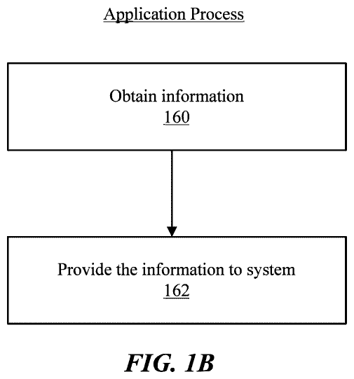

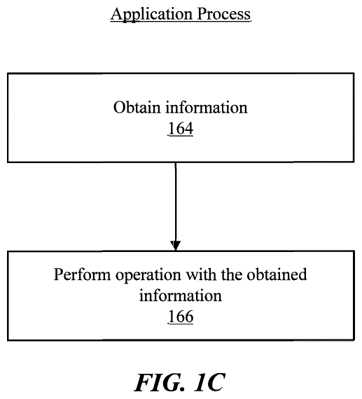

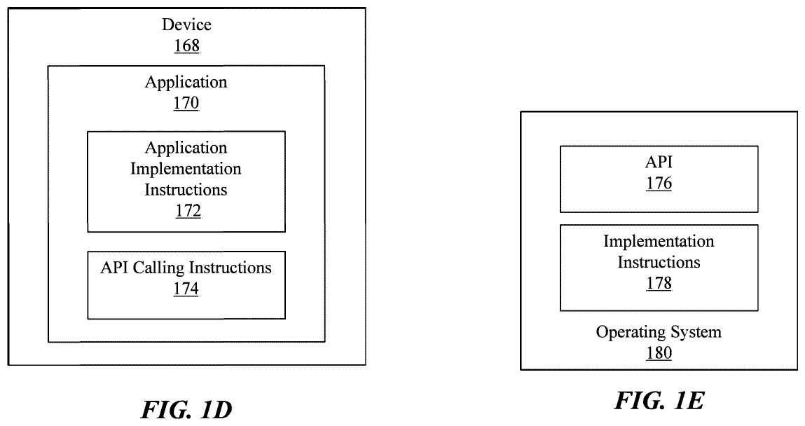

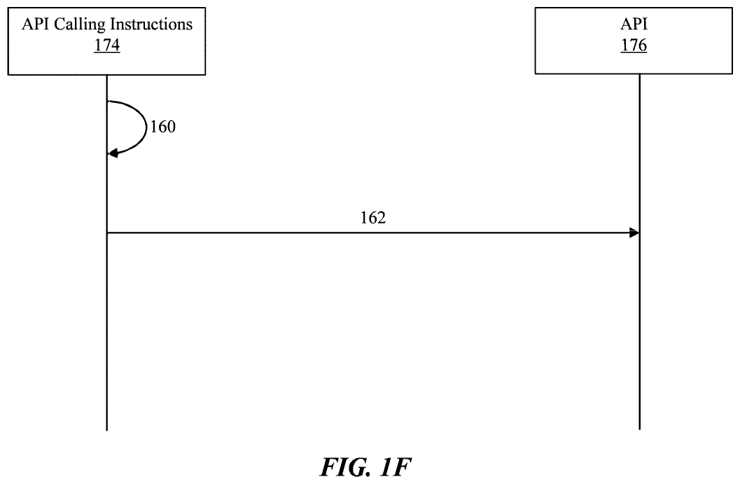

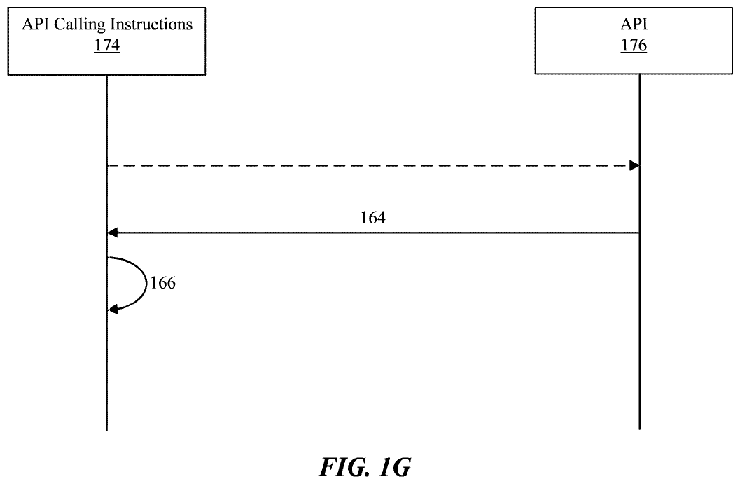

Turning to FIG. 1A, a block diagram of compute system 100 is illustrated. Compute system 100 is a non-limiting example of a compute system that can be used to perform functionality described herein. It should be recognized that other computer architectures of a compute system can be used to perform functionality described herein.

In the illustrated example, compute system 100 includes processor subsystem 110 communicating with (e.g., wired or wirelessly) memory 120 (e.g., a system memory) and I/O interface 130 via interconnect 150 (e.g., a system bus, one or more memory locations, or other communication channel for connecting multiple components of compute system 100). In addition, I/O interface 130 is communicating with (e.g., wired or wirelessly) to I/O device 140. In some embodiments, I/O interface 130 is included with I/O device 140 such that the two are a single component. It should be recognized that there can be one or more I/O interfaces, with each I/O interface communicating with one or more I/O devices. In some embodiments, multiple instances of processor subsystem 110 can be communicating via interconnect 150.

Compute system 100 can be any of various types of devices, including, but not limited to, a system on a chip, a server system, a personal computer system (e.g., a smartphone, a smartwatch, a wearable device, a tablet, a laptop computer, and/or a desktop computer), a sensor, or the like. In some embodiments, compute system 100 is included or communicating with a physical component for the purpose of modifying the physical component in response to an instruction. In some embodiments, compute system 100 receives an instruction to modify a physical component and, in response to the instruction, causes the physical component to be modified. In some embodiments, the physical component is modified via an actuator, an electric signal, and/or algorithm. Examples of such physical components include an acceleration control, a break, a gear box, a hinge, a motor, a pump, a refrigeration system, a spring, a suspension system, a steering control, a pump, a vacuum system, and/or a valve. In some embodiments, a sensor includes one or more hardware components that detect information about a physical environment in proximity to (e.g., surrounding) the sensor. In some embodiments, a hardware component of a sensor includes a sensing component (e.g., an image sensor or temperature sensor), a transmitting component (e.g., a laser or radio transmitter), a receiving component (e.g., a laser or radio receiver), or any combination thereof. Examples of sensors include an angle sensor, a chemical sensor, a brake pressure sensor, a contact sensor, a non-contact sensor, an electrical sensor, a flow sensor, a force sensor, a gas sensor, a humidity sensor, an image sensor (e.g., a camera sensor, a radar sensor, and/or a LiDAR sensor), an inertial measurement unit, a leak sensor, a level sensor, a light detection and ranging system, a metal sensor, a motion sensor, a particle sensor, a photoelectric sensor, a position sensor (e.g., a global positioning system), a precipitation sensor, a pressure sensor, a proximity sensor, a radio detection and ranging system, a radiation sensor, a speed sensor (e.g., measures the speed of an object), a temperature sensor, a time-of-flight sensor, a torque sensor, and an ultrasonic sensor. In some embodiments, a sensor includes a combination of multiple sensors. In some embodiments, sensor data is captured by fusing data from one sensor with data from one or more other sensors. Although a single compute system is shown in FIG. 1A, compute system 100 can also be implemented as two or more compute systems operating together.

In some embodiments, processor subsystem 110 includes one or more processors or processing units configured to execute program instructions to perform functionality described herein. For example, processor subsystem 110 can execute an operating system, a middleware system, one or more applications, or any combination thereof.

In some embodiments, the operating system manages resources of compute system 100. Examples of types of operating systems covered herein include batch operating systems (e.g., Multiple Virtual Storage (MVS)), time-sharing operating systems (e.g., Unix), distributed operating systems (e.g., Advanced Interactive executive (AIX), network operating systems (e.g., Microsoft Windows Server), and real-time operating systems (e.g., QNX). In some embodiments, the operating system includes various procedures, sets of instructions, software components, and/or drivers for controlling and managing general system tasks (e.g., memory management, storage device control, power management, or the like) and for facilitating communication between various hardware and software components. In some embodiments, the operating system uses a priority-based scheduler that assigns a priority to different tasks that processor subsystem 110 can execute. In such examples, the priority assigned to a task is used to identify a next task to execute. In some embodiments, the priority-based scheduler identifies a next task to execute when a previous task finishes executing. In some embodiments, the highest priority task runs to completion unless another higher priority task is made ready.

In some embodiments, the middleware system provides one or more services and/or capabilities to applications (e.g., the one or more applications running on processor subsystem 110) outside of what the operating system offers (e.g., data management, application services, messaging, authentication, API management, or the like). In some embodiments, the middleware system is designed for a heterogeneous computer cluster to provide hardware abstraction, low-level device control, implementation of commonly used functionality, message-passing between processes, package management, or any combination thereof. Examples of middleware systems include Lightweight Communications and Marshalling (LCM), PX4, Robot Operating System (ROS), and ZeroMQ. In some embodiments, the middleware system represents processes and/or operations using a graph architecture, where processing takes place in nodes that can receive, post, and multiplex sensor data messages, control messages, state messages, planning messages, actuator messages, and other messages. In such examples, the graph architecture can define an application (e.g., an application executing on processor subsystem 110 as described above) such that different operations of the application are included with different nodes in the graph architecture.

In some embodiments, a message sent from a first node in a graph architecture to a second node in the graph architecture is performed using a publish-subscribe model, where the first node publishes data on a channel in which the second node can subscribe. In such examples, the first node can store data in memory (e.g., memory 120 or some local memory of processor subsystem 110) and notify the second node that the data has been stored in the memory. In some embodiments, the first node notifies the second node that the data has been stored in the memory by sending a pointer (e.g., a memory pointer, such as an identification of a memory location) to the second node so that the second node can access the data from where the first node stored the data. In some embodiments, the first node would send the data directly to the second node so that the second node would not need to access a memory based on data received from the first node.

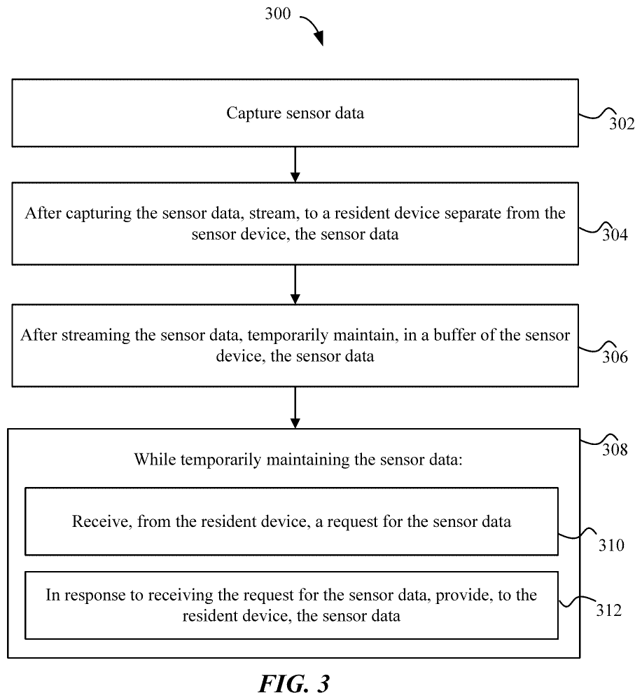

Memory 120 can include a computer readable medium (e.g., non-transitory or transitory computer readable medium) usable to store (e.g., configured to store, assigned to store, and/or that stores) program instructions executable by processor subsystem 110 to cause compute system 100 to perform various operations described herein. For example, memory 120 can store program instructions to implement the functionality associated with processes 300, 400, 500, 1100, 1800, 1900, 2000, 2100 (FIGS. 3-5, 11, and 18-21) described below.

Memory 120 can be implemented using different physical, non-transitory memory media, such as hard disk storage, floppy disk storage, removable disk storage, flash memory, random access memory (RAM-SRAM, EDO RAM, SDRAM, DDR SDRAM, RAMBUS RAM, or the like), read only memory (PROM, EEPROM, or the like), or the like. Memory in compute system 100 is not limited to primary storage such as memory 120. Compute system 100 can also include other forms of storage such as cache memory in processor subsystem 110 and secondary storage on I/O device 140 (e.g., a hard drive, storage array, etc.). In some embodiments, these other forms of storage can also store program instructions executable by processor subsystem 110 to perform operations described herein. In some embodiments, processor subsystem 110 (or each processor within processor subsystem 110) contains a cache or other form of on-board memory.

I/O interface 130 can be any of various types of interfaces configured to communicate with other devices. In some embodiments, I/O interface 130 includes a bridge chip (e.g., Southbridge) from a front-side bus to one or more back-side buses. I/O interface 130 can communicate with one or more I/O devices (e.g., I/O device 140) via one or more corresponding buses or other interfaces. Examples of I/O devices include storage devices (hard drive, optical drive, removable flash drive, storage array, SAN, or their associated controller), network interface devices (e.g., to a local or wide-area network), sensor devices (e.g., camera, radar, LiDAR, ultrasonic sensor, GPS, inertial measurement device, or the like), and auditory or visual output devices (e.g., speaker, light, screen, projector, or the like). In some embodiments, compute system 100 is communicating with a network via a network interface device (e.g., configured to communicate over Wi-Fi, Bluetooth, Ethernet, or the like). In some embodiments, compute system 100 is directly or wired to the network.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, software modules, and/or components.

Implementations within the scope of the present disclosure include a computer-readable storage medium that encodes instructions organized as an application (e.g., application 170) that, when executed by one or more processing units, control an electronic device (e.g., device 168) to perform the process of FIG. 1B, the process of FIG. 1C, and/or one or more other processes and/or processes described herein.

It should be recognized that application 170 (e.g., illustrated in FIG. 1D) can be any suitable type of application, including, for example, one or more of: a browser application, an application that functions as an execution environment for plug-ins, widgets, or other applications, a fitness application, a health application, an accessory management application, a home application, a digital payments application, a media application, a social network application, a messaging application, and/or a maps application. In some embodiments, application 170 is an application that is pre-installed on device 168 at purchase (e.g., a first party application). In some embodiments, application 170 is an application that is provided to device 168 via an operating system update file (e.g., a first party application or a second party application). In other embodiments, application 170 is an application that is provided via an application store. In some embodiments, the application store can be an application store that is pre-installed on device 168 at purchase (e.g., a first party application store). In some embodiments, the application store is a third-party application store (e.g., an application store that is provided by another application store, downloaded via a network, and/or read from a storage device).

Referring to FIG. 1B and FIG. 1F, application 170 obtains information (e.g., 160). In some embodiments, at 160, information is obtained from at least one hardware component of device 168. In some embodiments, at 160, information is obtained from at least one software module (e.g., a set of one more instructions) of device 168. In some embodiments, at 160, information is obtained from at least one hardware component external to device 168 (e.g., a peripheral device, an accessory device, and/or a server). In some embodiments, the information obtained at 160 includes positional information, time information, notification information, user information, environment information, electronic device state information, weather information, media information, historical information, event information, hardware information, and/or motion information. In some embodiments, in response to and/or after obtaining the information at 160, application 170 provides the information to system (e.g., 162).

In some embodiments, the system (e.g., 180 as illustrated in FIG. 1E) is an operating system hosted on device 168. In some embodiments, the system (e.g., 180 as illustrated in FIG. 1E) is an external device (e.g., a server, a peripheral device, an accessory, and/or a personal computing device) that includes an operating system.

Referring to FIG. 1C, application 170 obtains information (e.g., 164). In some embodiments, the information obtained at 164 includes positional information, time information, notification information, user information, environment information electronic device state information, weather information, media information, historical information, event information, hardware information and/or motion information. In response to and/or after obtaining the information at 164, application 170 performs an operation with the information (e.g., 166). In some embodiments, the operation performed at 166 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 180 based on the information.

In some embodiments, one or more steps of the process of FIG. 1B and/or the process of FIG. 1C is performed in response to a trigger. In some embodiments, the trigger includes detection of an event, a notification received from system 180, a user input, and/or a response to a call to an API provided by system 180.

In some embodiments, the instructions of application 170, when executed, control device 168 to perform the process of FIG. 1B and/or the process of FIG. 1C by calling an application programming interface (API) (e.g., API 176) provided by system 180. In some embodiments, application 170 performs at least a portion of the process of FIG. 1B and/or the process of FIG. 1C without calling API 176.

In some embodiments, one or more steps of the process of FIG. 1B and/or the process of FIG. 1C includes calling an API (e.g., API 176) using one or more parameters defined by the API. In some embodiments, the one or more parameters include a constant, a key, a data structure, an object, an object class, a variable, a data type, a pointer, an array, a list or a pointer to a function or a process, and/or another way to reference a data or other item to be passed via the API.

Referring to FIG. 1D, device 168 is illustrated. In some embodiments, device 168 is a personal computing device, a smart phone, a smart watch, a fitness tracker, a head mounted display (HMD) device, a media device, a communal device, a speaker, a television, and/or a tablet. Device 168 includes application 170 and an operating system (not shown) (e.g., system 180 as illustrated in FIG. 1E). Application 170 includes application implementation instructions 172 and API calling instructions 174. System 180 includes API 176 and implementation instructions 178. It should be recognized that device 168, application 170, and/or system 180 can include more, fewer, and/or different components than illustrated in FIGS. 1D and 1E.

In some embodiments, application implementation instructions 172 is a software module that includes a set of one or more computer-readable instructions. In some embodiments, the set of one or more computer-readable instructions correspond to one or more operations performed by application 170. For example, when application 170 is a messaging application, application implementation instructions 172 can include operations to receive and send messages. In some embodiments, application implementation instructions 172 communicates with API calling instructions to communicate with system 180 via API 176 (e.g., as illustrated in FIG. 1E).

In some embodiments, API calling instructions 174 is a software module that includes a set of one or more computer-executable instructions.

In some embodiments, implementation instructions 178 is a software module that includes a set of one or more computer-executable instructions.

In some embodiments, API 176 is a software module that includes a set of one or more computer-executable instructions. In some embodiments, API 176 provides an interface that allows a different set of instructions (e.g., API calling instructions 174) to access and/or use one or more functions, processes, procedures, data structures, classes, and/or other services provided by implementation instructions 178 of system 180. For example, API calling instructions 174 can access a feature of implementation instructions 178 through one or more API calls or invocations (e.g., embodied by a function call, a method call, or a process call) exposed by API 176 and can pass data and/or control information using one or more parameters via the API calls or invocations. In some embodiments, API 176 allows application 170 to use a service provided by a Software Development Kit (SDK) library. In some embodiments, application 170 incorporates a call to a function or process provided by the SDK library and provided by API 176 or uses data types or objects defined in the SDK library and provided by API 176. In some embodiments, API calling instructions 174 makes an API call via API 176 to access and use a feature of implementation instructions 178 that is specified by API 176. In such embodiments, implementation instructions 178 can return a value via API 176 to API calling instructions 174 in response to the API call. The value can report to application 170 the capabilities or state of a hardware component of device 168, including those related to aspects such as input capabilities and state, output capabilities and state, processing capability, power state, storage capacity and state, and/or communications capability. In some embodiments, API 176 is implemented in part by firmware, microcode, or other low level logic that executes in part on the hardware component.

In some embodiments, API 176 allows a developer of API calling instructions 174 (which can be a third-party developer) to leverage a feature provided by implementation instructions 178. In such embodiments, there can be one or more sets of API calling instructions (e.g., including API calling instructions 174) that communicate with implementation instructions 178. In some embodiments, API 176 allows multiple sets of API calling instructions written in different programming languages to communicate with implementation instructions 178 (e.g., API 176 can include features for translating calls and returns between implementation instructions 178 and API calling instructions 174) while API 176 is implemented in terms of a specific programming language. In some embodiments, API calling instructions 174 calls APIs from different providers such as a set of APIs from an OS provider, another set of APIs from a plug-in provider, and/or another set of APIs from another provider (e.g., the provider of a software library) or creator of the another set of APIs.

Examples of API 176 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments the sensor API is an API for accessing data associated with a sensor of device 168. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation instructions 178 is a system (e.g., an operating system and/or a server system) software module (e.g., a collection of computer-readable instructions) that is constructed to perform an operation in response to receiving an API call via API 176. In some embodiments, implementation instructions 178 is constructed to provide an API response (via API 176) as a result of processing an API call. By way of example, implementation instructions 178 and API calling instructions 174 can each be any one of an operating system, a library, a device driver, an API, an application program, or other module. It should be understood that implementation instructions 178 and API calling instructions 174 can be the same or different type of software module from each other. In some embodiments, implementation instructions 178 is embodied at least in part in firmware, microcode, or other hardware logic.

In some embodiments, implementation instructions 178 returns a value through API 176 in response to an API call from API calling instructions 174. While API 176 defines the syntax and result of an API call (e.g., how to invoke the API call and what the API call does), API 176 might not reveal how implementation instructions 178 accomplishes the function specified by the API call. Various API calls are transferred via the one or more application programming interfaces between API calling instructions 174 and implementation instructions 178. Transferring the API calls can include issuing, initiating, invoking, calling, receiving, returning, and/or responding to the function calls or messages. In other words, transferring can describe actions by either of API calling instructions 174 or implementation instructions 178. In some embodiments, a function call or other invocation of API 176 sends and/or receives one or more parameters through a parameter list or other structure.

In some embodiments, implementation instructions 178 provides more than one API, each providing a different view of or with different aspects of functionality implemented by implementation instructions 178. For example, one API of implementation instructions 178 can provide a first set of functions and can be exposed to third party developers, and another API of implementation instructions 178 can be hidden (e.g., not exposed) and provide a subset of the first set of functions and also provide another set of functions, such as testing or debugging functions which are not in the first set of functions. In some embodiments, implementation instructions 178 calls one or more other components via an underlying API and thus be both an API calling instructions and an implementation instructions. It should be recognized that implementation instructions 178 can include additional functions, processes, classes, data structures, and/or other features that are not specified through API 176 and are not available to API calling instructions 174. It should also be recognized that API calling instructions 174 can be on the same system as implementation instructions 178 or can be located remotely and access implementation instructions 178 using API 176 over a network. In some embodiments, implementation instructions 178, API 176, and/or API calling instructions 174 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

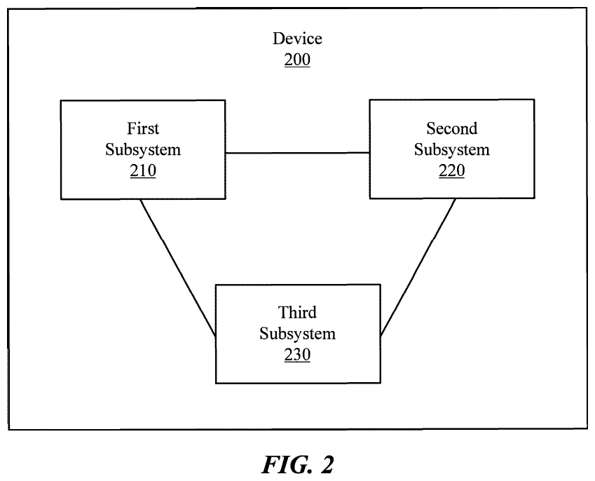

FIG. 2 illustrates a block diagram of device 200 with interconnected subsystems. In the illustrated example, device 200 includes three different subsystems (i.e., first subsystem 210, second subsystem 220, and third subsystem 230) communicating with (e.g., wired or wirelessly) each other, creating a network (e.g., a personal area network, a local area network, a wireless local area network, a metropolitan area network, a wide area network, a storage area network, a virtual private network, an enterprise internal private network, a campus area network, a system area network, and/or a controller area network). An example of a possible computer architecture of a subsystem as included in FIG. 2 is described in FIG. 1A (i.e., compute system 100). Although three subsystems are shown in FIG. 2, device 200 can include more or fewer subsystems.

In some embodiments, some subsystems are not connected to other subsystem (e.g., first subsystem 210 can be connected to second subsystem 220 and third subsystem 230 but second subsystem 220 cannot be connected to third subsystem 230). In some embodiments, some subsystems are connected via one or more wires while other subsystems are wirelessly connected. In some embodiments, messages are set between the first subsystem 210, second subsystem 220, and third subsystem 230, such that when a respective subsystem sends a message the other subsystems receive the message (e.g., via a wire and/or a bus). In some embodiments, one or more subsystems are wirelessly connected to one or more compute systems outside of device 200, such as a server system. In such examples, the subsystem can be configured to communicate wirelessly to the one or more compute systems outside of device 200.

In some embodiments, device 200 includes a housing that fully or partially encloses subsystems 210-230. Examples of device 200 include a home-appliance device (e.g., a refrigerator or an air conditioning system), a robot (e.g., a robotic arm or a robotic vacuum), and a vehicle. In some embodiments, device 200 is configured to navigate (with or without user input) in a physical environment.

In some embodiments, one or more subsystems of device 200 are used to control, manage, and/or receive data from one or more other subsystems of device 200 and/or one or more compute systems remote from device 200. For example, first subsystem 210 and second subsystem 220 can each be a camera that captures images, and third subsystem 230 can use the captured images for decision making. In some embodiments, at least a portion of device 200 functions as a distributed compute system. For example, a task can be split into different portions, where a first portion is executed by first subsystem 210 and a second portion is executed by second subsystem 220.

Attention is now directed towards techniques for managing sensor data. Such techniques are described in the context of a camera streaming video to a resident device in a local area network that, when events occur in the video, providing portions of the video to a server for storage. It should be recognized that other types of sensor devices can be used with techniques described herein. For example, a device with a microphone can act as a sensor device using techniques described herein. In addition, techniques optionally complement or replace other techniques for managing sensor data.

FIG. 3 is a flow diagram illustrating a process (e.g., process 300) for a sensor device to manage sensor data in accordance with some embodiments. Some operations in process 300 are, optionally, combined, the orders of some operations are, optionally, changed, and some operations are, optionally, omitted.

As described below, process 300 provides an intuitive way for a sensor device to manage sensor data. Process 300 reduces the cognitive burden on a user, thereby creating a more efficient human-machine interface. For battery-operated computing devices, enabling a user to interact with such devices faster and more efficiently conserves power and increases the time between battery charges.

In some embodiments, process 300 is performed at a sensor device (e.g., a computer system, an electronic device, a camera, a microphone, a gyroscope, a light sensor, a proximity sensor, a humidity sensor, a temperature sensor, an accelerometer, an infrared sensor, and/or a pressure sensor).

The sensor device captures (302) (e.g., detects, obtains, and/or senses) sensor data (e.g., an image, a video, an audio recording, orientation data, light data, proximity data, humidity data, temperature data, accelerometer data, infrared data, and/or pressure data).

After (and/in response to) capturing the sensor data, the sensor device streams (304) (e.g., sends, transmits, and/or provides) (and/or attempts to stream, send, transmit and/or provide), to a resident device (e.g., an electronic device, a computer system, a user device, a commissioning device, a communal device, an accessory device, and/or a controller device) separate from the sensor device, the sensor data. In some embodiments, the sensor device is in communication with the resident device while streaming the sensor data to the resident device, such as in communication via a short-range communication channel or a long-range communication channel. In some embodiments, the sensor device is in communication with the resident device while streaming the sensor data to the resident device via a network, such as an Internet network, a cellular network, a wired network, a wireless network, a WiFi network, and/or a Thread network.

After streaming (and/or attempting to stream, send, transmit and/or provide) the sensor data, the sensor device temporarily maintains (306) (e.g., stores, backs up, and/or forgoes deletion), in a buffer (e.g., a storage location, memory, volatile memory, random access memory, long-term memory, permanent memory, and/or non-volatile memory) of the sensor device, the sensor data. In some embodiments, in response to capturing the sensor data, the sensor device stores the sensor data in the buffer. In some embodiments, after streaming (and/or attempting to stream, send, transmit and/or provide) the sensor data, the sensor device maintains (e.g., stores, backs up, and/or forgoes deletion), in the buffer of the sensor device, the sensor data for a predefined period of time (e.g., thirty minutes to two days) and/or until an event occurs, such as enough data is stored in the buffer such that a location corresponding to the sensor data is overwritten because there is no other room. In some embodiments, after streaming (and/or attempting to stream, send, transmit and/or provide) the sensor data, the sensor device temporarily maintains (e.g., stores, backs up, and/or forgoes deletion), in a storage location external to the sensor device, the sensor data, such as a server and/or another device separate from the sensor device.

While (308) temporarily maintaining the sensor data, the sensor device receives (310), from the resident device, a request for the sensor data. In some embodiments, the request for the sensor data includes an identification corresponding to the sensor data. In some embodiments, the request for the sensor data does not include an identification corresponding to the sensor data.

While (308) temporarily maintaining the sensor data, in response to receiving the request for the sensor data, the sensor device provides (312) (e.g., sends, transmits, and/or streams), to the resident device, the sensor data (e.g., from the buffer). In some embodiments, after providing the sensor data to the resident device, the sensor device deletes the sensor data (e.g., from the buffer). In some embodiments, after providing the sensor data to the resident device, the sensor device continues to maintain the sensor data in the buffer.

In some embodiments, the sensor data is first sensor data. In some embodiments, the buffer is a first buffer. In some embodiments, the sensor device captures (e.g., detects, obtains, and/or senses) second sensor data (e.g., an image, a video, an audio recording, orientation data, light data, proximity data, humidity data, temperature data, accelerometer data, infrared data, and/or pressure data), wherein the second sensor data is separate from the first sensor data. In some embodiments, in response to capturing the second sensor data, in accordance with a determination that the resident device is active (e.g., is present, available, and/or open to communication) on a local area network (e.g., a WiFi network and/or a Thread network), the sensor device streams (e.g., sends, transmits, and/or provides) (and/or attempts to stream, send, transmit and/or provide), to the resident device, the second sensor data. In some embodiments, in response to capturing the second sensor data, in accordance with a determination that the resident device is not active (e.g., is not present, not available, and/or not open to communication) on the local area network, the sensor device forgoes stream (e.g., send, transmission, and/or provision) of, to the resident device, the second sensor data. In some embodiments, after capturing the sensor data, the sensor device temporarily maintains (e.g., stores, backs up, and/or forgoes deletion), in a second buffer (e.g., a storage location, memory, volatile memory, random access memory, long-term memory, permanent memory, and/or non-volatile memory) of the sensor device, the second sensor data. In some embodiments, in response to capturing the second sensor data, the sensor device stores the second sensor data in the second buffer. In some embodiments, the second sensor data is temporarily maintained in the second buffer for a predefined period of time (e.g., 30 minutes to 2 days) and/or until an event occurs, such as enough data is stored in the second buffer such that a location corresponding to the second sensor data is overwritten because there is no other room. In some embodiments, in response to capturing the second sensor data, the sensor device temporarily maintains (e.g., stores, backs up, and/or forgoes deletion), in a storage location external to the sensor device, the second sensor data, such as a server and/or another device separate from the sensor device. In some embodiments, the second buffer is the first buffer. In some embodiments, the second buffer is separate from the first buffer. In some embodiments, while temporarily maintaining the second sensor data, the sensor device receives, from the resident device, a request for the second sensor data. In some embodiments, the request for the second sensor data includes an identification corresponding to the second sensor data. In some embodiments, the request for the second sensor data does not include an identification corresponding to the second sensor data. In some embodiments, while temporarily maintaining the second sensor data, in response to receiving the request for the second sensor data, the sensor device provides (e.g., sends, transmits, and/or streams), to the resident device, the second sensor data (e.g., from the second buffer). In some embodiments, after providing the second sensor data to the resident device, the sensor device deletes the second sensor data (e.g., from the second buffer). In some embodiments, after providing the second sensor data to the resident device, the sensor device continues to maintain the second sensor data in the second buffer.

In some embodiments, the sensor data is first sensor data. In some embodiments, the buffer is a first buffer. In some embodiments, the resident device is a first resident device. In some embodiments, the sensor device captures (e.g., detects, obtains, and/or senses) third sensor data (e.g., an image, a video, an audio recording, orientation data, light data, proximity data, humidity data, temperature data, accelerometer data, infrared data, and/or pressure data), wherein the third sensor data is separate from the first sensor data. In some embodiments, in response to capturing the third sensor data, in accordance with a determination that the first resident device is active (e.g., is present, available, and/or open to communication) on a local area network (e.g., a WiFi network and/or a Thread network), the sensor device streams (e.g., sends, transmits, and/or provides) (and/or attempts to stream, send, transmit and/or provide), to the first resident device, the third sensor data. In some embodiments, in response to capturing the third sensor data, in accordance with a determination that the first resident device is not active (e.g., is not present, not available, and/or not open to communication) on the local area network and that a second resident device is active (e.g., is present, available, and/or open to communication) on the local area network, the sensor device streams (e.g., sends, transmits, and/or provides), to the second resident device, the third sensor data, wherein the second resident device is separate from the first resident device and the sensor device. In some embodiments, after capturing the sensor data, the sensor device temporarily maintains (e.g., stores, backs up, and/or forgoes deletion), in a third buffer (e.g., a storage location, memory, volatile memory, random access memory, long-term memory, permanent memory, and/or non-volatile memory) of the sensor device, the third sensor data. In some embodiments, in response to capturing the third sensor data, the sensor device stores the third sensor data in the third buffer. In some embodiments, the third sensor data is temporarily maintained in the third buffer for a predefined period of time (e.g., 30 minutes to 2 days) and/or until an event occurs, such as enough data is stored in the third buffer such that a location corresponding to the third sensor data is overwritten because there is no other room. In some embodiments, in response to capturing the third sensor data, the sensor device temporarily maintains (e.g., stores, backs up, and/or forgoes deletion), in a storage location external to the sensor device, the third sensor data, such as a server and/or another device separate from the sensor device. In some embodiments, the third buffer is the first buffer. In some embodiments, the third buffer is separate from the first buffer. In some embodiments, while temporarily maintaining the third sensor data, the sensor device receives, from the first resident device, a request for the third sensor data. In some embodiments, the request for the third sensor data includes an identification corresponding to the third sensor data. In some embodiments, the request for the third sensor data does not include an identification corresponding to the third sensor data. In some embodiments, in response to receiving the request for the third sensor data, the sensor device provides (e.g., sends, transmits, and/or streams), to the first resident device, the third sensor data (e.g., from the third buffer). In some embodiments, after providing the third sensor data to the first resident device, the sensor device deletes the third sensor data (e.g., from the third buffer). In some embodiments, after providing the third sensor data to the first resident device, the sensor device continues to maintain the third sensor data in the third buffer. In some embodiments, while temporarily maintaining the third sensor data, the sensor device receives, from the second resident device, a request for the third sensor data. In some embodiments, the request for the third sensor data includes an identification corresponding to the third sensor data. In some embodiments, the request for the third sensor data does not include an identification corresponding to the third sensor data. In some embodiments, in response to receiving the request for the third sensor data, the sensor device provides (e.g., sends, transmits, and/or streams), to the second resident device, the third sensor data (e.g., from the third buffer). In some embodiments, after providing the third sensor data to the second resident device, the sensor device deletes the third sensor data (e.g., from the third buffer). In some embodiments, after providing the third sensor data to the second resident device, the sensor device continues to maintain the third sensor data in the third buffer.

In some embodiments, the sensor data is streamed to the resident device via a local area network. In some embodiments, the request for the sensor data is received from the resident device via the local area network. In some embodiments, the sensor data is provided to the resident device via the local area network.

In some embodiments, the sensor device is a camera. In some embodiments, the sensor data includes (and/or is) video. In some embodiments, the sensor data includes (and/or is) one or more images.

In some embodiments, the buffer is a circular buffer. In some embodiments, the sensor data is maintained in the circular buffer until the sensor data is overwritten with other sensor data separate from the sensor data.

In some embodiments, before capturing the sensor data, the sensor device receives, from the resident device, cryptographic material (e.g., one or more encryption keys, a symmetric encryption key, an asymmetric encryption key, a private key, a public key, a digital certificate, a hashing algorithm, a random number, a digital signature, and/or a mathematical formula used to perform encryption). In some embodiments, in response to capturing the sensor data and before streaming the sensor data to the resident device, the sensor device encrypts, using the cryptographic material, the sensor data, wherein the sensor data streamed to the resident device is the sensor data after being encrypted using the cryptographic material. In some embodiments, the sensor data is encrypted using the cryptographic material before being stored by the sensor device. In some embodiments, the sensor data is encrypted using the cryptographic material before being stored by the sensor device in the buffer. In some embodiments, the sensor data is encrypted using the cryptographic material before being stored by the sensor device in a storage location, memory, volatile memory, random access memory, long-term memory, permanent memory, and/or non-volatile memory.

In some embodiments, before streaming the sensor data to the resident device (and/or before capturing the sensor data, after capturing the sensor data, while capturing the sensor data, and/or in response to capturing the sensor data), the sensor device generates first cryptographic material (e.g., one or more encryption keys, a symmetric encryption key, an asymmetric encryption key, a private key, a public key, a digital certificate, a hashing algorithm, and/or a random number). In some embodiments, in response to capturing the sensor data and before streaming the sensor data to the resident device, the sensor device encrypts, using the first cryptographic material, the sensor data, wherein the sensor data streamed to the resident device is the sensor data after being encrypted using the first cryptographic material. In some embodiments, the sensor data is encrypted using the first cryptographic material before being stored by the sensor device. In some embodiments, the sensor data is encrypted using the first cryptographic material before being stored by the sensor device in the buffer. In some embodiments, the sensor data is encrypted using the first cryptographic material before being stored by the sensor device in a storage location, memory, volatile memory, random access memory, long-term memory, permanent memory, and/or non-volatile memory. In some embodiments, in conjunction with (e.g., before, after, with, while, and/or in response to) streaming the sensor data to the resident device, the sensor device sends (e.g., streams, transmits, and/or provides), to the resident device, the first cryptographic material and/or another cryptographic material (e.g., separate from the first cryptographic material) (1) generated by the sensor device and (2) that corresponds to the first cryptographic material. In such embodiments, the first cryptographic material can be a private key and the other cryptographic material can be a public key corresponding to the private key. In some embodiments, before streaming the sensor data to the resident device (and/or before capturing the sensor data, after capturing the sensor data, while capturing the sensor data, and/or in response to capturing the sensor data), the sensor device receives, from an external device external to the sensor device and the resident device, second cryptographic material (e.g., one or more encryption keys, a symmetric encryption key, an asymmetric encryption key, a private key, a public key, a digital certificate, a hashing algorithm, a random number, a digital signature, and/or a mathematical formula used to perform encryption) separate from the first cryptographic material. In some embodiments, before streaming the sensor data to the resident device (and/or before capturing the sensor data, after capturing the sensor data, while capturing the sensor data, and/or in response to capturing the sensor data), the sensor device receives, from the resident device, third cryptographic material (e.g., one or more encryption keys, a symmetric encryption key, an asymmetric encryption key, a private key, a public key, a digital certificate, a hashing algorithm, a random number, a digital signature, and/or a mathematical formula used to perform encryption) separate from the first cryptographic material and/or the second cryptographic material. In some embodiments, the third cryptographic material includes one or more separate pieces of cryptographic material. In some embodiments, the third cryptographic material includes multiple separate pieces of cryptographic material, each separate piece of cryptographic material corresponding to a different security domain and/or accessory ecosystem. In some embodiments, before sending the first cryptographic material to the resident device, the first cryptographic material is encrypted (and/or wrapped) using the second cryptographic material, the third cryptographic material, and/or one or more pieces of the third cryptographic material. In some embodiments, the first cryptographic material sent to the resident device is the first cryptographic material after being encrypted (and/or wrapped) using the other cryptographic material, the second cryptographic material, the third cryptographic material, and/or one or more pieces of the third cryptographic material.

In some embodiments, before receiving the request for the sensor data (and/or after streaming the sensor data to the resident device and/or while temporarily maintaining the sensor data), the sensor device receives, from the resident device, a request for a list of sensor data buffered by the sensor device. In some embodiments, in response to receiving the request for a list of sensor data buffered by the sensor device, the sensor device provides (e.g., streams, sends, and/or transmits), to the resident device, a first list of sensor data buffered by the sensor device, wherein the first list of sensor data includes an indication of (e.g., a reference to and/or an identification of) the sensor data. In some embodiments, the first list of sensor data is used by the resident device to identify missing sensor data on a server separate from the sensor device and the resident device (e.g., as described below with respect to CS2).

In some embodiments, after (and/or in response to) capturing the sensor data, the sensor device detects occurrence of an event (e.g., motion, an emergency, a person, an animal, and/or a set of one or more criteria being satisfied) associated with (e.g., corresponding to, in, and/or that is represented by) the sensor data. In some embodiments, the occurrence of the event is detected using the sensor data and/or one or more sensor data separate from the sensor data. In some embodiments, in response to detecting occurrence of the event associated with the sensor data, the sensor device stores, in a storage location (e.g., of the sensor device or of another device separate from the sensor device, such as a server or the resident device) separate from the buffer, the sensor data (e.g., while temporarily maintaining the sensor data in the buffer), wherein the sensor data is maintained in the storage location after the sensor data is deleted from the buffer. In some embodiments, the occurrence of the event is detected without use of information and/or data from the resident device.

Note that details of the processes described above with respect to process 300 (e.g., FIG. 3) are also applicable in an analogous manner to other processes described herein. For example, process 400 optionally includes one or more of the characteristics of the various processes described above with reference to process 300. For example, the sensor device of process 300 can be the sensor device of process 400. For brevity, these details are not repeated herein.

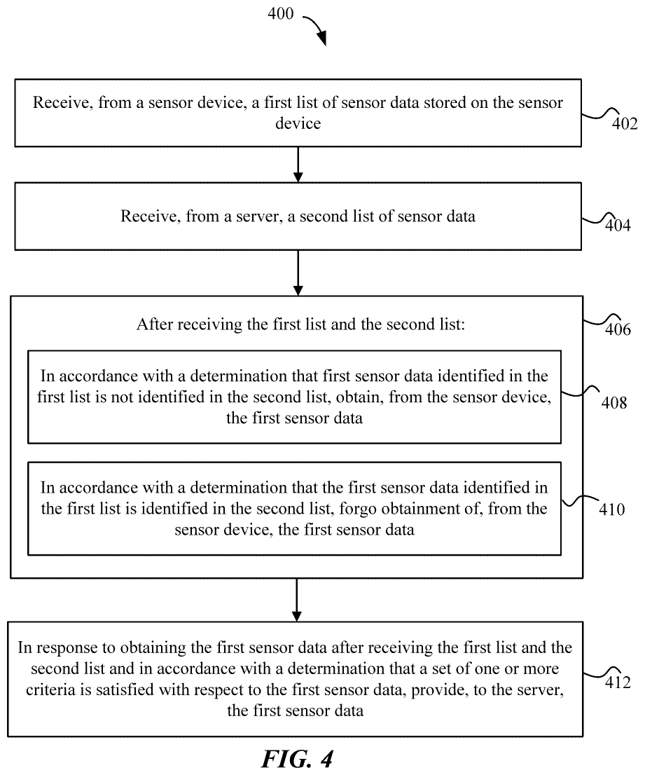

FIG. 4 is a flow diagram illustrating a process (e.g., process 400) for a resident device to manage sensor data in accordance with some embodiments. Some operations in process 400 are, optionally, combined, the orders of some operations are, optionally, changed, and some operations are, optionally, omitted.

As described below, process 400 provides an intuitive way for a resident device to manage sensor data. Process 400 reduces the cognitive burden on a user, thereby creating a more efficient human-machine interface. For battery-operated computing devices, enabling a user to interact with such devices faster and more efficiently conserves power and increases the time between battery charges.

In some embodiments, process 400 is performed at a resident device (e.g., an electronic device, a computer system, a user device, a commissioning device, a communal device, an accessory device, and/or a controller device).

The resident device receives (402) (and/or obtains), from a sensor device (e.g., a computer system, an electronic device, a camera, a microphone, a gyroscope, a light sensor, a proximity sensor, a humidity sensor, a temperature sensor, an accelerometer, an infrared sensor, and/or a pressure sensor), a first list of sensor data stored on the sensor device (e.g., in a buffer, such as the buffer described above with respect to process 300). In some embodiments, before receiving the first list of sensor data stored on the sensor device, the resident device sends, to the sensor device, a request for a list of sensor data stored on the sensor device. In some embodiments, before receiving the first list of sensor data stored on the sensor device, the resident device does not send, to the sensor device, a request for a list of sensor data stored on the sensor device.

The resident device receives (404) (and/or obtains), from a server (e.g., separate from the resident device and the sensor device), a second list of sensor data (e.g., stored by the server, indicated as reviewed by the sensor device, the resident device, and/or the server, and/or checked by the sensor device, the resident device, and/or the server). In some embodiments, the first list is received before, while, after, and/or in conjunction with receiving the second list. In some embodiments, the first list is obtained before, while, after, in conjunction with, and/or in response to receiving or obtaining the second list. In some embodiments, the second list is obtained before, while, after, in conjunction with, and/or in response to receiving or obtaining the first list. In some embodiments, before receiving the second list of sensor data, the resident device sends, to the server device, a request for a list of sensor data. In some embodiments, before receiving the second list of sensor data, the resident device does not send, to the server device, a request for a list of sensor data.

After (406) receiving the first list and the second list (and/or in response to receiving the first list or the second list and/or in response to detecting that the resident device is inactive and/or idle or has a threshold amount of processing and/or networking bandwidth), in accordance with a determination that first sensor data identified in the first list is not identified in the second list, the resident device obtains (408), from the sensor device, the first sensor data.

After (406) receiving the first list and the second list, in accordance with a determination that the first sensor data identified in the first list is identified in the second list, the resident device forgoes (410) obtainment of, from the sensor device, the first sensor data.

In response to obtaining the first sensor data after receiving the first list and the second list and in accordance with a determination that a set of one or more criteria is satisfied with respect to the first sensor data (e.g., that the first senor data is received and/or that the first sensor data includes, corresponds to, and/or is associated with an event, such as motion, an emergency, a person, and/or an animal), the resident device provides (412), to the server, the first sensor data. In some embodiments, the first sensor data is provided to the server without decrypting the first sensor data since receiving the first sensor data. In some embodiments, in response to obtaining the first sensor data after receiving the first list and the second list, the resident device analyzes the first sensor data attempting to detect an event (e.g., motion, an emergency, a person, an animal, and/or a set of one or more criteria being satisfied). In some embodiments, in response to detecting the event, the resident device provides, to the server, the first sensor data. In some embodiments, in response to not detecting the event, the resident device provides, to the server, an indication that no event occurred with respect to the first sensor data (e.g., with or without providing, to the server, the first sensor data).

In some embodiments, the second list of sensor data includes (and/or is) a list of sensor data stored by the server. In some embodiments, the second list of sensor data includes (and/or is) a list of sensor data analyzed (e.g., reviewed, checked, and/or otherwise assessed) by the resident device (e.g. determined by the resident device that such sensor data does not correspond to and/or is associated with an event, such as motion, an emergency, a person, an animal, and/or a set of one or more criteria being satisfied) but not stored by (and/or provided from the resident device to) the server.

In some embodiments, the sensor device is a camera. In some embodiments, the first sensor data includes (and/or is) video. In some embodiments, the first sensor data includes (and/or is) one or more images.

In some embodiments, in response to obtaining the first sensor data after receiving the first list and the second list and in accordance with a determination that the set of one or more criteria is not satisfied with respect to the first sensor data (e.g., that the first sensor data does not include, correspond to, and/or is not associated with an event, such as motion, an emergency, a person, and/or an animal), the resident device provides, to the server, an indication (e.g., an indication that the resident device does not detect an event with respect to the first sensor data) corresponding to the first sensor data without providing, to the server, the first sensor data. In some embodiments, the first sensor data is provided to the server without decrypting the first sensor data. In some embodiments, in response to obtaining the first sensor data after receiving the first list and the second list, the resident device analyzes the first sensor data attempting to detect an event (e.g., motion, an emergency, a person, an animal, and/or a set of one or more criteria being satisfied). In some embodiments, in response to detecting the event, the resident device provides, to the server, the first sensor data. In some embodiments, in response to not detecting the event, the resident device provides, to the server, an indication that no event occurred with respect to the first sensor data (e.g., with or without providing, to the server, the first sensor data).

In some embodiments, after receiving the first list and the second list (and/or in response to receiving the first list or the second list and/or in response to detecting that the resident device is inactive and/or idle or has a threshold amount of processing and/or networking bandwidth) and in accordance with a determination that second sensor data identified in the second list is not identified in the first list, the resident device provides, to the server, an indication (e.g., an indication that the second sensor data is not available and/or no longer stored by the sensor device) corresponding to the second sensor data without obtaining (and/or attempting obtainment of), from the sensor device, the second sensor data.

In some embodiments, the resident device is on a first local area network. In some embodiments, the sensor device is on the first local area network. In some embodiments, the first list of sensor data is received via the first local area network. In some embodiments, the first sensor data is obtained via the first local area network.

In some embodiments, after obtaining the second list of sensor data, before obtaining the first sensor data, and in accordance with the determination that the first sensor data identified in the first list is not identified in the second list, the resident device obtains, from the sensor data, a representation of the first sensor data, wherein the representation of the first sensor data is different from the first sensor data. In some embodiments, the representation of the first sensor data is a first memory size. In some embodiments, the first sensor data is a second memory size that is larger than the first memory size. In some embodiments, the representation of the first sensor data is a lower-resolution version of the first sensor data. In some embodiments, in response to obtaining the representation of the first sensor data and in accordance with a determination that the set of one or more criteria is not satisfied with respect to the representation of the first sensor data, the resident device forgoes obtainment of, from the sensor device, the first sensor data, wherein the first sensor data is obtained in response to obtaining the representation of the first sensor data and in accordance with a determination that the first set of one or more criteria is satisfied with respect to the representation of the first sensor data. In some embodiments, in response to obtaining the representation of the first sensor data and in accordance with the determination that the set of one or more criteria is not satisfied with respect to the representation of the first sensor data, the resident device provides, to the server, the representation of the first sensor data and/or an indication (e.g., an indication that the resident device does not detect an event with respect to the first sensor data and/or the representation of the first sensor data) corresponding to the first sensor data. In some embodiments, in response to obtaining the representation of the first sensor data and in accordance with the determination that the set of one or more criteria is not satisfied with respect to the representation of the first sensor data, the resident device forgoes provision of, to the server, the representation of the first sensor data.

In some embodiments, the resident device receives, from the server, a request for third sensor data. In some embodiments, in response to receiving the request for the third sensor data, the resident device obtains, from the sensor device, the third sensor data. In some embodiments, in response to obtaining the third sensor data, the resident device provides, to the server, the third sensor data (e.g., without decrypting the third sensor data since obtaining the third sensor data).

In some embodiments, the resident device receives, from the server, a request for fourth sensor data. In some embodiments, after receiving the request for the fourth sensor data, in accordance with a determination that the fourth sensor data is available (e.g., via the sensor device), the resident device obtains, from the sensor device, the fourth sensor data. In some embodiments, after receiving the request for the fourth sensor data, in accordance with a determination that the fourth sensor data is not available, the resident device provides, to the server, an indication (e.g., an indication that the fourth sensor data is not available and/or no longer stored by the sensor device) corresponding to the fourth sensor data without obtaining (and/or attempting obtainment of), from the sensor device, the fourth sensor data. In some embodiments, after obtaining, from the sensor device, the fourth sensor data, the resident device provides, to the server, the fourth sensor data.

Note that details of the processes described above with respect to process 400 (e.g., FIG. 4) are also applicable in an analogous manner to the processes described herein. For example, process 300 optionally includes one or more of the characteristics of the various processes described herein with reference to process 400. For example, the first sensor data of process 400 can be the sensor data of process 300. For brevity, these details are not repeated herein.

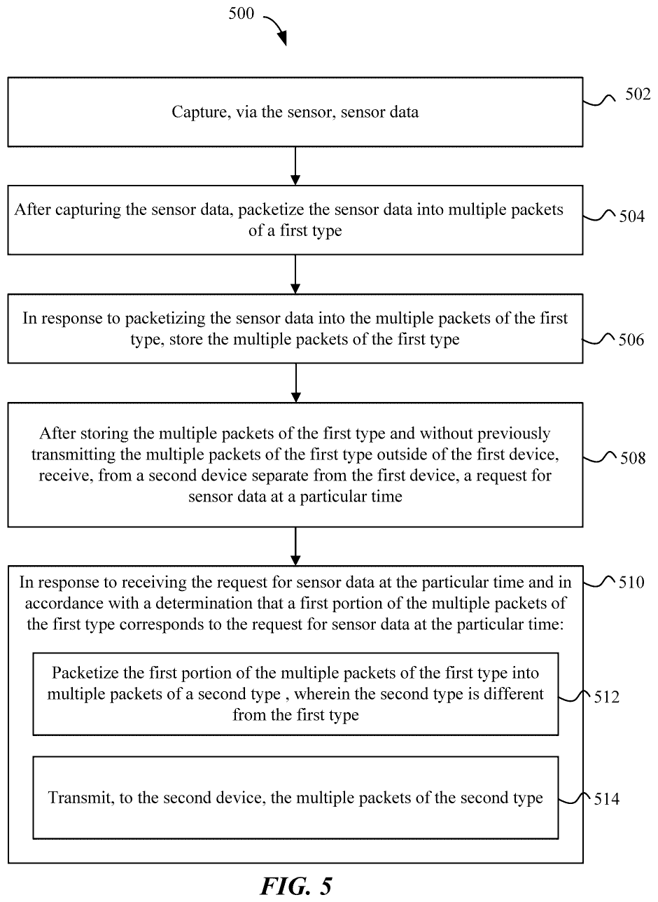

FIG. 5 is a flow diagram illustrating a process (e.g., process 500) for managing transmission of sensor data in accordance with some embodiments. Some operations in process 500 are, optionally, combined, the orders of some operations are, optionally, changed, and some operations are, optionally, omitted.

As described below, process 500 provides an intuitive way for managing transmission of sensor data. Process 500 reduces the cognitive burden on a user, thereby creating a more efficient human-machine interface. For battery-operated computing devices, enabling a user to interact with such devices faster and more efficiently conserves power and increases the time between battery charges.

In some embodiments, process 500 is performed at a first device (e.g., a computer system, a sensor device, a sender device, and/or an electronic device) including (and/or in communication with) a sensor (e.g., a camera, a microphone, a gyroscope, heartrate sensor, light sensor, infrared sensor, ultrasonic sensor, touch sensor, accelerometer, and/or a temperature sensor). In some embodiments, the first device is the sensor, such as a camera and/or a microphone. In some embodiments, the first device is a watch, a phone, a tablet, a fitness tracking device, a processor, a head-mounted display (HMD) device, a communal device, a media device, a speaker, a television, an electronic device, and/or a personal computing device.

The first device captures (502), via the sensor, sensor data (e.g., media data, such as video, audio, and/or one or more images). In some embodiments, in response to capturing the sensor data, the first device encodes the sensor data into encoded sensor data (the encoded sensor data is sometimes referred to as “the sensor data” below unless explicitly mentioned otherwise), such as encoded video data using a video encoder. In some embodiments, the sensor data includes one or more groups of pictures. In some embodiments, a group of pictures includes a sequence parameter set, a picture parameter set, an I-frame (e.g., a single I-frame or multiple I-frames), and/or one or more P-frames. In some embodiments, the sensor data includes and/or consists of sensor data captured sequentially.

After (and/or in response to) capturing the sensor data (and/or after and/or in response to encoding the sensor data), the first device packetizes (504) the sensor data into multiple packets of a first type (e.g., RTP or SRTP packets). In some embodiments, the multiple packets of the first type, taken together, represent multiple groups of pictures. In some embodiments, the multiple packets of the first type, taken together, represent a single group of pictures. In some embodiments, a beginning packet and/or an initial packet of the multiple packets of the first type is required to be used to decrypt, decode, and/or otherwise use the multiple packets of the first type. In some embodiments, one or more P-frames of a group of pictures is separated into a different packet from an I-frame of the group of pictures. In some embodiments, a single frame of the sensor data is packetized into multiple packets of the first type.

In response to (and/or after) packetizing the sensor data into the multiple packets of the first type (and/or in accordance with a determination that the first device is not streaming data to another device different from the first device), the first device stores (506) (e.g., in a buffer in disk and/or memory, such as a circular buffer or other data structure) the multiple packets of the first type (e.g., without transmitting the multiple packets of the first type outside of the first device). In some embodiments, in response to (and/or after) packetizing the sensor data into the multiple packets of the first type and in accordance with a determination that the first device is streaming data to another device different from the first device, the first device stores or forgoes storage of the multiple packets of the first type. In some embodiments, the multiple packets of the first type are stored in long-term memory and/or short-term memory. In some embodiments, storing the multiple packets of the first type is locally storing the multiple packets of the first type on the first device.

After storing the multiple packets of the first type (and/or without regard to capturing the sensor data, packetizing the sensor data, and/or storing the multiple packets of the first type) and without previously transmitting the multiple packets of the first type outside of the first device, the first device receives (508), from a second device (e.g., a computer system, a receiver device, and/or an electronic device) separate from the first device, a request for sensor data at a particular time. In some embodiments, the request for sensor data at the particular time is received via a wired connection and/or a wireless connection. In some embodiments, the second device is a watch, a phone, a tablet, a fitness tracking device, a processor, a head-mounted display (HMD) device, a communal device, a media device, a speaker, a television, an electronic device, and/or a personal computing device. In some embodiments, the second device is a different type of device than the first device, such as the first device is a sensor device and the second device is a personal device.

In response to (510) receiving the request for sensor data at the particular time and in accordance with a determination that a first portion of the multiple packets of the first type corresponds to the request for sensor data at the particular time (and/or that a second portion, different from the first portion, of the multiple packets of the first type does not correspond to the request for sensor data at the particular time), the first device packetizes (512) the first portion of the multiple packets of the first type into multiple packets of a second type (e.g., without packetizing the second portion of the multiple packets of the first type), wherein the second type is different from the first type. In some embodiments, the multiple packets of the second type are different from the multiple packets of the first type. In some embodiments, in response to receiving the request for sensor data at the particular time and in accordance with a determination that the second portion of the multiple packets of the first type does not correspond to the request for sensor data at the particular time, the first device forgoes packetization of the second portion of the multiple packets of the first type. In some embodiments, the multiple packets of the second type are TCP packets or UDP datagrams.

In response to (510) receiving the request for sensor data at the particular time and in accordance with the determination that the first portion of the multiple packets of the first type corresponds to the request for sensor data at the particular time, the first device transmits (514), to the second device (e.g., in order of capture of the sensor data), the multiple packets of the second type.

Note that details of the processes described above with respect to process 500 (e.g., FIG. 5) are also applicable in an analogous manner to the processes described herein. For example, process 300 optionally includes one or more of the characteristics of the various processes described herein with reference to process 500. For example, the first device of process 500 can be the sensor device of process 300. For brevity, these details are not repeated herein.

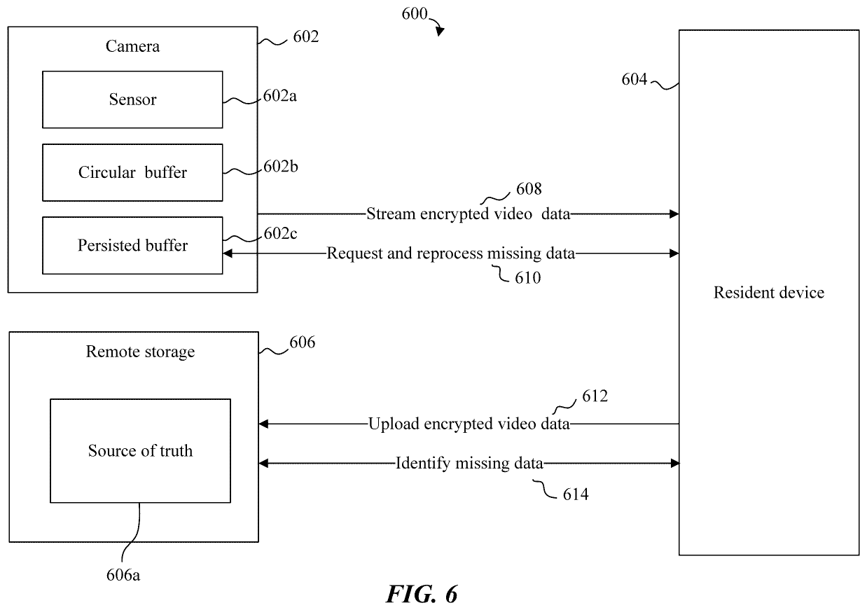

FIG. 6 is a block diagram illustrating an exemplary system for managing video data in accordance with some embodiments. The exemplary system in this figure is used to illustrate the processes described above, including the processes in FIGS. 3-5.

As illustrated in FIG. 6, system 600 includes camera 602, resident device 604, and remote storage 606. In some embodiments, camera 602 is a security device configured to capture, store, and/or stream video data. In some embodiments, resident device 604 is a hub device that acts as an intermediary between camera 602 and remote storage 606. In some embodiments, remote storage 606 is a cloud-based server system that provides off-premise storage and/or coordination services for system 600.

As illustrated in FIG. 6, camera 602 includes sensor 602a, circular buffer 602b, and persisted buffer 602c. It should be recognized that camera 602 can include more, less, and/or different components. In some embodiments, camera 602 captures video segments through sensor 602a and stores the video segments in circular buffer 602b. In such embodiments, circular buffer 602b can operate as a ring buffer that maintains up to a window of video segments (e.g., one hour, three hours, or one day) to allow system 600 to recover video segments when downstream components, such as resident device 604, are temporarily unavailable. For example, when resident device 604 becomes unavailable due to a software update, system maintenance, or network outage, camera 602 can provide video segments retained in circular buffer 602b to resident device 604 when resident device 604 returns to service to process past video segments. For another example, when resident device 604 becomes unavailable, remote storage 606 can coordinate processing of video segments in circular buffer 602b through another resident device that is available in system 600.

In some embodiments, circular buffer 602b is organized to optimize storage utilization through sequential write patterns. This organization can enable reduced write amplification (e.g., representing a ratio between data written logically and data written physically) on storage media, such as a flash drive and/or a Secure Digital (SD) card. For example, the storage media for circular buffer 602b can be partitioned into blocks and pages, where a block can include multiple pages, and pages can only be written individually while blocks must be erased as a unit. In such an example, video segments can be written to circular buffer 602b continuously in sequence to maintain a write amplification factor closer to an ideal value (e.g., of one) rather than using random access patterns that can result in higher write amplification factors and/or accelerate storage media wear. For another example, when new video segments are written to circular buffer 602b, older segments can be overwritten sequentially by block. The sequential overwriting can avoid a need to copy and relocate video segments from partially filled blocks before erasing them.

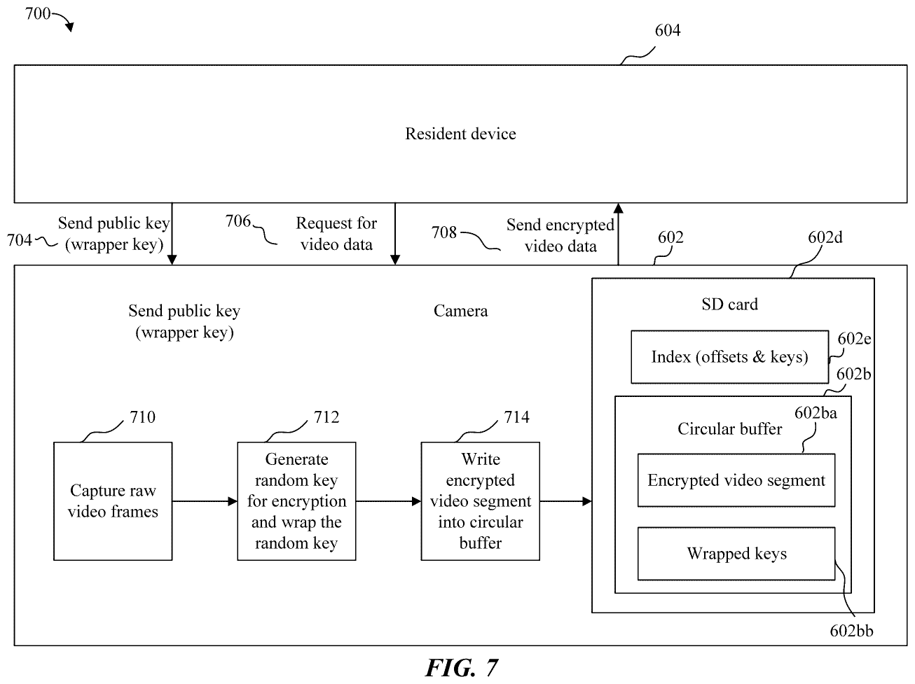

In some embodiments, camera 602 encrypts video segments before storing in circular buffer 602b. For example, the video segments can be encrypted using public keys received from resident device 604. In such an example, resident device 604 can retain corresponding private keys so that camera 602 is unable to decrypt the video segments. In other embodiments, camera 602 generates a random key for encrypting and/or decrypting one or more video segments, encrypts the one or more video segments using the random key, and wraps the random key (or wraps a decryption key corresponding to the random key) using one or more public keys received from resident device 604 to be sent to resident device 604 for decryption by resident device 604 and/or one or more other devices as further discussed below with respect to FIG. 7.

In some embodiments, metadata associated with video segments (e.g., motion detection signals, timestamps, video segment indices, motion vectors, index offsets, fragment sizes, and/or encryption key information) is also encrypted on camera 602. Such metadata can be stored with or separately from associated video segments. For example, camera 602 can maintain separate storage regions for video segments and associated metadata to optimize write patterns in circular buffer 602b. In such an example, video segments can be stored in one storage region (e.g., an SD card) while metadata about video segments can be stored in another storage region (e.g., an internal eMMC memory).

In some embodiments, persisted buffer 602c provides extended storage for video segments that are identified as important by camera 602. Such video segments can be retained beyond the window of circular buffer 602b. For example, when motion detection techniques on camera 602 identify activity in a video segment, the video segment can be copied from circular buffer 602b to persisted buffer 602c before the video segment would be overwritten in circular buffer 602b. Such motion detection techniques can be provided by camera 602, resident device 604, remote storage 606, and/or one or more different ecosystems (e.g., different home automation systems, management applications, and/or accessory devices).

In some embodiments, persisted buffer 602c implements the same encryption mechanisms as circular buffer 602b, where video segments and/or associated metadata are encrypted before storage. For example, when a video segment in circular buffer 602b is identified for retention, camera 602 can copy the encrypted video segment and its associated metadata to persisted buffer 602c. In some embodiments, this dual-buffer approach allows coexistence of continuous recording in circular buffer 602b with event-based retention in persisted buffer 602c without interference between the two mechanisms.

As illustrated in FIG. 6, camera 602 streams (608) encrypted video data to resident device 604. Such encrypted video data can include video segments and/or associated metadata. In some embodiments, during real-time streaming, camera 602 immediately streams the encrypted video data regardless of whether a segment is identified as important. In such embodiments, camera 602 can store (1) all encrypted video segments in circular buffer 602b and (2) encrypted videos segments identified as important in persisted buffer 602c. For example, camera 602 can examine video segments before and after a motion event to determine logical clip boundaries and store encrypted video segments corresponding to the logical clip boundaries in persisted buffer 602c.

In some embodiments, the encrypted video data is streamed through one or more real-time streaming protocols, such as Real-Time Transport Protocol (RTP) for media transport and Real Time Streaming Protocol (RTSP) for session control. For example, when resident device 604 requests live video, camera 602 can establish an RTSP session and stream encrypted RTP packets containing video fragments. For another example, camera 602 can implement WebRTC protocols for peer-to-peer streaming between camera 602 and resident device 604. For another example, camera 602 can use HTTP Live Streaming (HLS) protocol.

In some embodiments, after receiving encrypted video data from camera 602, resident device 604 stores the encrypted video data locally (e.g., in a temporary storage buffer or cache, memory, and/or disk) before processing and uploading to remote storage 606. In some embodiments, resident device 604 processes encrypted video segments to detect events before uploading to remote storage 606. In such embodiments, this processing can include decrypting video segments using a decryption key stored by resident device 604, analyzing video segments for events, and preparing video data with events for upload to remote storage 606. In some embodiments, only video data with events are uploaded to remote storage 606, otherwise an indication that no event was detected is uploaded to remote storage 606.

In some embodiments, resident device 604 implements one or more motion detection techniques when processing video segments. For example, resident device 604 can perform instance segmentation using convolutional neural networks to detect and classify objects (e.g., people, vehicles and/or animals) in video segments. For another example, resident device 604 can apply deep optical flow algorithms to analyze pixel-level displacements between consecutive frames to detect motion patterns. For another example, resident device 604 can use Gaussian Mixture Models for foreground-background separation to identify moving objects.

In some embodiments, resident device 604 uses and/or combines multiple detection approaches based on available computational resources. For example, when processing, resident device 604 can selectively decode and decrypt lower-resolution video segments of a video stream for motion detection without decoding and decrypting higher-resolution video segments for upload to remote storage 606. In some embodiments, when detecting motion in a video segment, resident device 604 analyzes adjacent video segments to determine event clips with logical clip boundaries similar to the method as described above with respect to camera 602.

In some embodiments, after processing, resident device 604 prepares video segments for upload by re-encrypting the video segments. For example, resident device 604 can generate new random keys for processed video segments and wrap the new random keys using public keys from different ecosystems (e.g., that can retrieve and decrypt the video segments from remote storage 606). For another example, resident device 604 can bundle the encrypted video segment with its wrapped keys and motion detection metadata into a single package (e.g., custom binary format, MP4 container format, or JSON Web Encryption (JWE) object) for upload to remote storage 606.

In some embodiments, resident device 604 uploads (612) video data to remote storage 606, which persistently stores encrypted video data and/or processing results. For example, remote storage 606 can include source of truth 606a that has a record of video data processing states in system 600. In such an example, source of truth 606a can be used to coordinate processing tasks across multiple resident devices by tracking which video segments have been processed, which video segments are important (e.g., include motion), and/or which video segments require processing. In some embodiments, this centralized record in source of truth 606a allows system 600 to identify gaps in video processing, coordinate workload distribution between multiple resident devices, and/or ensure complete coverage of video data processing in cases where individual system components become temporarily unavailable.

In some embodiments, resident device 604 processes received video segments to detect events before uploading to remote storage 606. In such embodiments, after processing, resident device 604 uploads processing results to remote storage 606 and, if an event is detected, the received video segments. In other embodiments, resident device 604 first uploads encrypted video segments to remote storage 606 before processing. For example, when receiving encrypted video segments from camera 602, resident device 604 can immediately upload the encrypted video segments to remote storage 606 while marking them as unprocessed in source of truth 606a. In such an example, after processing a video segment, resident device 604 can update source of truth 606a with processing results for the video segment.

In some embodiments, remote storage 606 maintains consistency and/or eventual consistency of source of truth 606a through a distributed coordination mechanism. For example, remote storage 606 can implement a distributed coordination service that manages video segment processing locks and/or state transitions using a consensus protocol. For another example, when multiple resident devices attempt concurrent updates, remote storage 606 can serialize operations using distributed transactions to maintain consistency. For another example, remote storage 606 can implement lease-based coordination where a resident device obtains time-limited processing rights for specific video segments. In such an example, source of truth 606a can maintain processing state transitions (e.g., unprocessed, in-progress, or completed) with atomic updates to prevent multiple resident devices from processing the same video segment. For another example, if resident device 604 fails during processing, the failure can be detected through lease expiration and such video segments can be reassigned to other available resident devices. In some embodiments, remote storage 606 implements relaxed consistency models based on ecosystem requirements. For example, remote storage 606 can allow temporary processing duplicates to improve system availability and/or reduce processing latency. For another example, remote storage 606 can implement optimistic concurrency control that allows parallel processing of the same video segments by multiple resident devices. For another example, source of truth 606a can maintain both strongly consistent critical state information (e.g., access control permissions for resident devices) and eventually consistent auxiliary data (e.g., video segment metadata) to balance reliability with performance.

In some embodiments, system 600 implements a mechanism for identifying and recovering missing video data through coordination between camera 602, resident device 604, and remote storage 606. In such embodiments, remote storage 606 and/or resident device 604 can identify (614) missing video data through comparison operations with source of truth 606a. In some embodiments, remote storage 606 and/or resident device 604 identifies missing video data with a set subtraction operation between what is stored in remote storage 606 and what is available in camera 602. For example, resident device 604 can retrieve two lists that include a list of processed video segments from source of truth 606a and a list of available video segments from camera 602 (e.g., within circular buffer 602b and/or persisted buffer 602c). In such an example, resident device 604 can compute a difference between the two lists to identify video segments that exist in camera 602 that have not been processed according to source of truth 606a. For another example, when returning to service after being offline, resident device 604 can request both lists to determine what processing was missed during downtime. In some embodiments, remote storage 606 can also identify missing video segments by analyzing gaps in processing records within source of truth 606a. For example, remote storage 606 can detect time periods where no video records and/or processing results were recorded and notify available resident devices to check camera 602 for corresponding video segments. For another example, when source of truth 606a indicates a video segment was partially processed (e.g., uploaded but not analyzed for motion), remote storage 606 can request a resident device to complete the processing.

In some embodiments, after identifying missing video segments, resident device 604 requests and reprocesses (610) missing video segments from camera 602. In some embodiments, resident device 604 retrieves the missing video segments from circular buffer 602b and/or from persisted buffer 602c. In such embodiments, resident device 604 can request video segments that are identified as missing from camera 602 using video segment timestamps and/or indices.

In some embodiments, system 600 implements priority-based recovery of missing video segments based on video segment age and/or buffer constraints. For example, when multiple video segments are missing, resident device 604 can prioritize retrieving older video segments that are at risk of being overwritten in circular buffer 602b. For another example, when source of truth 606a indicates motion was detected in nearby video segments, resident device 604 can prioritize recovery of video segments that could contain parts of the same motion event.

In some embodiments, multiple resident devices can participate in video segment recovery operations through coordination via source of truth 606a. For example, remote storage 606 can distribute recovery tasks of missing video data across available resident devices based on processing capacity and/or current workload. For another example, if a resident device fails during a recovery operation, source of truth 606a can reassign the recovery operation to other available resident devices. In some embodiments, after missing video data is identified and is stored in camera 602, camera 602 sends the missing video data using the same streaming mechanism described above for video streaming. In some embodiments, resident device 604 processes recovered video data using the same motion detection and/or encryption method described above.

FIG. 7 illustrates an exemplary process for storing and managing encrypted video segments in accordance with some embodiments. The exemplary process in this figure is used to illustrate the processes described above, including the processes in FIGS. 3-6.

As illustrated in FIG. 7, process 700 is performed by camera 602 and resident device 604. In some embodiments, camera 602 includes SD card 602d for storing video segments and/or associated metadata. For example, SD card 602d can be partitioned to include index 602e storing offset and key information, circular buffer 602b storing encrypted video segments 602ba, and wrapped keys 602bb storing wrapped keys.

As illustrated in FIG. 7, camera 602 receives (704) a public key from resident device 604 for encrypting video segments on camera 602. In some embodiments, resident device 604 maintains a private key that corresponds to the public key for decoding encrypted video segments. It should be recognized that resident device 604 can receive multiple public keys, each public key corresponding to a different ecosystem as described above with respect to FIG. 6.

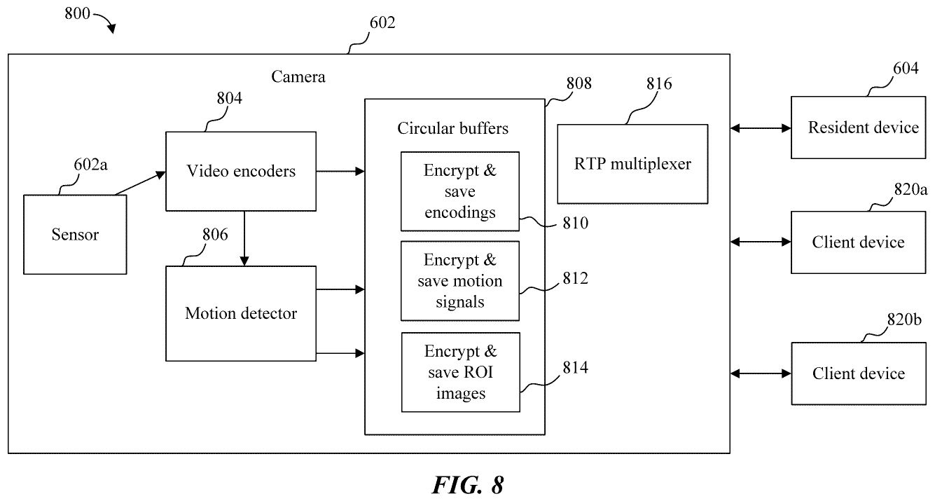

As illustrated in FIG. 7, camera 602 captures (710) raw video frames via sensor 602a. In some embodiments, the raw video frames are captured at multiple resolutions and/or frame rates. In other embodiments, the raw video frames are captured at a single resolution and/or frame rate and then reduced as further described below with respect to FIG. 8. In some embodiments, camera 602 processes the raw video frames to generate video segments (e.g., four second and/or seven second video segments). In some embodiments, camera 602 applies compression to the video segments before storage. In other embodiments, camera 602 stores the video segments without any compression applied.

As illustrated in FIG. 7, for each video segment, camera 602 generates (712) a random key. In some embodiments, camera 602 generates the random key internally using a cryptographically secure method. For example, camera 602 can use hardware random number generators (HRNGs) or a software-based cryptographic random number generators (e.g., HMAC-DRBG, CTR-DRBG, and/or hash-based generators) to generate the random key.

In some embodiments, camera 602 wraps the random key (or a corresponding decryption key) using the public key received at 704. In such embodiments, wrapping can include encrypting the random key with the public key using an asymmetric encryption algorithm. For example, camera 602 can use RSA encryption or elliptic curve cryptography. In some embodiments, when multiple different ecosystems or multiple different devices request access to video segments, camera 602 encrypts each video segment once with the random key and creates multiple wrapped versions of the random key. For example, when two different ecosystems (e.g., a first accessory management application and a second accessory management application) need access to a video segment, camera 602 can wrap the same random key with each ecosystem's respective public key.

In some embodiments, camera 602 implements configurable key rotation policies. For example, camera 602 can generate new random keys based on time intervals (e.g., hourly, daily, or weekly rotation). For another example, camera 602 can rotate keys after processing specific amounts of video data (e.g., every 100 MB or 1 GB of footage). For another example, camera 602 can force key rotation when ecosystem access permissions change for preserving forward and/or backward security.

As illustrated in FIG. 7, after generating the random key, camera 602 encrypts video segments using the random key and writes (714) the encrypted video segments to SD card 602d. In some embodiments, the encrypted video segments are written sequentially to circular buffer 602b in encrypted video segments 602ba to minimize write amplification, as described above with respect to FIG. 6. For example, when writing an encrypted video segment to circular buffer 602b, camera 602 can write the video segment next to a most recently written location rather than writing to a random position. For another example, when circular buffer 602b reaches capacity, camera 602 returns to the beginning of circular buffer 602b and starts overwriting older video segments while maintaining the sequential write pattern. In some embodiments, camera 602 stores wrapped keys 602bb in a dedicated region of SD card 602d to maintain flexible key management while preserving the sequential write pattern for video data in circular buffer 602b. In such embodiments, wrapped keys 602bb can be in the same circular buffer as encrypted video segments 602ba or a different one.

In some embodiments, SD card 602d of camera 602 implements a storage architecture that separates different types of data for optimizing write patterns and/or querying. In some embodiments, SD card 602d includes index 602e that stores video metadata including a mapping between video segment timestamps and physical storage locations of the encrypted video segments to maintain efficient video segment retrieval without needing to scan circular buffer 602b. For example, index 602e can store video segment start timestamps, video duration information, and/or memory offset pointers for enabling direct access to encrypted video segments. For another example, index 602e can implement tree-based structures for fast temporal range queries of encrypted video segments. For another example, index 602e can maintain separate indices for different time granularities (e.g., hourly, daily, and/or weekly) to optimize different querying requirements.

In some embodiments, camera 602 stores wrapped keys in wrapped keys 602bb alongside corresponding video segment references in index 602e for providing secure access from multiple ecosystems. In some embodiments, wrapped keys are stored with associated metadata. In some embodiments, this metadata can include key version information, ecosystem identifiers, and/or validity periods. For example, when implementing key rotation, camera 602 can track which wrapped keys correspond to which time periods or video segment ranges. For another example, camera 602 can maintain access control metadata alongside wrapped keys to manage ecosystem permissions. In some embodiments, wrapped keys 602bb are referenced in index 602e to maintain associations with corresponding encrypted video segments.

In some embodiments, during write operations, camera 602 updates multiple storage regions atomically to maintain data consistency. For example, when writing a new encrypted video segment, camera 602 updates circular buffer 602b with encrypted video data in encrypted video segment 602ba, stores corresponding wrapped keys in wrapped key 602bb, and updates index entries in index 602e to reflect the new encrypted segment's location and/or timestamp.

In some embodiments, camera 602 manages video segment expiration through index 602e rather than explicit deletion operations. For example, when circular buffer 602b overwrites old video segments, camera 602 can update index entries to reflect video segment invalidation without modifying wrapped keys and/or buffer contents. For another example, camera 602 can maintain separate indices for active and expired video segments for optimizing lookup operations. In some embodiments, camera 602 implements read optimization techniques based on access patterns. For example, camera 602 can maintain read caches in internal memory for frequently accessed index entries and/or wrapped keys. For another example, when multiple ecosystems repeatedly access recent video segments, camera 602 can cache relevant index entries to reduce SD card reads. For another example, camera 602 can prefetch index entries for time ranges adjacent to requested video segments to optimize subsequent access.

In some embodiments, when multiple requests for encrypted video segments are received (such as from different ecosystems), camera 602 can use index 602e to locate both the requested encrypted video segments and a corresponding wrapped key for that ecosystem in circular buffer 602b. For example, when two ecosystems need access to video segments of a same time period, camera 602 can fetch encrypted video segments once from circular buffer 602b but provide different wrapped keys to each of the two ecosystems. Each ecosystem can then decrypt the same encrypted video segment using the ecosystem's private key to unwrap the ecosystem's version of the random key.

In some embodiments, camera 602 of FIG. 7 implements a storage method that supports both circular buffer 602b and persisted buffer 602c as described above with respect to FIG. 6. In such embodiments, index 602e can maintain separate indices (e.g., index 602e) for encrypted video segments in circular buffer 602b and encrypted video segments in persisted buffer 602c. For example, when camera 602 detects motion and copies an encrypted video segment to persisted buffer 602c as described above with respect to FIG. 6, camera 602 can create new entries in index 602e to record an encrypted video segment's location in persisted buffer 602c while maintaining original entries that map to circular buffer 602b. For another example, index 602e can maintain references between video segments in both buffers to track which video segments were part of a single motion event for facilitating reconstruction of complete motion events even when video segments are stored at different locations.

In some embodiments, camera 602 manages storage allocation between circular buffer 602b and persisted buffer 602c based on usage patterns. For example, camera 602 can dynamically adjust partition sizes based on motion detection frequency and/or retention policies. For another example, if persisted buffer 602c approaches capacity, camera 602 can implement policies to free space for preserving video segments identified as most important. In some embodiments, camera 602 maintains consistent encryption and key management across both buffers. In some embodiments, when copying video segments to persisted buffer 602c, camera 602 preserves original wrapped keys. For example, wrapped keys in wrapped keys 602bb can reference video segments in both buffers to provide ecosystems access to requested video segments using the same wrapped keys regardless of whether the video segments are in circular buffer 602b or persisted buffer 602c. For another example, when implementing key rotation, camera 602 applies new random keys and wrapped versions only to newly captured video segments and maintains original wrapped keys for previously stored video segments in both buffers.

In some embodiments, camera 602 sends (708) encrypted video segments and corresponding wrapped keys to requesting devices, such as resident device 604 (706). In some embodiments, camera 602 implements different delivery mechanisms based on request types and/or network conditions. For example, camera 602 can stream encrypted video segments using real-time protocols for live viewing while using bulk transfer protocols for historical video segment retrieval, as described above with respect to FIG. 6. For another example, camera 602 can adapt transmission chunk sizes based on network quality and/or requesting device capabilities. For another example, when different devices request overlapping time ranges of video segments, camera 602 can optimize disk reads by retrieving video segments once, then caching and reusing them across responses.

FIG. 8 illustrates an exemplary process for managing multi-resolution video streams in accordance with some embodiments. The exemplary process in this figure is used to illustrate the processes described above, including the processes in FIGS. 6-7.

As illustrated in FIG. 8, process 800 implements an architecture optimized for handling multiple video streams through coordinated operation of video encoders 804, motion detector 806, circular buffers 808, RTP multiplexer 816, and sensor 602a. In some embodiments, process 800 optimizes camera resources by sharing encoders across recording and streaming functions rather than maintaining separate dedicated encoders for each function. In some embodiments, process 800 supports multiple concurrent video streams while managing hardware constraints through quality-tiered encoding.

Process 800 starts with sensor 602a capturing raw video data. In some embodiments, the raw video data is sent to multiple different video encoders (e.g., video encoders 804), each video encoder configured to encode the raw video data at a different resolution. In such embodiments, each video encoder of video encoders 804 can encode video streams at their original captured resolution or at scaled-down resolutions. For example, a video encoder can receive 4K raw sensor data and scale it down to 1080p before encoding to generate a lower resolution stream. For another example, another video encoder can process the same raw sensor data at full 4K resolution to maintain maximum quality for recording and/or high-bandwidth streaming.

In some embodiments, video encoders 804 implement multiple encoding methods to compress video data. For example, video encoders 804 can use hardware-accelerated H.264/AVC encoding with motion estimation and/or transform coding. For another example, video encoders 804 can implement H.265/HEVC encoding with features such as variable block sizes and/or improved intra-prediction. For another example, video encoders 804 can use lower complexity encoding profiles for reduced resolution streams for optimizing processing resources. For another example, when hardware supports parallel encoding, multiple video encoders 804 can process the same raw video data simultaneously at different target resolutions to minimize latency between streams. In some embodiments, camera 602's hardware capabilities determine a number and/or configuration of available encoder quality tiers (e.g., available processing power limiting maximum number of simultaneous encoding streams and/or hardware encoding blocks determining supported resolutions and/or codecs).

In some embodiments, when processing resources are constrained, camera 602 can prioritize different resolution streams based on current needs, such as favoring low latency streaming over high-resolution archival storage. For example, video encoders 804 can implement multiple output queue types (e.g., lock-free FIFO queues, priority queues with atomic operations, and/or wait-free circular queues), such as a high-priority streaming queue that writes compressed frames directly to memory buffers for immediate access by RTP multiplexer 816, a storage queue that stages compressed frames for encryption before writing to circular buffers 808, and a queue that directs lower resolution frames to motion detector 806. For another example, video encoders 804 can implement ring buffer structures (e.g., fixed-size arrays with head and tail pointers, memory-mapped circular buffers, and/or lock-free ring buffers with producer-consumer synchronization) in shared memory where RTP multiplexer 816 can directly access most recently encoded frames without requiring additional memory copies. For another example, video encoders 804 can use double-buffering techniques where one buffer is filled with newly encoded frames while another buffer is being read by the RTP multiplexer to ensure continuous frame availability for streaming. For another example, when managing multiple output paths, video encoders 804 can implement reference counting for encoded frame buffers to track when all consumers (e.g., streaming, storage, and/or motion detection) have processed a frame before releasing memory.

In some embodiments, outputs from video encoders 804 flow to RTP multiplexer 816. In such embodiments, RTP multiplexer 816 manages distribution of video streams to resident device 604 and/or client devices 820a-b based on device capabilities and/or network conditions. In some embodiments, unlike traditional systems where each viewer requires a dedicated encoder and directly negotiates bitrates, RTP multiplexer 816 acts as a central controller that assigns viewers to pre-configured quality tiers, which allows more concurrent viewers than traditional per-viewer encoder allocation. In some embodiments, this architecture allows multiple viewers with similar requirements to share a single encoder output that can maximize camera resources while maintaining stream quality appropriate for each viewer's conditions.

In some embodiments, when viewers request video streams, RTP multiplexer 816 evaluates network conditions and/or device capabilities to assign appropriate quality tiered encodings. For example, RTP multiplexer 816 can consider device characteristics (e.g., screen resolution, decoding capabilities, and/or processing power) when mapping viewers to quality tiers. For another example, RTP multiplexer 816 can analyze network metrics (e.g., available bandwidth, latency, and/or packet loss rates) to determine optimal stream quality for each viewer. For another example, when a viewer's network conditions change as the viewer moves from a high-bandwidth connection such as Wi-Fi to a low-bandwidth connection such as cellular, RTP multiplexer 816 can assign the viewer to a different pre-configured quality tier instead of dynamically adjusting encoder parameters.

In some embodiments, RTP multiplexer 816 implements adaptive quality tier management to handle viewer loads and/or varying network conditions. In some embodiments, when total viewing requests exceed available resources, RTP multiplexer 816 implements a tiered allocation strategy rather than rejecting new connections. For example, when servicing multiple viewer requests, RTP multiplexer 816 can implement priority-based stream allocation where viewers are initially assigned to lower quality tiers with opportunities to upgrade as resources become available. For another example, RTP multiplexer 816 can maintain a queue of upgrade requests for viewers that can support higher quality streams and automatically transitioning viewers when bandwidth and/or processing capacity becomes available. In some embodiments, RTP multiplexer 816 optimizes stream management by maximizing concurrent viewer support. For example, RTP multiplexer 816 can implement stream replication at the RTP packet level rather than requiring separate encoder outputs for each viewer. For another example, when multiple viewers have a similar bandwidth capability, RTP multiplexer 816 can route the same encoded stream to multiple RTP sessions to reduce encoder load compared to traditional per-viewer encoding. For another example, when network conditions change for a viewer, RTP multiplexer 816 can switch quality tiers by adjusting packet routing without requiring encoder reconfiguration.

In some embodiments, RTP multiplexer 816 manages stream synchronization across different quality tiers. In some embodiments, RTP multiplexer 816 maintains timing alignment between streams to provide smooth quality transitions. For example, RTP multiplexer 816 can implement RTP timestamp synchronization across different quality streams of the same video content to enable smooth transitions between tiers. For another example, when switching quality tiers, RTP multiplexer 816 can coordinate the transition with GOP (Group of Pictures) boundaries (e.g., aligning I-frame intervals across quality tiers, switching only at IDR frames, and/or buffering a subsequent I-frame before transitioning) to prevent visual artifacts (e.g., pixelation, distortion, and/or decoding glitches). In some embodiments, RTP multiplexer 816 implements session management protocols to maintain stream reliability. For example, RTP multiplexer 816 can maintain RTCP (RTP Control Protocol) feedback channels with viewers to monitor streaming performance and adjust quality tier assignments based on real-time metrics. For example, when network conditions deteriorate, RTP multiplexer 816 can implement gradual quality transitions rather than abrupt switches for a seamless viewing experience. For another example, when packet loss rates exceed acceptable thresholds, RTP multiplexer 816 can proactively downgrade stream quality before a viewing experience becomes severely impacted. In some embodiments, RTP multiplexer 816 implements adaptive stream handling mechanisms based on a viewer's role (e.g., resident device 604 versus client devices 820a-b) in process 800. In some embodiments, resident device 604 can access different quality tiers for different purposes simultaneously. For example, resident device 604 can receive lower resolution streams for motion detection processing while maintaining access to high resolution streams for archival storage (e.g., upload to remote storage 606, as described above with respect to FIG. 6). In some embodiments, RTP multiplexer 816 supports features, such as multi-camera grid viewing, by efficiently allocating streams to viewers. For example, RTP multiplexer 816 can dynamically adjust quality tiers for grid cells that have user focus while maintaining lower quality streams for background views.

In some embodiments, RTP multiplexer 816 handles viewer disconnection and reconnection scenarios. For example, when a viewer temporarily loses connectivity while transitioning between networks, RTP multiplexer 816 can maintain their session state and/or quality tier assignment for a configured period. In some embodiments, RTP multiplexer 816 implements fallback mechanisms when encoder resources become constrained. For example, if an encoder fails or requires reconfiguration, RTP multiplexer 816 can redistribute affected viewers across remaining quality tiers while maintaining priority-based allocation. For another example, during periods of high system load, RTP multiplexer 816 can implement fair sharing policies to ensure all viewers maintain at least minimal stream quality rather than allowing some viewers to consume disproportionate resources.

In some embodiments, motion detector 806 receives encoded video streams from video encoders 804 to identify motion events and/or regions of interest of motion events. In some embodiments, motion detection 806 operates on reduced resolution video streams. For example, motion detection 806 can analyze video at 640×480 resolution while full 1920×1080 resolution is preserved for processing motion detection on resident device 604 and/or for archival storage. For another example, motion detector 806 can implement basic algorithms (e.g., frame differencing and/or background subtraction) directly on camera 602 to enable quick decisions about video segment retention while deferring more comprehensive motion detection on resident device 604.

In some embodiments, motion detector 806 implements detection techniques based on encoded stream characteristics. For example, motion detector 806 can use motion vectors and/or block differences already computed during video encoding to identify areas of potential motion without full frame decoding. For another example, motion detector 806 can analyze a size and/or distribution of P-frame data to detect significant changes between frames, as changes in these frames can indicate areas of motion and/or significant changes between frames. In some embodiments, motion detector 806 computes frame differences between consecutive frames to detect pixel intensity changes. For example, motion detector 806 can calculate absolute differences in pixel values between adjacent frames and apply adaptive thresholding to identify regions of significant change. For another example, motion detector 806 can implement temporal filtering across multiple frames using sliding windows to distinguish persistent motion from transient changes, such as lighting variations.

In some embodiments, motion detector 806 outputs structured detection results to support downstream processing. In such embodiments, motion detector 806 can output both binary motion decisions and/or metadata for each analyzed frame pair. For example, a binary output can indicate motion presence with a value of one or absence with a value of zero. For another example, metadata can include motion confidence scores between zero and one, precise coordinates of motion regions, motion intensity measurements, and/or timestamps of motion occurrences. For another example, when motion is detected in multiple regions of a frame, motion detection 806 can output confidence scores and/or coordinates for each region separately. For another example, motion detection 806 can track motion regions across consecutive frames to generate motion trajectory metadata that can be used for identifying motion event boundaries (e.g., event-clips). In some embodiments, some techniques described herein with regards to motion detection 806 are processed on resident device 604 rather than on camera 602.

In some embodiments, motion detector 806 generates region of interest (ROI) images based on detected motion regions. In some embodiments, ROI images are generated in standardized formats (e.g., JPEG, PNG, and/or WebP). In some embodiments, when motion detector 806 identifies significant motion in a lower resolution stream, corresponding ROI images are extracted from original full-resolution video segments before any resolution scaling occurs. For example, motion detector 806 can scale motion region coordinates identified in a lower resolution (e.g., 640×480) stream to match a higher resolution (e.g., 1920×1080) stream's dimensions before extracting an ROI image. In some embodiments, motion detector 806 can apply padding around detected motion regions when extracting ROI images to provide additional context around a motion event. In some embodiments, when multiple motion regions are detected in a single frame, motion detector 806 can generate separate ROI images for each region and maintain their spatial relationships. In some embodiments, these ROI images are provided to allow resident device 604 to examine high-quality resolution motion regions without processing complete video segments. For example, resident device 604 can perform object classification using just ROI images and therefore reducing processing overhead compared to decoding full video segments.

In some embodiments, camera 602 stores encrypted versions of encoded streams along with encrypted motion signals (812) and/or region of interest (ROI) images (814) in circular buffers 808 using encryption and storage methods described above with respect to FIGS. 6-7. In some embodiments, camera 602 maintains separate circular buffers for different resolution tiers to optimize storage and/or retrieval patterns. In such embodiments, camera 602 can implement different retention policies in each circular buffer based on resolution and/or usage patterns. In other embodiments, camera 602 implements a single circular buffer that stores multiple resolutions of the same video content together to optimize retrieval of a video segment across quality tiers. In some embodiments, camera 602 maintains temporal alignment between different resolution streams stored in circular buffers 808. In some embodiments, camera 602 uses Group of Pictures (GOP) boundaries and/or timestamps to synchronize storage across resolution tiers. For example, when storing multiple resolutions of the same video content, camera 602 can align video segment boundaries with GOP structures to maintain consistent access points across quality levels (e.g., If a GOP is defined as 30 frames per second (fps) with a GOP length of 90 frames, the video segment length would be 3 seconds per GOP. This means that a 3-second segment in 1080p can align with a 3-second segment in 720p and/or 480p, which allows for easy switching between resolutions without frame mismatch). For another example, camera 602 can implement shared timestamp indices (e.g., in index 602e) across resolution tiers for efficient lookup of corresponding video segments at different qualities (e.g., such that a frame at the 10-second mark in a 1080p stream has the same timestamp as its corresponding frame in 720p and/or 480p streams). In some embodiments, generated motion signals on the camera side provide direction for storing sequences of video segments that contain detected motion. In some embodiments, each stored video segment includes frames where motion was detected and several preceding and/or following frames to provide context about detected motion. For example, if motion is detected in frame N, frames N−4 through N+4 are stored to capture a complete motion sequence.

In some embodiments, camera 602 maintains longer retention periods for motion signals and/or ROI images compared to video segments to preserve detected motion events while optimizing storage utilization. In some embodiments, camera 602 maintains an index (e.g., index 602e or a separately maintained index) that tracks relationships between video segments, motion signals, and/or ROI images across different video encodings (e.g., resolution tiers). For another example, indices can map between motion detection results in low-resolution streams and corresponding high-resolution ROI images and/or video segments. In such embodiments, stored ROI images and/or motion signals can be requested by resident device 604 to efficiently analyze motion events without processing entire video segments. Instead of decoding video segments, resident device 604 can first retrieve and analyze motion events on ROI images that are substantially smaller than full video segments and allow resident device 604 to perform initial motion analysis with reduced processing overhead and/or bandwidth usage. In some embodiments, this storage architecture allows resident devices to quickly assess motion events by analyzing encrypted motion signals and/or ROI images before processing complete video segments that require more processing overhead, such as decoding and decrypting the video segments.

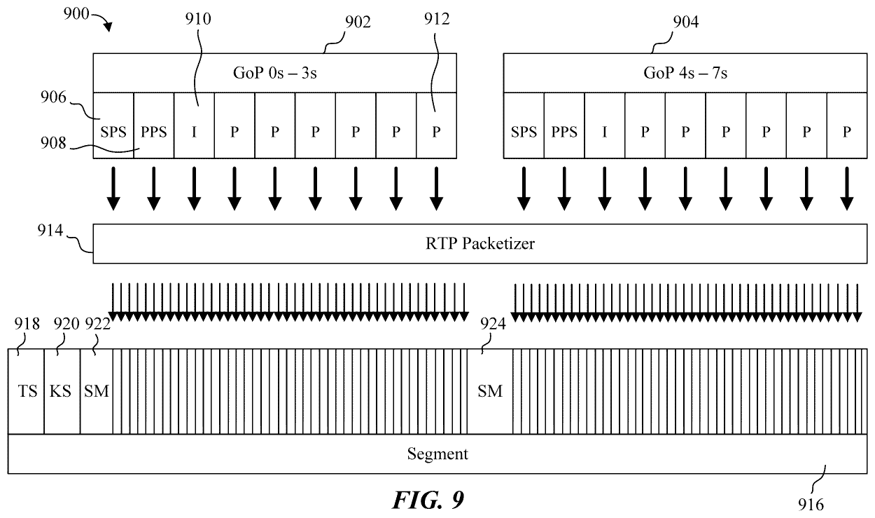

FIG. 9 illustrates an exemplary process for pre-packetizing and storing encrypted video data in accordance with some embodiments. The exemplary process in this figure is used to illustrate the processes described above, including the processes in FIGS. 6-8.

In some embodiments, process 900 implements techniques for pre-packetizing video data into RTP packets and storing the RTP packets on camera 602 before attempting to stream video, such as at initialization of camera 602. In some embodiments, camera 602 implements a circular buffer (e.g., circular buffer 602b and/or circular buffers 808) where RTP packets are continually generated and stored in a rolling window that can serve real-time streaming and/or historical playback requests. In some embodiments, process 900 reduces processing overhead by eliminating a need to packetize video data separately for each viewer (e.g., resident device 604 and/or client devices 820a-b) and allows a single encrypted RTP packet stream to serve multiple viewers simultaneously.

As illustrated in FIG. 9, process 900 includes two Groups of Pictures (GoP) structures GoP 902 and GoP 904, each representing sequential 3-second video segments at different time intervals. In some embodiments, each GoP includes sequence parameter sets (SPS) 906, picture parameter sets (PPS) 908, I-frame 910, and multiple P-frames (e.g., P-frame 912). In some embodiments, SPS 906 includes one or more decoding parameters, such as a resolution specification, a profile constraint, and/or level information that define a decoder resource requirement. In some embodiments, PPS 908 includes one or more frame-specific encoding parameters, such as an entropy coding mode, a quantization matrix, and/or a deblocking filter setting that optimize compression and/or visual quality. In some embodiments, I-frame 910 includes a complete reference frame that can be decoded independently and serve as an entry point for decoding. In some embodiments, a P-frame includes motion-compensated difference data that references previous frames for compression and/or reduces redundant data storage. In some embodiments, a GoP is replicated across multiple quality tiers (e.g., different resolutions and/or bitrates) while maintaining temporal alignment between tiers to allow for adaptive streaming including bitrate switching.

In some embodiments, RTP packetizer 914 processes each GoP to generate RTP packets. In such embodiments, RTP packetizer 914 can preserve GoP boundaries and frame relationships through packet headers that include sequence numbers, timestamps, and/or frame type indicators. In some embodiments, when packetizing video data, RTP packetizer 914 begins a new packet with an I-frame sequence to provide random access capability and allow viewers to join streams at any GoP boundary.

In some embodiments, after generating RTP packets, the RTP packets are stored with associated metadata as segment 916. In some embodiments, each segment begins with timestamp synchronization (TS) 918 that provides mapping between wall clock time and RTP timestamps. In some embodiments, TS 918 can be used by camera 602 to identify what to send in response to requests from other devices. For example, when a device requests video from a specific wall clock time, camera 602 can use TS 918 to convert the specific wall clock time into the RTP timestamp domain to locate an appropriate segment for the specific wall clock time. In some embodiments, to facilitate efficient seeking, camera 602 implements a hierarchical index structure where top-level indices map large time ranges to segment files, while segment-level indices provide fine-grained mapping to specific RTP packet locations within segments. In some embodiments, TS 918 implements a mapping that maintains a monotonic 64-bit wall clock reference. In some embodiments, TS 918 tracks a 32-bit RTP timestamp wraparound points at 90 kHz frequency and provides interpolation mechanisms for sub-frame timestamp accuracy. In some embodiments, RTP packets include a 16-bit sequence number and 30-bit timestamp field operating at 90 kHz frequency in RTP packet headers. In some embodiments, because this 32-bit timestamp wraps around approximately every 13 hours at 90 kHz, camera 602 implements additional timestamp management mechanisms for continuous recording that can extend over longer periods. For example, camera 602 can maintain metadata at segment boundaries that provides mapping between wall clock time and RTP timestamps for accurate temporal positioning even across multiple timestamp wraparound points. For another example, when an RTP timestamp rollover occurs, camera 602 can either insert additional time synchronization metadata or create a new segment for maintaining clear temporal relationships.

In some embodiments, segment markers SM 922 and/or SM 924 serve as internal reference points within segment 916 to indicate GoP boundaries and/or potential stream entry points. In some embodiments, these segment markers (e.g., SM 922 and/or SM 924) identify positions where decoders can begin processing without requiring previous frame data. In some embodiments, when a viewer requests video from a specific timestamp, these segment markers can be used to quickly locate the nearest preceding GoP boundary where decoding can begin. In some embodiments, these segment markers contain metadata about the following video content structure, including sequence parameter set locations, I-frame positions, and/or frame counts until a subsequent segment marker. For example, when a segment marker indicates an upcoming I-frame, a viewer can prepare decoding resources before frame data arrives. For another example, segment markers maintain counts of P-frames between I-frames to allow viewers to estimate buffer requirements. In some embodiments, segment markers include quality tier information that enables switching between different resolution streams by identifying aligned GoP boundaries. In some embodiments, camera 602 implements segment boundary synchronization across encoders (e.g., video encoders 804). In some embodiments, camera 602 coordinates segment creation across all active encoders to maintain clean switching points. For example, when approaching a segment boundary, camera 602 can delay boundary creation until all video encoders reach a suitable GOP boundary to ensure that quality switches can occur without requiring complex packet reassembly. For another example, when one quality tier requires a new segment due to size limitations, camera 602 can force segment boundaries across all quality tiers to maintain synchronization across segments.

In some embodiments, segment 916 includes key stream (KS) 920 information that manages key distribution for multiple viewers. In some embodiments, KS 920 includes wrapped keys where the same video content is encrypted once with a master key, and that master key is then encrypted separately with each authorized viewer's public key, as described above with respect to FIG. 7. In some embodiments, this approach significantly reduces processing overhead compared to traditional systems that would encrypt the same video content separately for each viewer.

In some embodiments, process 900 implements an access control mechanism through key management. In some embodiments, when a new viewer is granted access to camera 602, the process creates a new segment boundary and begins including wrapped keys of the new viewer in subsequent key sets. In some embodiments, camera 602 can embed wrapped keys directly within RTP packet headers using available key identifier fields. In some embodiments, process 900 implements packet authentication alongside encryption. In some embodiments, camera 602 generates authentication tags that protect both the RTP header and payload data. For example, when encrypting packets, camera 602 can include sequence numbers and timestamps in the authenticated data to prevent tampering with packet ordering and/or timing information. For another example, camera 602 can implement a Secure Real-time Transport Protocol (SRTP) authentication mechanism where both encrypted payload and critical header fields are protected by an authentication tag for preventing replay attacks and/or unauthorized packet modification.

In some embodiments, RTP packetizer 914 writes segments into circular buffers (e.g., circular buffer 602b and/or circular buffers 808) with optimized write patterns and/or minimized hardware wear while maintaining compatibility with real-time streaming requirements. In some embodiments, RTP packets are written sequentially within segments, with packet sizes chosen to minimize storage fragmentation and/or reduce write amplification factors, as described above with respect to FIGS. 6-7. For example, RTP packetizer 914 can align packet boundaries with flash storage page sizes to minimize partial page writes.

In some embodiments, process 900 implements different packet transmission strategies based on viewer type and/or request context. In some embodiments, RTP packets are transmitted over User Datagram Protocol (UDP) for a live streaming scenario where minimal latency is required. In some embodiments, when a viewer joins a live stream, camera 602 identifies the nearest preceding segment marker (e.g., SM 922 or SM 924) and begins transmitting packets from that point, to ensure that the viewer's decoder has all necessary reference frames for proper video reconstruction, even though the viewer may only display frames from a requested start time. In some embodiments, for video data processing where data completeness is critical (e.g., motion detection and/or upload to remote storage as described above in FIG. 6), RTP packets are transmitted over TCP for reliable delivery and/or limited data loss. In some embodiments, when transmitting over TCP, camera 602 can implement additional framing around RTP packets to handle sizing requirements and maintain packet boundaries within a TCP stream. For example, when sending a 1400-byte RTP packet over TCP, camera 602 can add a 4-byte length field before packet data to indicate packet size to allow a receiver to properly identify where one RTP packet ends and a next one begins within a continuous TCP byte stream. In some embodiments, organization of segment 916 supports adaptation through quality tier selection. For example, when network conditions change, a viewer can switch between quality tiers at GoP boundaries where SPS and PPS data provide complete decoding parameters for a new video quality tier. In such embodiments, this is facilitated by maintaining consistent GoP structures and timing across different quality tiers, as described above with respect to FIG. 8.

Attention is now directed towards techniques for detecting events. Such techniques are described in the context of a resident device detecting events using data from different accessory devices in a home. It should be recognized that different types of electronic devices can be used with techniques described herein. For example, a server or one of the accessory devices can detect the events instead of the resident device. In addition, techniques described herein optionally complement or replace other techniques for detecting events.

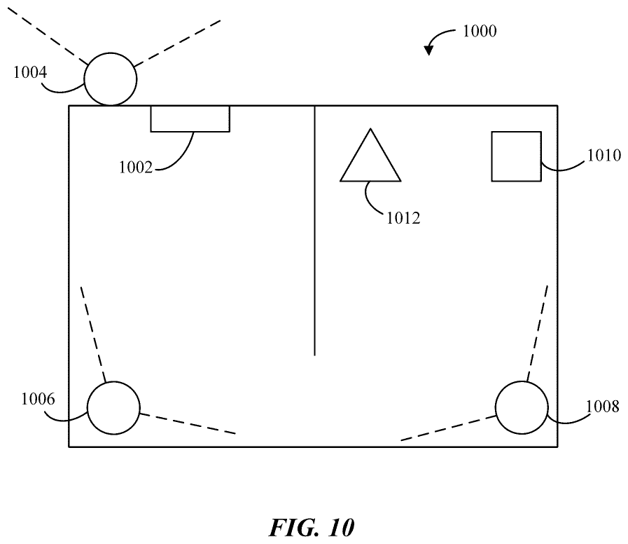

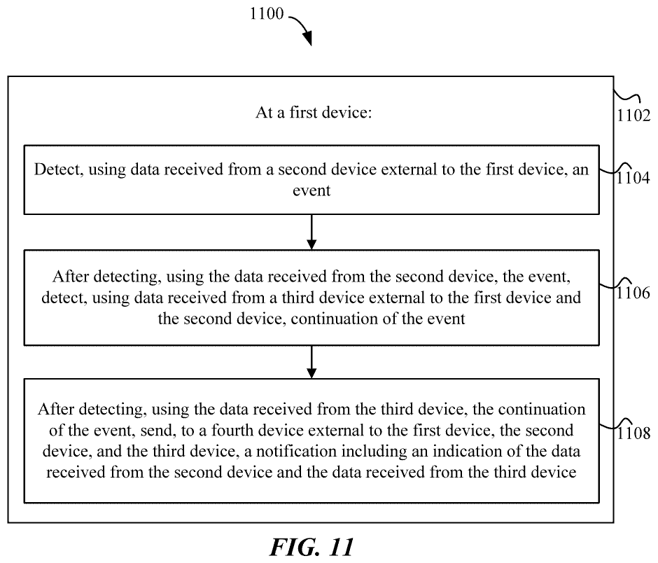

FIG. 10 is a block diagram illustrating an exemplary environment for detecting events in accordance with some embodiments. The block diagram in this figure is used to illustrate the processes described below, including the processes in FIG. 11.

As illustrated in FIG. 10, environment 1000 is a home with multiple rooms, including a left room with door 1002 and a right room. Environment 1000 includes multiple different accessory devices, including multiple cameras (e.g., front camera 1004, left camera 1006, right camera 1008) and speaker 1010. Environment 1000 also includes resident device 1012. As illustrated in FIG. 10, front camera 1004 is outside of the home and is facing away from the home near door 1002. In some embodiments, front camera 1004 is mounted on an exterior of the home and is configured to capture video of an area outside of the home in front of door 1002. As illustrated in FIG. 10, the left room includes left camera 1006 and the right room includes right camera 1008, speaker 1010, and resident device 1012. In some embodiments, left camera 1006 is mounted on an interior of the home and is configured to capture video of the left room and right camera 1008 is mounted on another interior of the home and is configured to capture video of the right room. In some embodiments, speaker 1010 is configured to output audio content. In some embodiments, resident device 1012 is a device within environment 1000 that acts as a controller for the different accessory devices within environment 1000. For example, resident device 1012 can communicate with each of the different accessory devices within environment 1000 and be enabled to obtain and/or modify states of the different accessory devices within environment 1000. In such an example, resident device 1012 can communicate with other devices inside and/or outside of environment 1000, such as personal devices of users that live in the home, so as to provide access to the other device of the different accessory devices. It should be recognized that the configuration of environment 1000 is exemplary and can be different than as described above. For example, different accessory devices can be included in environment 1000 and/or resident device 1012 might not be used in factor of the other devices communicating directly with the different accessory devices and/or the other devices controlling the different accessory devices via a server that is in communication with the different accessory devices. It should also be recognized that a home is being used for explanatory purposes and that other environments can be used with techniques described here.

FIG. 10 is used to describe techniques for detecting events in environment 1000. Such techniques can include detection of a complex event that is based on discrete events detected by different accessory devices. The user interfaces in FIG. 10 are used to illustrate the processes described below, including the processes in FIG. 11.

In one illustrative example, front camera 1004 captures video of a neighbor coming to door 1002, left camera 1006 captures video of the neighbor entering the home and going from the left room to the right room, right camera 1008 captures video of the neighbor going into the right room, and speaker 1010 is turned on. In some embodiments, each video and an indication that speaker 1010 is turned on is sent to resident device 1012. In other embodiments, video is not sent to resident device 1012 but instead each camera is configured to analyze video captured by itself and provide indications of events that occur to resident device 1012 without sending video to resident device 1012. In the illustrative example, rather than notifying an owner of the home about each discrete event, resident device 1012 summarizes such events in a notification that is sent to the owner such that the owner is notified that the neighbor came to the home and turned on speaker 1010. In some embodiments, the notification does not include an indication of each discrete event but rather a summary of the discrete events together. In other embodiments, the notification includes an indication of each discrete event, such as a list of each discrete event in chronological order.

In some embodiments, in addition to notifying that the neighbor came to the home and turned on speaker 1010, resident device 1012 generates and sends the owner a video of the neighbor within environment 1000, the video including video from front camera 1004 of the neighbor approaching the home, video from left camera 1006 of the neighbor entering the home and going from the left room to the right room, and/or video from right camera 1008 of the neighbor in the right room. In such embodiments, the video can be generated by combining video received from each of front camera 1004, left camera 1006, and/or right camera 1008. In some embodiments, resident device 1012 modifies the video to include an indication that speaker 1010 was turned on. For example, the video can be modified to include a textual and/or graphical representation of a state of speaker 1010 while speaker 1010 is off and when speaker 1010 is on. In such an example, the state of speaker 1010 can be determined based on information received from speaker 1010, such as when speaker 1010 was turned on.

In some embodiments, resident device 1012 determines whether to send a notification and/or what information (e.g., a summary, a video, an image, and/or an audio recording) to include in a notification to the owner, such as to a personal device of the owner that can receive notifications from the resident device. Such determinations can be based on what events occur (e.g., how such events can be represented in a notification and/or a priority of such events to the owner), who and/or what is involved with the events (e.g., unknown people might require notification while known people might not require notification), and/or other information related to the owner and/or the events. In some embodiments, such determinations are based on trends and/or past events. For example, a notification can be sent when events that typically occur at a certain time or date do not occur or occur in a different manner. It should be recognized that other aspects can be used for such determinations.

As described above, different discrete events are detected within environment 1000 and resident device 1012 determines that each successive event is a continuation of a previous event. In some embodiments, such a determination is based on one or more different aspects, such as when different events were detected (e.g., close in time events are more likely to be continuations of each other), who are detected in events (e.g., events including the same person are more likely to be continuations of each other), and/or where events are detected (e.g., events close in proximity and/or in a logical direction of travel are more likely to be continuations of each other). It should be recognized that a determination that a successive event is a continuation of a previous event can be based on different aspects than described above and/or a determination that a first event is a continuation of a second event can be based on a different aspect than a determination that a third event is a continuation of the first event and the second event.

While discussed above as determinations, it should be recognized that such determinations can be performed using different techniques, such as using a heuristic and/or a machine learning model. For example, discrete events can be detected in video using computer vision and converted to separate textual descriptions for each event. The separate textual descriptions for each event can be provided to a large language model that generates a summary of the separate textual descriptions. In some embodiments, the large language model is provided additional inputs that modify the summary, such as identification of people within the video and/or relationships of the people so as to cater the summary to who is being provided the summary.

FIG. 11 is a flow diagram illustrating a process (e.g., process 1100) for sending a notification of an event in accordance with some embodiments. Some operations in process 1100 are, optionally, combined, the orders of some operations are, optionally, changed, and some operations are, optionally, omitted.

As described below, process 1100 provides an intuitive way for sending a notification of an event. Process 1100 reduces the cognitive burden on a user, thereby creating a more efficient human-machine interface. For battery-operated computing devices, enabling a user to interact with such devices faster and more efficiently conserves power and increases the time between battery charges.

In some embodiments, process 1100 is performed at a first device (e.g., resident device 1012). In some embodiments, the first device is a communal device, a watch, a phone, a tablet, a fitness tracking device, a processor, a head-mounted display (HMD) device, a media device, a speaker, a television, an electronic device, a computer system, and/or a personal computing device.

The first device detects (1102), using data (e.g., video of a neighbor coming to door 1002) (e.g., sensor data, image data, audio data, and/or biometric data) received from (and/or collected by, obtained from, and/or processed by) a second device (e.g., front camera 1004, left camera 1006, and/or right camera 1008) external to the first device, an event (e.g., a motion detection of subject (e.g., a user, a person, an animal, another device, and/or an object), an alarm, an interruption, an observation, a threat, a disturbance, an anomaly, and/or an intrusion). In some embodiments, detecting the event includes utilizing techniques such as machine learning, sound pattern recognition, noise threshold detection, motion detection, object detection, facial recognition, and/or thermal detection on the data received from the second device to identify an intruder, a disturbance, and/or an anomaly in an environment. In some embodiments, the first device is in direct communication with the second device. In some embodiments, the first device communicates with the second device using a server.

After (and/or while) detecting, the first device uses (1104) the data received from the second device, the event, detecting, using data (e.g., video of the neighbor entering a home and going from a left room to a right room) (e.g., sensor data, image data, audio data, and/or biometric data) received from (and/or collected by, obtained from, and/or processed by) a third device (e.g., front camera 1004, left camera 1006, and/or right camera 1008) external to the first device and the second device, continuation (e.g., after detecting, using the data received from the second device, the event) of the event. In some embodiments, detecting the continuation of the event includes utilizing techniques such as machine learning, sound pattern recognition, noise threshold detection, motion detection, object detection, facial recognition, and/or thermal detection on the data received from the second device to identify the same or related intruder, disturbance, and/or the anomaly in the environment detected by the second device. In some embodiments, the first device and the third device are in direct communication each other. In some embodiments, the first device and the third device communicate with each other using a server. In some embodiments, the second device and the third device are in direct communication with each other. In some embodiments, the second device and the third device communicate with each other using a server.

After (and/or in response to and/or while) detecting, the first device uses (1106) the data received from the third device, the continuation of the event, sending, to a fourth device (e.g., a personal device as described with respect to FIG. 10) external to the first device, the second device, and the third device, a notification (e.g., an alert, a notice, a warning, a message, a prompt and/or an advisory) including an indication (e.g., a video of the neighbor within environment 1000) (e.g., a visual indication and/or an audio indication) of the data received from the second device and the data received from the third device. In some embodiments, the fourth device is a server, a communal device, a watch, a phone, a tablet, a fitness tracking device, a processor, a head-mounted display (HMD) device, a media device, a speaker, a television, an electronic device, a computer system, and/or a personal computing device. In some embodiments, the first device and the fourth device are in direction communication with each other. In some embodiments, the first device and the fourth device communicate with each other using a server.

In some embodiments, the event is detected using the data received from the second device and data received from a fifth device (e.g., speaker 1010) external to the first device, the second device, the third device, and the fourth device.

In some embodiments, the third device includes (and/or is in communication with) one or more cameras. In some embodiments, the data received from the third device includes video captured via the one or more cameras (e.g., as described with respect to FIG. 10).

In some embodiments, the second device is a first type of device. In some embodiments, the third device is a second type of device different from the first type of device (e.g., as described with respect to FIG. 10).

In some embodiments, the data received from the third device is first data received from the third device. In some embodiments, after detecting, the first device uses the data received from the second device, the event (and/or after detecting, using the first data received from the third device, continuation of the event), detecting, using second data (e.g., sensor data, image data, audio data, and/or biometric data) received from (and/or collected by, obtained from, and/or processed by) the third device, that the event has ended based on a time that the second data has been detected (e.g., close in time events are more likely to be continuations of each other as described with respect to FIG. 10) (e.g., relative to when the first data received from the third device is detected and/or when the data received from the second device is detected). In some embodiments, in response to detecting that the event has ended, the first device forgoes and/or ceases display of the notification, the indication, and/or an indication of the event.

In some embodiments, the continuation of the event is detected based on where the third device is located relative to the second device when the data is received from the third device (e.g., events close in proximity as described with respect to FIG. 10) (e.g., the event is detected to be continued when the third device is within a threshold amount of distance from the second device, the threshold based on an amount of time between when the data is received from the second device and when the data is received from the third device).

In some embodiments, the continuation of the event is detected based on the data received from the third device corresponding to the data received from the second device (e.g., as described with respect to FIG. 10) (e.g., the data received from the third device is the same as, includes the same pattern, includes the same person, includes the same activity, and/or includes the same quality as the data received from the second device).

In some embodiments, the continuation of the event is detected when the data received from the third device includes the same person (and/or the same group of people) as the data received from the second device (e.g., events including the same person being more likely to be continuations of each other as described with respect to FIG. 10).

In some embodiments, the continuation of the event is detected based on the data received from the third device being detected within a predefined period of time from when the data received from the second device is detected (e.g., as described with respect to FIG. 10) (and/or that the same person and/or same group of people is detected in the data received from the second device and the data received from the third device). In some embodiments, different events and/or different types of event have different predefined period of time to result in detecting that an event has been continued.

In some embodiments, the notification includes a list of multiple activities in chronological order (e.g., a list of each discrete event in chronological order as described with respect to FIG. 10). In some embodiments, the list of multiple activities are activities performed by a person detected in the data received from the second device. In some embodiments, the list of multiple activities are activities that correspond to the event. In some embodiments, the list of multiple activities includes a first activity and a second activity separate from (and/or detected at a different time than) the first activity. In some embodiments, each activity in the list of multiple activities is detected by the first device.

In some embodiments, the notification includes a portion (e.g., an image, a clip, an audio segment, and/or a part of a video) of the data received from the second device and a portion (e.g., an image, a clip, an audio segment, and/or a part of a video) of the data received from the third device (e.g., video from front camera 1004, left camera 1006, and/or right camera 1008 as described with respect to FIG. 10).

In some embodiments, the notification does not include a portion (e.g., an image, a clip, an audio segment, and/or a part of a video) of the data received from the second device nor a portion (e.g., an image, a clip, an audio segment, and/or a part of a video) of the data received from the third device (e.g., notification not including an indication of each discrete event as described with respect to FIG. 10).

In some embodiments, the notification includes: in accordance with a determination that the event has a first priority (e.g., that the event is defined, by the first device or another device, such as a server, different from the first device, the second device, and the third device, to have the first priority and/or that the event corresponds to an unknown subject and/or an unknown person at a particular location), content of a first type (e.g., video, image, audio, and/or text content); and in accordance with a determination that the event has a second priority (e.g., that the event is defined, by the first device or the other device to have the second priority and/or that the event corresponds to a known subject and/or a known person at another location different from the particular location), content of a second type (e.g., video, image, audio, and/or text content) different from the first type. In some embodiments, the second priority is different (e.g., less or greater than) the first priority (e.g., determining whether to send a notification and/or what information based on a priority of events to an owner as described with respect to FIG. 10). In some embodiments, the content of the first type is a video recorded of the event and the content of the second type is an image of the event.

In some embodiments, the notification includes: in accordance with a determination that the event corresponds to a first subject (e.g., that the data received from the second device and/or the data received from the third device includes, is associated with, and/or corresponds to the first subject and/or the first subject is detected in an environment corresponding to the event), content corresponding to the first subject; and In some embodiments, the first subject is a person, an animal, and/or an object detected in an environment such as by a camera, a microphone, and/or a personal device of the first subject. In some embodiments, the content corresponding to the first subject includes content personalized to the first subject. In some embodiments, the content corresponding to the first subject includes content obtained from a personal device of the first subject. in accordance with a determination that the event corresponds to a second subject (e.g., that the data received from the second device and/or the data received from the third device includes, is associated with, and/or corresponds to the first subject and/or the first subject is detected in an environment corresponding to the event), content corresponding to the second subject (e.g., without including the content corresponding to the first subject). In some embodiments, the second subject is different (e.g., less or greater than) the first subject. In some embodiments, the content corresponding to the second subject is different from the content corresponding to the first subject (e.g., notification including information based on who is involved in events as described with respect to FIG. 10). In some embodiments, the second subject is a person, an animal, and/or an object detected in an environment such as by a camera, a microphone, and/or a personal device of the second subject. In some embodiments, the content corresponding to the second subject includes content personalized to the second subject. In some embodiments, the content corresponding to the second subject includes content obtained from a personal device of the second subject.

In some embodiments, the notification includes: in accordance with a determination that the data received from the second device is more relevant to the event than the data received from the third device, a portion (e.g., an image, a clip, an audio segment, and/or a part of a video) of the data from the second device (e.g., without including a portion of the data from the third device); and in accordance with a determination that the data received from the third device is more relevant to the event than the data received from the second device, a portion (e.g., an image, a clip, an audio segment, and/or a part of a video) of the data from the third device (e.g., determining what information to include in the notification as described with respect to FIG. 10) (e.g., without including a portion of the data from the second device).

In some embodiments, the indication includes a textual representation (and/or a graphical representation) of an activity (e.g., walking, sleeping, jumping, running, staring, looking in a direction, knocking, arriving, leaving, and/or talking) performed in the data received from the second device, the data received from the third device, or any combination thereof (e.g., textual and/or graphical representation of a state of speaker 1010 as described with respect to FIG. 10).

In some embodiments, the event is a first event. In some embodiments, after sending the notification, the first device detects, via the second device, the second device, or any combination thereof, an activity (e.g., walking, sleeping, jumping, running, staring, looking in a direction, knocking, arriving, leaving, and/or talking) being performed in an environment (e.g., as described with respect to FIG. 10). In some embodiments, in response to detecting the activity being performed in the environment, in accordance with a determination that the activity corresponds to the first event, the first device continues detection of the first event. In some embodiments, in response to detecting the activity being performed in the environment and in accordance with the determination that the activity corresponds to the first event, the first device sends, to the fourth device, a notification corresponding to the first event. In some embodiments, in response to detecting the activity being performed in the environment, in accordance with a determination that the activity corresponds to a second event, the first device detects an occurrence of a second event different from the first event (e.g., different discrete events being detected within environment 1000 as described with respect to FIG. 10). In some embodiments, in response to detecting the activity being performed in the environment and in accordance with the determination that the activity corresponds to the second event, the first device sends, to the fourth device, a notification corresponding to the second event (e.g., without sending a notification corresponding to the first event).

In some embodiments, in response to detecting, the first device uses the data received from the second device, the event: in accordance with a determination that the event is a first type of event (e.g., that the event pertains to security, privacy, a particular subject, an unknown subject, a known subject, and/or a particular application), sending, to the fourth device, a notification corresponding to the event (e.g., unknown people in the event might require a notification as described with respect to FIG. 10); and in accordance with a determination that the event is a second type of event (e.g., that the event pertains to security, privacy, a particular subject, an unknown subject, a known subject, and/or a particular application), forgoing send of, to the fourth device, the notification corresponding to the event, wherein the second type of event is different from the first type of event (e.g., known people in the event might not require a notification as described with respect to FIG. 10).

In some embodiments, the first device is a resident device (e.g., resident device 604 and/or as described with respect to FIG. 10) (e.g., a device that resides in an environment, such as a device that is in facilitates communication with one or more accessory devices in the environment). In some embodiments, the first device is a server (e.g., remote storage 606).

In some embodiments, detecting the continuation of the event includes identifying (e.g., using machine learning, such as an object detection and/or object identification system) an object (e.g., a person, a tool, and/or an animal) within the data received from the third device that was also identified (e.g., using machine learning, such as an object detection and/or object identification system) within the data received from the second device (e.g., events including the same person being more likely to be continuations of each other as described with respect to FIG. 10).

In some embodiments, the first device (and/or the sensor) is initialized (e.g., the first device performs an initialization process, boots up, performs a boot sequence, transitions to its operational state, transitions to a ready state, turns on). In some embodiments, in conjunction with (e.g., as part of, while, after, or in response to) initializing the first device (and/or the sensor), the first device initializes live streaming of sensor data captured via the sensor, wherein sensor data is not transmitted outside of the first device until the first device receives, from another device (e.g., a computer system and/or an electronic device) separate from the first device, a request for sensor data (e.g., the request for sensor data at the particular time as described above), wherein the sensor data packetized into the multiple packets of the first type is captured as part of the live streaming of sensor data captured via the sensor.

In some embodiments, the request for sensor data at the particular time is a request to join the live streaming of sensor data captured via the sensor. In some embodiments, the particular time is a current time. In some embodiments, the particular time is a past time (and/or a previous time).

In some embodiments, at least one packet of the multiple packets of the second type includes (and/or corresponds to) sensor data from a time before the particular time. In some embodiments, the second device decodes each and/or all of the multiple packets of the second type but only displays a portion of sensor data decoded from the multiple packets of the second type (e.g., sensor data captured at and/or after the particular time). In some embodiments, the second device decodes the one packet but does not display the one packet.

In some embodiments, the particular time is a first particular time. In some embodiments, the first device receives, from a third device (e.g., a computer system, a receiver device, a hub device, a resident device, and/or an electronic device) separate from the first device and the second device, a request for sensor data at a second particular time (e.g., the first particular time or another time different from the first particular time). In some embodiments, the third device is a watch, a phone, a tablet, a fitness tracking device, a processor, a head-mounted display (HMD) device, a communal device, a media device, a speaker, a television, an electronic device, and/or a personal computing device. In some embodiments, the third device is a different type of device than the first device, such as the first device is a sensor device and the third device is a personal device or a resident device. In some embodiments, in response to receiving the request for sensor data at the second particular time, in accordance with a determination that the first portion of the multiple packets of the first type corresponds to the request for sensor data at the second particular time (and/or that the second portion of the multiple packets of the first type does not correspond to the request for sensor data at the second particular time) and that the request for sensor data at the second particular time is a first type of request (e.g., a request for sensor data for the purposes of presentation) (and/or that the third device is a first type of device, such as a personal device), the first device packetizes the first portion of the multiple packets of the first type into multiple packets of the second type (e.g., without packetizing the second portion of the multiple packets of the first type). In some embodiments, the multiple packets of the second type are UDP datagrams. In some embodiments, in response to receiving the request for sensor data at the second particular time, in accordance with the determination that the first portion of the multiple packets of the first type corresponds to the request for sensor data at the second particular time and that the request for sensor data at the second particular time is the first type of request, the first device transmits, to the third device (e.g., in order of capture of the sensor data), the multiple packets of the second type. In some embodiments, in response to receiving the request for sensor data at the second particular time, in accordance with a determination that the first portion of the multiple packets of the first type corresponds to the request for sensor data at the second particular time (and/or that the second portion of the multiple packets of the first type does not correspond to the request for sensor data at the second particular time) and that the request for sensor data at the second particular time is a second type of request (e.g., a request for sensor data for the purposes of analysis and/or storage) (and/or that the third device is a second type of device, such as a resident device and/or a hub device), wherein the second type of request is different from the first type of request, the first device packetizes the first portion of the multiple packets of the first type into multiple packets of a third type (e.g., without packetizing the second portion of the multiple packets of the first type and/or without packetizing the first portion of the multiple packets of the first type into multiple packets of the second type), wherein the third type is different from the first type and the second type. In some embodiments, the multiple packets of the third type are TCP datagrams. In some embodiments, the second type of device is different from the first type of device. In some embodiments, in response to receiving the request for sensor data at the second particular time, in accordance with the determination that the first portion of the multiple packets of the first type corresponds to the request for sensor data at the second particular time and that the request for sensor data at the second particular time is the second type of request, wherein the second type of request is different from the first type of request, the first device transmits, to the third device (e.g., in order of capture of the sensor data), the multiple packets of the third type.

In some embodiments, the determination that the request for sensor data at the second particular time is the second type of request includes a determination that the third device is a resident device (and/or a hub device). In some embodiments, the multiple packets of the third type are TCP packets.

In some embodiments, the determination that the request for sensor data at the second particular time is the first type of request includes a determination that the third device is a user device (and/or a personal device). In some embodiments, the multiple packets of the second type are UDP datagrams.

In some embodiments, the multiple data packets of the first type are packets in accordance with (and/or confirming to) the Real-time Transport Protocol. In some embodiments, the multiple packets of the first type are RTP packets. In some embodiments, the multiple packets of the first type of SRTP packets.

In some embodiments, in conjunction with (e.g., before, while, in response to, as part of, and/or after) storing the multiple packets of the first type, the first device adds (e.g., to a buffer including the multiple packets of the first type, to each packet of the multiple packets of the first type, and/or to a mapping table) an indication (e.g., a start indication, a marker, and/or a start marker) for separating different sets of packets of the first type within the multiple packets of the first type, wherein the indication is added to separate the first portion of the multiple packets of the first type from the second portion of the multiple packets of the first type. In some embodiments, the indication for separating different sets of packets of the first type within the multiple packets of the first type is a storage hierarchy of the multiple packets of the first type, such that a packet of the multiple packets of the first type is stored in manner in which indicates that the packet is start a different set of packets of the first type. In some embodiments, the different sets of packets of the first type are groups of pictures. In some embodiments, a set of packets of the first type is a group of pictures. In some embodiments, a group of pictures includes a single I-frame and/or a point at which the second device is able to decode one or more packets. In some embodiments, the different sets of packets of the first type correspond to groups that are required for decoding (e.g., an entire group must be transmitted so as to be able to be decoded) by a receiver, such as the second device.

In some embodiments, the determination that the first portion of the multiple packets of the first type corresponds to the request for sensor data at the particular time includes: a determination that a packet within the first portion of the multiple packets of the first type corresponds to the particular time (e.g., each packet of the multiple packets of the first type corresponds to a different time, such as when sensor data corresponding to the packet was captured); and a determination, based on the indication for separating different sets of packets of the first type within the multiple packets of the first type, that the first portion is a closest separation between different sets of packets of the first type before the packet within the first portion of the multiple packets of the first type corresponding to the particular time. In some embodiments, the determination that the first portion is the closest separation between different sets of packets of the first type before the packet within the first portion of the multiple packets of the first type corresponding to the particular time is performed so that the first device is able to transmit a set of packets to the second device that the second device is able to decode (e.g., the second device is not able to decode packets if not provided all packets of a set of packets).

In some embodiments, in conjunction with (e.g., before, while, in response to, as part of, and/or after) storing the multiple packets of the first type, the first device adds (e.g., to a buffer including the multiple packets of the first type, to each packet of the multiple packets of the first type, and/or to a mapping table) an indication for mapping a wall clock and a clock for one or more packets of the multiple packets of the first type in order to identify data packets that correspond to a time specified in a request (e.g., the request for sensor data at the particular time), wherein the determination that the first portion of the multiple packets of the first type corresponds to the request for sensor data at the particular time is based on the indication for mapping the wall clock and a clock for one or more packets of the multiple packets of the first type. In some embodiments, the indication for mapping the wall clock and a clock for one or more packets of the multiple packets of the first type is a storage hierarchy of the multiple packets of the first type, such that a packet of the multiple packets of the first type is stored in manner in which indicates how a time corresponding to the packet can be converted to the wall clock. In some embodiments, the indication for mapping the wall clock and a clock for one or more packets of the multiple packets of the first type is required as a result of more packets of the first type being stored than a time indication within packets of the first type to be able to differentiate (e.g., a time indication within packets of the first type is forced to restart (e.g., start at zero) while another packet is stored with the same time indication (e.g., zero)).

In some embodiments, in response to receiving the request for sensor data at the particular time and in accordance with the determination that the first portion of the multiple packets of the first type corresponds to the request for sensor data at the particular time, the first device transmits, to the second device, the indication for mapping the wall clock and a clock for one or more packets of the multiple packets of the first type. In some embodiments, the indication for mapping the wall clock and a clock for one or more packets of the multiple packets of the first type is not transmitted to the second device and instead the indication for mapping the wall clock and a clock for one or more packets of the multiple packets of the first type is used by the first device to determine which packets to transmit but not used by the second device (such as when decoding packets).

In some embodiments, before storing the multiple packets of the first type (and/or as a part of packetizing the sensor data into multiple packets of the first type), the first device encrypts, using a master key, the multiple packets of the first type, wherein the multiple packets of the first type are stored after being encrypted (e.g., and not stored unencrypted).

In some embodiments, before encrypting, the first device uses the master key, the multiple packets of the first type, generating the master key (e.g., the master key is not received from another device, such as the second device, different from the first device). In some embodiments, the master key is generated by the first device.

In some embodiments, the sensor data is first sensor data. In some embodiments, the multiple packets of the first type is a first set of multiple packets of the first type. In some embodiments, after encrypting, the first device uses the master key, the first set of multiple packets of the first type and in response to a determination that a predefined set of one or more criteria is satisfied with respect to the master key (e.g., an amount of time or a number of packets encrypted using the master key has been reached), rolling (replaces with a new master key) the master key. In some embodiments, rolling the master key includes generating a new master key and writing over the master key with the new master key such that a previous master key is no longer known by the first device. In some embodiments, after rolling the master key, the first device captures, via the sensor, second sensor data (e.g., media data, such as video, audio, and/or one or more images) separate from the first sensor data. In some embodiments, in response to capturing the second sensor data, the first device encodes the second sensor data into encoded sensor data (the encoded sensor data is sometimes referred to as “the sensor data” below unless explicitly mentioned otherwise), such as encoded video data using a video encoder. In some embodiments, the second sensor data includes one or more groups of pictures. In some embodiments, the second sensor data includes and/or consists of sensor data captured sequentially. In some embodiments, after (and/or in response to) capturing the second sensor data (and/or after and/or in response to encoding the second sensor data), the first device packetizes the second sensor data into a second set of multiple packets of the first type (e.g., RTP or SRTP packets) separate from the first set of multiple packets of the first type. In some embodiments, the second set of multiple packets of the first type, taken together, represent multiple groups of pictures. In some embodiments, the second set of multiple packets of the first type, taken together, represent a single group of pictures. In some embodiments, a beginning packet and/or an initial packet of the second set of multiple packets of the first type is required to be used to decrypt, decode, and/or otherwise use the second set of multiple packets of the first type. In some embodiments, in response to (and/or after) packetizing the second sensor data into the second set of multiple packets of the first type, the first device stores (e.g., in a buffer in disk and/or memory, such as a circular buffer or other data structure) the second set of multiple packets of the first type (e.g., with or without transmitting the second set of multiple packets outside of the first device). In some embodiments, the second set of multiple packets of the first type are stored in long-term memory and/or short-term memory, such as in the same buffer and/or with the first set of multiple packets of the first type.

In some embodiments, the first device receives, from the second device, a public key. In some embodiments, the second device retains a private key corresponding to the public key such that the second device is able to decode content encrypted using the public key. In some embodiments, after receiving the public key, the first device encrypts, using the public key, the master key to produce an encrypted master key. In some embodiments, the first device transmits (e.g., as part of live streaming sensor data and/or as part of transmitting, to the second device, the multiple packets of the second type), to the second device, the encrypted master key. In some embodiments, the master key was used by the first device to encrypt the sensor data included in the multiple packets of the first type.

In some embodiments, the public key is a first public key. In some embodiments, the encrypted master key is a first encrypted master key. In some embodiments, the first device receives, from a fourth device (e.g., a computer system, a receiver device, and/or an electronic device) separate from the first device and the second device, a second public key different from the first public key. In some embodiments, the fourth device retains a private key corresponding to the second public key such that the fourth device is able to decode content encrypted using the second public key. In some embodiments, the second device and/or the fourth device are registered with the first device to receive and/or be able to receive sensor data from the first device. In some embodiments, the fourth device is a watch, a phone, a tablet, a fitness tracking device, a processor, a head-mounted display (HMD) device, a communal device, a media device, a speaker, a television, an electronic device, and/or a personal computing device. In some embodiments, the fourth device is a different type of device than the first device, such as the first device is a sensor device and the fourth device is a personal device. In some embodiments, after receiving the second public key, the first device encrypts, using the second public key, the master key to produce a second encrypted master key separate from the first encrypted master key. In some embodiments, the second encrypted master key is stored with the first encrypted master key, such as within a data structure including encrypted master keys for different devices. In some embodiments, the first encrypted master key and/or the second encrypted master key are stored with (such as within a buffer including) the multiple packets of the first type. In some embodiments, the first encrypted master key and/or the second encrypted master key are stored adjacent to the indication for separating different sets of packets of the first type within the multiple packets of the first type and/or the indication for mapping the wall clock and a clock for one or more packets of the multiple packets of the first type. In some embodiments, the first device transmits (e.g., as part of live streaming sensor data and/or as part of transmitting, to the fourth device, the multiple packets of the second type), to the fourth device (and/or the second device), the second encrypted master key. In some embodiments, the master key was used by the first device to encrypt the sensor data included in the multiple packets of the first type.

In some embodiments, after encrypting, the first device uses the public key, the master key to produce the encrypted master key, detecting that the second device is no longer configured (and/or registered) to receive (and/or be able to receive) sensor data from the first device. In some embodiments, detecting that the second device is no longer configured to receive sensor data from the first device includes receiving, from the second device or another device (such as a server, a resident device, and/or a hub device) separate from the first device and the second device, an indication that the second device is no longer configured (and/or registered) to receive (and/or be able to receive) sensor data from the first device. In some embodiments, in response to detecting that the second device is no longer configured (and/or registered) to receive (and/or be able to receive) sensor data from the first device, the first device removes (e.g., deletes and/or removes an association for) the encrypted master key from being stored with respect to packets of the first type previously stored. In some embodiments, after detecting that the second device is no longer configured (and/or registered) to receive (and/or be able to receive) sensor data from the first device, the first device forgoes association of the encrypted master key (and/or future encrypted master keys corresponding to the second device) with packets of the first type.

In some embodiments, the encrypted master key is a first encrypted master key. In some embodiments, after encrypting, the first device uses the public key, the master key to produce the first encrypted master key, detecting that a fifth device (e.g., a computer system, a receiver device, and/or an electronic device) is now (e.g., newly and/or added to be) configured (and/or registered) to receive (and/or be able to receive) sensor data from the first device. In some embodiments, detecting that the fifth device is now configured to receive sensor data from the first device includes receiving, from the fifth device or another device (such as a server, a resident device, and/or a hub device) separate from the first device and the fifth device, an indication that the fifth device is now configured (and/or registered) to receive (and/or be able to receive) sensor data from the first device. In some embodiments, the fifth device is a watch, a phone, a tablet, a fitness tracking device, a processor, a head-mounted display (HMD) device, a communal device, a media device, a speaker, a television, an electronic device, and/or a personal computing device. In some embodiments, the fifth device is a different type of device than the first device, such as the first device is a sensor device and the fifth device is a personal device. In some embodiments, in response to detecting that the fifth device is now configured (and/or registered) to receive (and/or be able to receive) sensor data from the first device, the first device encrypts, using a public key received from the fifth device, the master key to produce a third encrypted master key separate from the first encrypted master key. In some embodiments, the third encrypted master key is stored with the first encrypted master key, such as within a data structure including encrypted master keys for different devices. In some embodiments, the first encrypted master key and/or the third encrypted master key are stored with (such as within a buffer including) the multiple packets of the first type. In some embodiments, the first encrypted master key and/or the third encrypted master key are stored adjacent to the indication for separating different sets of packets of the first type within the multiple packets of the first type and/or the indication for mapping the wall clock and a clock for one or more packets of the multiple packets of the first type. In some embodiments, the first device transmits (e.g., as part of live streaming sensor data and/or as part of transmitting, to the fifth device, the multiple packets of the second type), to the fifth device (and/or the second device), the third encrypted master key. In some embodiments, the master key was used by the first device to encrypt the sensor data included in the multiple packets of the first type.

In some embodiments, the multiple packets of the second type are transmitted to the second device via a first communication channel. In some embodiments, in conjunction with (e.g., before, while, or after) transmitting, to the second device (e.g., in order of capture of the sensor data) (and/or after encrypting the multiple packets of the first type), the multiple packets of the second type via the first communication channel, the first device transmits, to the second device, via a second communication channel separate (and/or different) from the first communication channel, a representation (e.g., the master key itself and/or an encrypted version of the master key as described above) of the master key (e.g., the representation of the master key is transmitted out of band of transmitting the multiple packets of the second type). In some embodiments, the first communication channel is an encrypted communication channel or an unencrypted communication channel. In some embodiments, the second communication channel is an encrypted communication channel or an unencrypted communication channel. In some embodiments, the representation of the master key is able to be transmitted via an unencrypted communication channel as a result of the representation of the master key being an encrypted representation of the master key.

In some embodiments, the first device as part of transmitting, to the second device (e.g., in order of capture of the sensor data) (and/or after encrypting the multiple packets of the first type), the multiple packets of the second type (and/or as part of live streaming sensor data to the second device), transmitting, to the second device, a representation (e.g., the master key itself and/or an encrypted version of the master key as described above) of the master key (e.g., the representation of the master key is transmitted in band with transmitting the multiple packets of the second type). In some embodiments, the representation of the master key is transmitted as part of each packet of the multiple packets of the second type, such as within a key field of each packet of the multiple packets of the second type. In some embodiments, the representation of the master key is transmitted separate from packets of the multiple packets of the second type but via the same communication channel as the multiple packets of the second type are transmitted.

In some embodiments, before transmitting, to the second device, the multiple packets of the second type, the first device initializes live streaming of sensor data captured via the sensor, wherein the multiple packets of the second type are transmitted to the second device as part of the live streaming. In some embodiments, after initializing the live streaming of sensor data captured via the sensor (and/or while the live streaming is maintained), the first device receives, from a sixth device (e.g., a computer system, a receiver device, and/or an electronic device) separate from the first device and the second device, a request to join the live streaming of sensor data captured via the sensor. In some embodiments, the sixth device is a watch, a phone, a tablet, a fitness tracking device, a processor, a head-mounted display (HMD) device, a communal device, a media device, a speaker, a television, an electronic device, and/or a personal computing device. In some embodiments, the sixth device is a different type of device than the first device, such as the first device is a sensor device and the sixth device is a personal device.

In some embodiments, after receiving the request to join the live streaming of sensor data captured via the sensor and in conjunction with (e.g., before, while, or after) transmitting, to the second device, the multiple packets of the second type, the first device transmits, to the sixth device (e.g., in order of capture of the sensor data), the multiple packets of the second type.

In some embodiments, before transmitting, to the second device, the multiple packets of the second type, the first device initializes live streaming of sensor data captured via the sensor, wherein the multiple packets of the second type are transmitted to the second device as part of the live streaming. In some embodiments, while the live streaming of sensor data captured via the sensor is maintained and after transmitting, to the second device, the multiple packets of the second type, the first device detects that the first device is no longer live streaming sensor data to another device separate from the first device (e.g., that the first device is live streaming locally to the first device, such as storing packets of the first type). In some embodiments, detecting that the first device is no longer live streaming sensor data to another device separate from the first device includes receiving, from the second device, an indication that the second device is no longer requesting the live streaming. In some embodiments, while the live streaming of sensor data captured via the sensor is maintained and after transmitting, to the second device, the multiple packets of the second type, in response to detecting that the first device is no longer live streaming sensor data to another device separate from the first device, the first device continues storage (e.g., in a buffer in disk and/or memory, such as a circular buffer or other data structure) of packets of the first type (e.g., including and/or corresponding to sensor data captured via the sensor) as part of the live streaming (e.g., without transmitting the packets of the first type outside of the first device). In some embodiments, continuing storage of the packets of the first type is continuing local storage of the packets of the first type on the first device. In some embodiments, live streaming includes packetizing and storing sensor data as the sensor data is captured.

In some embodiments, the sensor data is video data. In some embodiments, the sensor is a camera. In some embodiments, the first device includes (and/or is in communication with) a microphone (e.g., integrated within or separate from the camera). In some embodiments, the multiple packets of the first type are a first set of multiple packets of the first type. In some embodiments, the multiple packets of the second type are a first set of multiple packets of the second type. In some embodiments, in conjunction with (e.g., before, after, or while) capturing the video data, the first device captures, via the microphone, audio data. In some embodiments, in response to capturing the audio data, the first device encodes the audio data into encoded audio data (the encoded audio data is sometimes referred to as “the audio data” below unless explicitly mentioned otherwise), such as encoded audio data using an audio encoder. In some embodiments, the audio data corresponds to the video data such that the audio data is captured at the same time as the video data to represent visual and acoustic data at a point in time. In some embodiments, the audio data includes and/or consists of audio data captured sequentially. In some embodiments, after (and/or in response to) capturing the audio data (and/or after and/or in response to encoding the audio data), the first device packetizes the audio data into a third set of multiple packets of the first type separate from the first set of multiple packets of the first type. In some embodiments, a beginning packet and/or an initial packet of the third set of multiple packets of the first type is required to be used to decrypt, decode, and/or otherwise use the third set of multiple packets of the first type. In some embodiments, a single frame of the audio data is packetized into multiple packets of the first type. In some embodiments, in response to (and/or after) packetizing the audio data into the third set of multiple packets of the first type (and/or in accordance with a determination that the first device is not streaming data to another device different from the first device), the first device stores (e.g., in a buffer in disk and/or memory, such as a circular buffer or other data structure) the third set of multiple packets of the first type (e.g., without transmitting the third set of multiple packets of the first type outside of the first device). In some embodiments, in response to (and/or after) packetizing the audio data into the third set of multiple packets of the first type and in accordance with a determination that the first device is streaming data to another device different from the first device, the first device stores or forgoes storage of the third set of multiple packets of the first type. In some embodiments, the third set of multiple packets of the first type are stored in long-term memory and/or short-term memory. In some embodiments, storing the third set of multiple packets of the first type is locally storing the third set of multiple packets of the first type on the first device. In some embodiments, the third set of multiple packets of the first type is stored with the first set of multiple packets of the first type, such as within the same buffer. In some embodiments, the third set of multiple packets of the first type is stored separate from the first set of multiple packets of the first type, such as within a different buffer. In some embodiments, the first set of multiple packets of the first type are encrypted via a first master key as described above. In some embodiments, the third set of multiple packets of the first type are encrypted via the first master key. In some embodiments, the third set of multiple packets of the first type are encrypted via a second master key different from the first master key. In some embodiments, in response to receiving the request for sensor data at the particular time and in accordance with a determination that a first portion of the third set of multiple packets of the first type corresponds to the request for sensor data at the particular time (and/or that a second portion, different from the first portion, of the third set of multiple packets of the first type does not correspond to the request for sensor data at the particular time), the first device packetizes the first portion of the third set of multiple packets of the first type into a second set of multiple packets of the second type (e.g., without packetizing the second portion of the third set of multiple packets of the first type) separate from the first set of multiple packets of the second type. In some embodiments, the second set of multiple packets of the second type are different from the third set of multiple packets of the first type. In some embodiments, in response to receiving the request for sensor data at the particular time and in accordance with a determination that the second portion of the third set of multiple packets of the first type does not correspond to the request for sensor data at the particular time, the first device forgoes packetization of the second portion of the third set of multiple packets of the first type. In some embodiments, the second set of multiple packets of the second type is TCP packets or UDP datagrams. In some embodiments, in response to receiving the request for sensor data at the particular time and in accordance with the determination that the first portion of the third set of multiple packets of the first type corresponds to the request for sensor data at the particular time, the first device transmits, to the second device (e.g., in order of capture of the audio data), the second set of multiple packets of the second type.

In some embodiments, the first device includes a first encoder (e.g., a video or an audio encoder) and a second encoder (e.g., a video or an audio encoder) separate from the first encoder. In some embodiments, the first encoder encodes sensor data with a first quality level. In some embodiments, the second encoder encodes sensor data with a second quality level different from (e.g., more or less than) the first quality level. In some embodiments, the multiple packets of the first type is a first set of multiple packets of the first type. In some embodiments, sensor data encoded with the first quality level requires less resources to transmit than when encoded with the second quality level. In some embodiments, after capturing, via the sensor, the sensor data and before packetizing the sensor data into the first set of multiple packets of the first type, the first device encodes, using the first encoder, the sensor data to produce first encoded data, wherein the sensor data packetized into the first set of multiple packets of the first type is the first encoded data. In some embodiments, after capturing, via the sensor, the sensor data and before packetizing the sensor data into the first set of multiple packets of the first type, the first device encodes, using the second encoder, the sensor data to produce second encoded data different from the first encoded data. In some embodiments, after encoding the second sensor data to produce the second encoded data, the first device packetizes the second encoded data into a fourth set of multiple packets of the first type different from the first set of multiple packets of the first type. In some embodiments, the fourth set of multiple packets of the first type, taken together, represent multiple groups of pictures. In some embodiments, the fourth set of multiple packets of the first type, taken together, represent a single group of pictures. In some embodiments, a beginning packet and/or an initial packet of the fourth set of multiple packets of the first type is required to be used to decrypt, decode, and/or otherwise use the fourth set of multiple packets of the first type. In some embodiments, the fourth set of multiple packets of the first type is encrypted using the same master key as the first set of multiple packets of the first type. In some embodiments, the first set of multiple packets of the first type is encrypted using a first master key. In some embodiments, the fourth set of multiple packets of the first type is encrypted using the first master key. In some embodiments, the fourth set of multiple packets of the first type is encrypted using a second master key different from the first master key. In some embodiments, in response to (and/or after) packetizing the second encoded data into the fourth set of multiple packets of the first type (and/or in accordance with the determination that the first device is not streaming data to another device different from the first device), the first device stores (e.g., in a buffer in disk and/or memory, such as a circular buffer or other data structure) the fourth set of multiple packets of the first type (e.g., without transmitting the fourth set of multiple packets of the first type outside of the first device). In some embodiments, in response to (and/or after) packetizing the second encoded data into the fourth set of multiple packets of the first type and in accordance with a determination that the first device is streaming data to another device different from the first device, the first device stores or forgoes storage of the fourth set of multiple packets of the first type. In some embodiments, the fourth set of multiple packets of the first type are stored in long-term memory and/or short-term memory. In some embodiments, storing the fourth set of multiple packets of the first type is locally storing the fourth set of multiple packets of the first type on the first device. In some embodiments, depending on a bandwidth of the second device, the first device transmits packets of the second type including the first set of multiple packets of the first type or the fourth set of multiple packets of the first type (e.g., less bandwidth uses the first set of multiple packets of the first type and more bandwidth uses the fourth set of multiple packets of the first type).

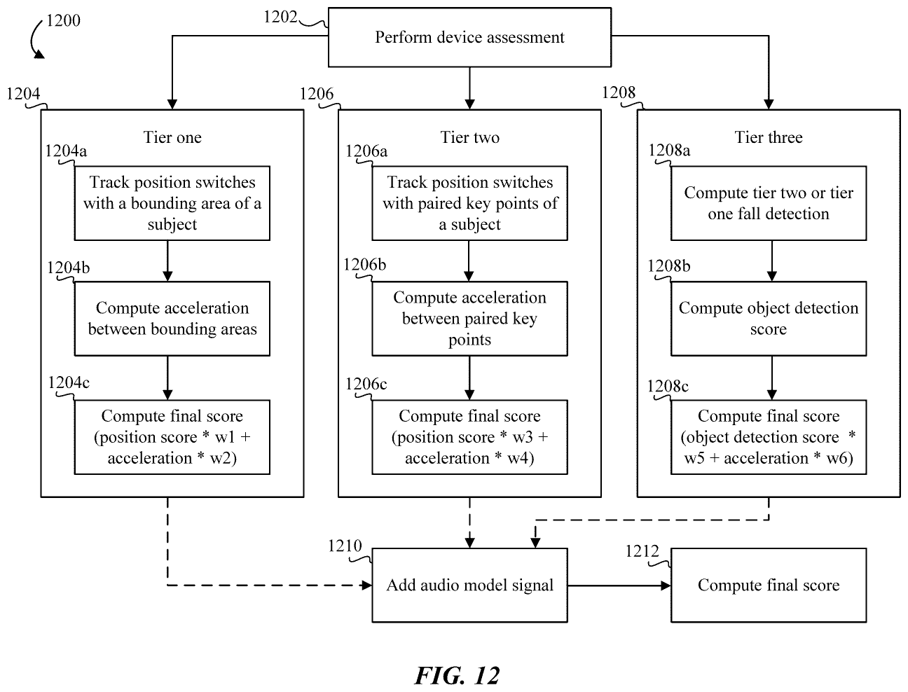

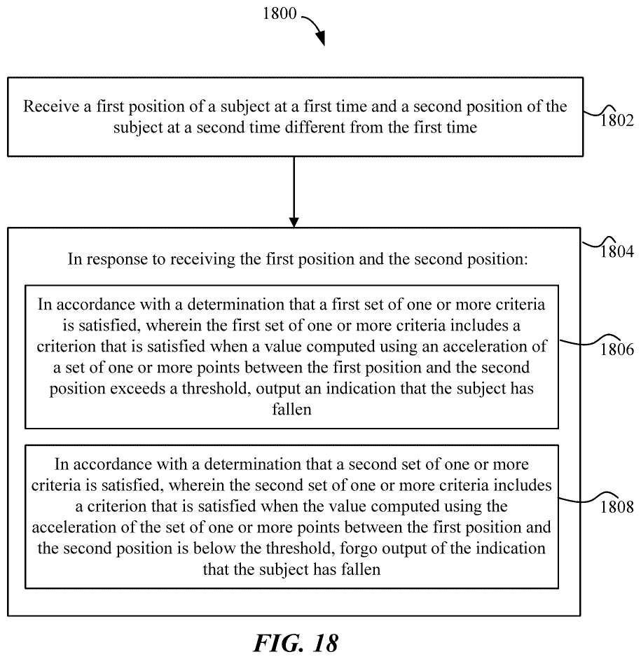

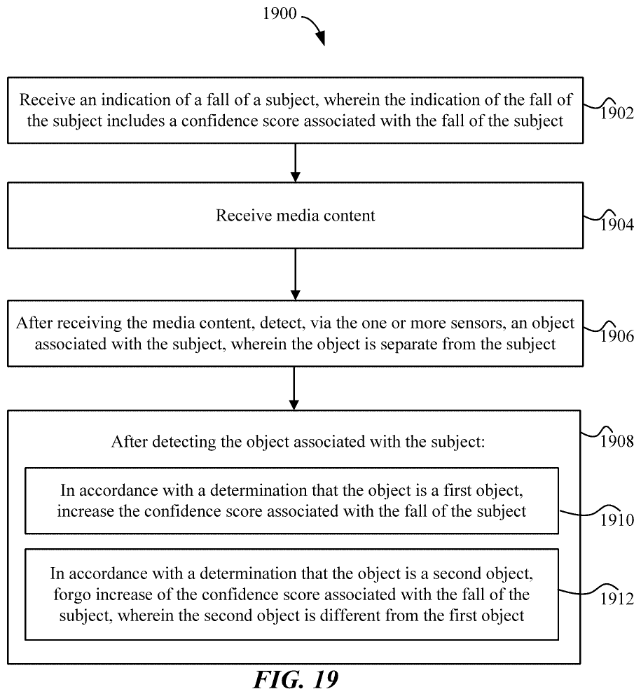

FIG. 12 illustrates exemplary processes for detecting that a subject has fallen in accordance with some embodiments. The processes in this figure are used to illustrate the processes described below, including the processes in FIGS. 18-19.

As described further below, process 1200 identifies the subject in different frames and determines whether the subject has fallen based on changes between the different frames. For example, process 1200 can identify a change in position and/or acceleration of the subject between the different frames to determine whether the subject has fallen. In some embodiments, the position of the subject is a pose, orientation, and/or location of the subject. It should be recognized that falling is one example of an activity that can be detected using techniques described herein and that other activities can be detected, such as talking, eating, and/or performing an exercise.

In some embodiments, process 1200 includes different tiers of techniques that use different amounts of compute. In such embodiments, process 1200 can proceed according to different tiers depending on an amount of compute available on a device. To determine the amount of compute available on the device, process 1200 can include performing (1202) a device assessment of the device.

In some embodiments, performing the device assessment includes detecting resources of the device, such as processing power (e.g., CPU clock speed, number of CPU cores, and/or workload capacity), amount of available memory, memory bandwidth, storage throughput, network bandwidth, available hardware (e.g., camera sensor, thermal sensor, depth sensor, IMU, microphone, and/or audio processor), battery level, operating system version, video encoding capability, frame processing capability, thermal headroom, sampling rate, and/or presence of specialized hardware accelerators (e.g., Graphics Processing Unit (GPU), Neural Processing Unit (NPU), Tensor Processing Unit (TPU), and/or Digital Signal Processor (DSP)). For example, performing the device assessment can assess whether available memory on the device is below a first threshold, such as less than 2-200 megabytes, indicating a limited compute level qualifying for tier one 1204. For another example, performing the device assessment can assess whether the available memory on the device is between the first threshold and a second threshold, such as 200-1000 megabytes, indicating a moderate compute level qualifying for tier two 1206. For another example, performing the device assessment can assess whether the available memory on the device is above the second threshold, such as 1000 megabytes or more, indicating a higher compute level qualifying for tier three 1208.

In some embodiments, the device assessment is performed by the device to determine which tier to execute on the device. For example, the device can identify a current level of compute available on the device and, in response, perform instructions for a tier corresponding to the current level of compute available. In other embodiments, the device assessment is performed by a server in communication with the device, causing the server to instruct the device to perform instructions for a tier and/or loading instructions on the device for the tier (e.g., with or without loading instructions on the device for other tiers). In such embodiments, the server can perform the device assessment once or periodically (e.g., before, during, and/or after executing process 1200). For example, the server can maintain compute and/or hardware specifications of the device and, upon device registration or network connection, can determine an appropriate tier of processing for the device.

In some embodiments, the device assessment is performed at different times, such as when configuring the device, at device startup, during initial connection to a home network, when communicating with a server (e.g., the server performs the device assessment as described above), periodically during device operation (e.g., in real-time, continuously during execution of process 1200 or a different process, based on a system event, and/or periodically), and/or when fall detection is requested. For example, in such embodiments, when the device assessment results in a determination that a limited compute level is available, one or more software modules of tier one 1204, such as a probabilistic model, are loaded into active memory and/or are executed. For another example, when the device assessment results in a determination that a higher compute level is available, one or more software modules of tier three 1208, such as an object detection library, position estimation module, neural network weights, and/or multi-dimensional arrays, are loaded into active memory and/or are executed. For another example, when the device assessment results in a determination that the compute level has decreased during execution, the device can selectively unload and/or release allocated resources for higher tiers (e.g., tier two and/or tier three).

In some embodiments, the device assessment causes the device to select a processing tier by prioritizing fall detection accuracy over available computational resources on a device. For example, if a first camera has a lower compute level than a second camera, but the first camera has a higher-quality field of view (e.g., closer proximity to the subject, better lighting conditions, and/or more optimal field-of-view angle) for a certain tier that is determined and/or estimated to produce higher fall detection accuracy, the device can select the first camera over the second camera despite the lower compute level of the first camera. In other embodiments, the device can select the second camera based on the higher compute level of the second camera when the device assessment results in a determination (e.g., historically and/or dynamically) that processing fall detection at a higher tier produces greater fall detection accuracy as compared to, for example, having higher resolution and/or better lighting conditions. For another example, if a third camera and a fourth camera have the same compute level, and the fourth camera is in closer proximity to the subject, the device can select the fourth camera to execute process 1200.

In some embodiments, the device assessment is performed by aggregating a global compute level from multiple devices to determine which tier to execute and/or on which device. For example, the device assessment can assess available computational resources across one or more cameras, accessory devices, sensors, speakers, and/or hub devices within an environment and/or home accessory ecosystem to process fall detection, such as including distributing, coordinating, and/or synchronizing tier-specific sub-process tasks across different devices. In such an example, a first device with a camera can track (1206a) position switches with paired key points of the subject and send results to a hub device with a computational resource and/or dedicated sensor to compute (1206b) acceleration of paired key points, add (1210) audio model signal, and/or compute (1212) a final score, allowing fall detection to be performed using collaboration of multiple devices for collectively satisfying computational overhead of a tier-based fall detection process.

In some embodiments, process 1200 is performed using media content (e.g., video, image, and/or audio) captured by the device or another device in a home accessory ecosystem. For example, the media content can be captured by a camera, a microphone, a surveillance camera, a home security camera, a smart doorbell, a mobile device, and/or other capture device. In some embodiments, a bounding area, as used further below, is a geometric shape that surrounds and/or encompasses the subject in a video frame, such as a rectangle, quadrilateral, and/or any other closed shape that contains an entirety or a majority of the subject. In some embodiments, the bounding area is determined using computer vision techniques, such as edge detection, contour analysis, foreground-background separation, pixel clustering, and/or optical flow.

In some embodiments, tier one 1204 implements fall detection using techniques adapted to when a limited compute level is determined on the device. As illustrated in FIG. 12, tier one 1204 includes tracking position switches with a bounding area of the subject, such as orientation and/or dimension changes of the bounding area across consecutive frames, using probabilistic distributions, computing acceleration between bounding areas, and/or computing a final score by combining a position score and an acceleration-based score.

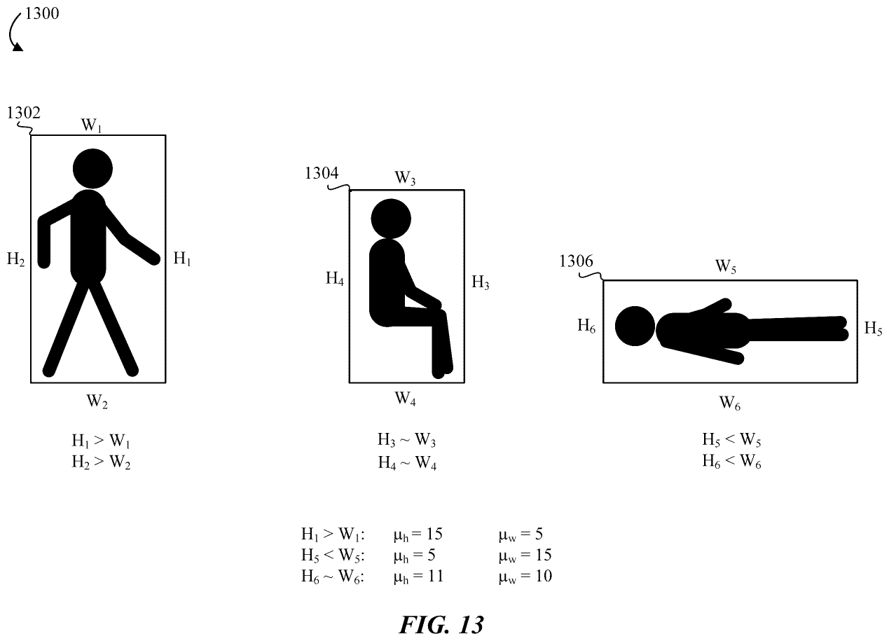

In some embodiments, tracking the position switches with the bounding area of the subject uses a learning model (e.g., clustering algorithm, statistical learning model, probabilistic model, distribution learning model, and/or density estimation), such as a Gaussian Mixture Model (GMM), to classify a position of the subject (e.g., standing, sitting, and/or lying) based on observed characteristics of the bounding area of the subject across frames in the media content. In some embodiments, the learning model identifies a number of most important and/or distinct position distributions (e.g., N or K distributions) that model different positions of the subject without requiring prior specification and/or labeling of the different positions. In such embodiments, the learning model operates in a camera-agnostic manner and adapts to different environmental conditions and/or field-of-view of the device by observing patterns in the media content in particular environmental conditions and/or camera position without requiring predefined cluster definitions. For example, distributions representing standing, sitting, and/or lying positions can have different height-to-width ratios for a camera mounted in a bird's eye view position as compared to a front-facing camera position. It should be recognized that the learning model can result in position observations and/or clusters different from positions (e.g., 1302, 1304 and 1306) illustrated in FIG. 13. In the example illustrated in FIG. 13, the learning model was provided with a cluster number that is set to 3, which resulted in the learning model separating observations into “standing” position 1302, “sitting” position 1304, and “lying” position 1306. In another example different from the example illustrated in FIG. 13, the learning model can make different observations based on the same cluster number that is set to 3, such as “subject not present in frame”, “subject present in frame”, and “subject in sitting position”. In some embodiments, different position distributions determined by the learning model are labeled in an additional process, not illustrated in FIG. 12, for downstream logic, such as monitoring a change from one labeled position (e.g., standing and/or sitting) to another labeled position (e.g., lying and/or leaning), for fall detection.

In some embodiments, each distribution in the learning model includes parameters such as a mean value, variance (covariance), and/or relative importance weight (mixing coefficient). These parameters can allow tracking the position switches with the bounding area of the subject by evaluating characteristics of the bounding area (e.g., a first bounding area in a first frame or a second bounding area in a second frame) against multiple learned distributions for determining a most probable match to a position. For example, a distribution representing a “standing” position can have a mean height-to-width ratio significantly greater than 1.0, a relatively small variance, and an importance weight that reflects how frequently the standing position is observed. For another example, a distribution representing a lying position can have a mean height-to-width ratio significantly lower than 1.0, a different or similar variance, and a different or similar importance weight based on observation frequency of the lying position. In some embodiments, such parameters are continuously updated as new frames of the media content are processed to adapt the distributions to changes in camera orientation, subject characteristics, and/or environmental conditions.

In some embodiments, tracking the position switches with the bounding area of the subject generates a confidence score (e.g., 0-1 or 0-100%) based on how closely the bounding area of the subject matches a distribution. In some embodiments, the confidence score computes a statistical distance between a value (e.g., height, width, and/or height-to-width ratio) of the bounding area and learned distributions, such as how far a current observation is from a mean of a distribution and/or while accounting for a variance of the distribution. In other embodiments, a probability density function value is calculated for a value of the bounding area, such as a height-to-width ratio, against each learned distribution, with a higher value indicating stronger alignment with a particular position. In other embodiments, a normalized likelihood is computed across all distributions to calculate a probability of the bounding area matching a position, such as determining that the bounding area has a 0.85 probability of matching a “standing” distribution, a 0.11 probability of matching a “sitting” distribution, and a 0.04 probability of matching a “lying” distribution, all adding up to 1. In some embodiments, confidence scores are computed for both a starting position and ending position across sequential frames (and/or a middle position, such as at a middle point of the media content). In some embodiments, a fast (e.g., determined in computing (1204b) acceleration of bounding areas described below) and significant change in these confidence scores across sequential frames (e.g., a drop from 0.9 to 0.2 in standing position confidence with an increase from 0.05 to 0.8 in lying position confidence within 15-30 frames at a device capturing 30 frames per second) serves as an indicator of a potential fall event.

In some embodiments, tracking the position switches with the bounding area of the subject is used for computing temporal geometric characteristics and/or transformations in the bounding area around the subject across frames in the media content to identify position changes, such as from a “sitting” position or “standing” position to a “lying” position or a “horizontal” position. For example, an inversion of a height-to-width ratio can be detected between a first frame with the subject in a vertical orientation (e.g., with a height-to-width ratio of 3:1 of the bounding area) and a second frame after the first frame with the subject in a horizontal orientation (e.g., with a height-to-width ratio of 1:3 of the bounding area), where this height-to-width ratio reversal indicates a 90-degree positional change characteristic of a fall event. In other embodiments, tracking the position switches with the bounding area of the subject analyzes other geometric properties of the bounding area across frames to identify a fall event. For example, an amount of change in corner point coordinates and/or surface area of the bounding area can be computed, such as, in case of a vertical fall, downward displacement of top corners can be detected while bottom corners remain relatively stationary, which creates a trapezoidal deformation pattern during a transition from a “standing” position to a “lying” position of a potential fall event. For another example, variations in a centroid of the bounding area can be computed, where a fast downward displacement of the centroid of the bounding area combined with changes in a shape of the bounding area can indicate a descent consistent with a fall event rather than controlled movement such as sitting and/or bending.

In some embodiments, as described above and as illustrated in FIG. 13, tracking the position switches with the bounding area of the subject is used to determine different positions of the subject based on a height-to-width ratio of the bounding area of the subject. FIG. 13 illustrates exemplary values of a bounding area and exemplary values of distributions of the learning model in accordance with some embodiments. FIG. 13 illustrates a “standing” position 1302, a “sitting” position 1304, and a “lying” position 1306, each characterized by a particular height-to-width ratio. As described above, these three positions are, in some embodiments, only a portion of positions generated by the learning model.

In some embodiments, “standing” position 1302 is illustrated with the bounding area around the subject that is characterized by height (H₁) being significantly greater than width (W₁) and/or height (H₂) being significantly greater than width W₂. For example, as indicated in FIG. 13, positions similar to “standing” position 1302 can fall within and/or contribute to a distribution with a mean height (Un) trending toward 15 units and a mean width (U_{w}) trending toward 5 units, yielding a height-to-width ratio where height substantially exceeds width. In some embodiments, “sitting” position 1304 is illustrated with the bounding area characterized by height (H₃) being approximately equal to width (W₃) and/or height (H₄) being approximately equal to width (W₄). For example, as indicated in FIG. 13, positions similar to “sitting” position 1304 can fall within and/or contribute to a distribution with a mean height (Uₕ) trending toward 10 units and a mean width (U_{w}) trending toward 10 units, yielding a height-to-width ratio where height and width are roughly equal and/or within a small margin of equivalence. In some embodiments, “lying” position 1306 is illustrated with the bounding area characterized by height (H₅) being significantly lower than width (W₅) and/or height (H₆) being significantly lower than width (W₆). For example, as indicated in FIG. 13, positions similar to “lying” position 1306 can fall within and/or contribute to a distribution with a mean height (Uₕ) trending toward 5 units and a mean width (U_{w}) trending toward 15 units, representing positions where width substantially exceeds height. As described above, the learning model used by tracking the position switches with the bounding area of the subject continuously updates these distribution means as new bounding areas in incoming frames are analyzed. For example, with “standing” position 1302 having height H₁ equal to 13 units and width W₁ equal to 7 units, the learning model can apply an update function (e.g., exponential moving average with learning rate α, where 0<α≤1) to adjust the means of a “standing” position distribution, resulting in new mean values, such as, for example, (Uₕ) trending toward 14.8 units and (U_{w}) trending towards 5.2 units, to reflect a slight shift toward the newly observed bounding area while maintaining the characterizing height-to-width relationship of the “standing” position distribution. In some embodiments, the learning model implements an adaptive learning rate that decreases over time to stabilize distribution parameters once sufficient observations have been processed.

In some embodiments, computing (1204b) acceleration between bounding areas analyzes movement of the subject across sequential frames to identify a fast change of a position of the subject. In some embodiments, computing the acceleration between the bounding areas includes tracking positional changes of reference points in the bounding area between sequential frames in the media content. For example, computing the acceleration between the bounding areas can track four corners of the bounding area (e.g., top-left, top-right, bottom-left, and/or bottom-right) to capture translational movement and/or deformation of the bounding area that can occur during a fall event. For another example, computing the acceleration between the bounding areas can track midpoints of each side of the bounding area to detect asymmetric deformations indicative of a fall event. In other embodiments, computing the acceleration between the bounding areas analyzes movement of a centroid of the bounding area to determine overall displacement direction and/or magnitude.

In some embodiments, computing the acceleration between the bounding areas calculates velocity and/or acceleration from displacement measurements of the bounding area across sequential frames. For example, computing the acceleration between the bounding areas can determine velocity by measuring displacement of bounding area reference points between sequential frames and dividing by a time interval between the sequential frames, then calculating acceleration by measuring change in velocity across sequential frame pairs. In such an example, if a top-left corner of the bounding area moves from an x, y position (150, 150) pixels in frame 1 to another x, y position (150, 100) pixels in frame 2, with a time interval of 33.3 milliseconds (e.g., at 30 frames per second), velocity can be calculated as 0 pixels/ms horizontally and 1.5 pixels/ms vertically (50 pixels: 33.3 ms). Then, if in frame 3, captured 33.3 milliseconds after frame 2, the same corner point is at position (150, 25), the new velocity can be 0 pixels/ms horizontally and 2.25 pixels/ms vertically (75 pixels: 33.3 ms). The acceleration can then be calculated as the change in velocity (2.25−1.5=0.75 pixels/ms vertically) divided by the time interval (33.3 ms), resulting in an acceleration of approximately 0.0225 pixels/ms² vertically. For another example, computing the acceleration between the bounding areas can implement a filtering algorithm (e.g., Kalman filter, moving average filter, and/or low-pass filter) to estimate velocity and/or acceleration values from potentially noisy displacement measurements. For another example, computing the acceleration between the bounding areas can use temporal smoothing over multiple frames to estimate acceleration curves that reduce impact of frame-to-frame detection fluctuations. For another example, computing the acceleration between the bounding areas can compute total acceleration magnitude by calculating a vector sum of individual corner point accelerations.

In some embodiments, computing (1204c) final score combines results from tracking the position switches with the bounding area of the subject and computing the acceleration between the bounding areas to generate a final score. In some embodiments, computing the final score applies a weighted combination of a position score and an acceleration score, previously computed using techniques described above in 1204a and 1204b. For example, computing the final score can calculate a weighted sum (e.g., position score*W₁+acceleration score*W₂, as indicated in FIG. 12). In some embodiments, weights W₁ and weight W₂ are predetermined values, dynamically adjusted values, and/or learned values. In some embodiments, computing the final score normalizes the position score and the acceleration score before combining both scores. For example, computing the final score can scale each score to a range of 0 to 1 before calculating the weighted sum using both scores.

In some embodiments, after computing the final score, the final score is compared against a threshold for outputting a binary fall detection decision (e.g., fall or no fall). For example, the weighted sum of the position score and the acceleration score can be compared against a threshold that, when exceeded, indicates a fall event. For another example, multiple thresholds corresponding to different confidence levels of fall detection (e.g., possible fall, probable fall, and/or definite fall) can be used.

In some embodiments, tier two 1206 implements fall detection using techniques for when a moderate compute level is determined on the device. As illustrated in FIG. 12, tier two 1206 includes tracking (1206a) position switches with the paired key points of the subject, computing (1206b) acceleration between paired key points, and computing (1206c) final score by combining a position score and an acceleration score.

In some embodiments, tracking the position switches with the paired key points of the subject uses a more precise representation of a position of the subject than with the bounding area used in tier one 1204. In some embodiments, tracking the position switches with the paired key points of the subject identifies anatomical landmarks on the subject across frames in the media content. For example, tracking the position switches with the paired key points detect and/or track points on a body of the subject, such as shoulders, hips, knees, and/or ankles.

In some embodiments, tracking the position switches with the paired key points of the subject establishes pairs of key points to detect position changes potentially indicative of a fall event. For example, tracking the position switches with the paired key points can establish key point pairs, such as shoulder-to-knee or hip-to-ankle, to detect orientation changes of the subject.

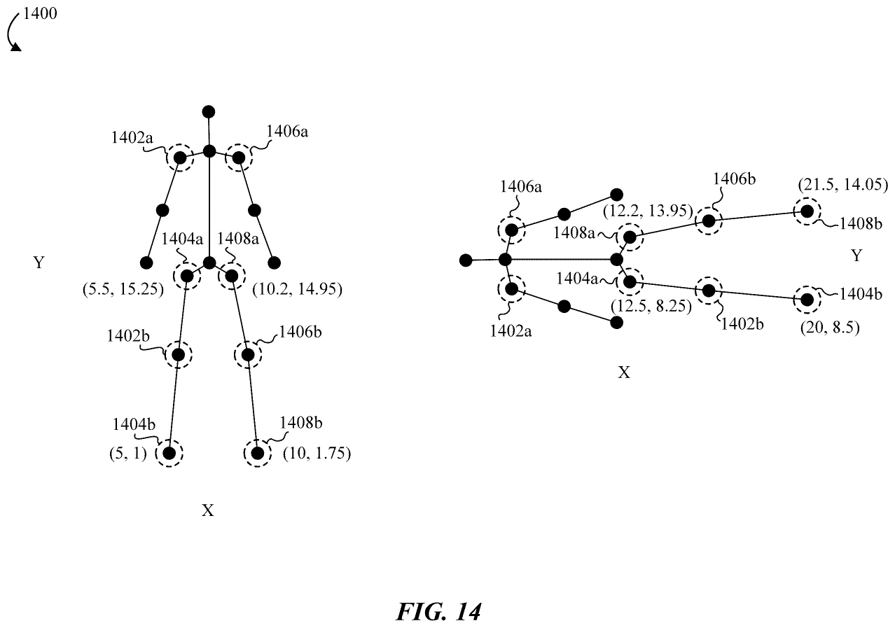

As illustrated in FIG. 14, in some embodiments, tracking the position switches with the paired key points analyzes relationships between the paired key points to identify different position categories. FIG. 14 illustrates exemplary key point configurations and coordinate relationships in accordance with some embodiments. FIG. 14 demonstrates how relative positions of key point pairs differ between a standing and lying position of the subject.

In some embodiments, tracking the position switches with the paired key points of the subject focuses on relative coordinates of key points to identify a position change of the subject. As illustrated in FIG. 14, in a standing position, vertical key points (e.g., 1404a and 1404b, and/or 1408a and 1408b) maintain similar x coordinates while having significantly different y coordinates. For example, points 1404a and 1404b, representing a left hip key point and a left ankle key point, have similar x coordinates (e.g., 5.5 units versus 5 units) but substantially different y coordinates (e.g., 15.25 units versus 1 unit) indicating a vertical (e.g., x coordinate) alignment characteristic of a standing position. For another example, key points 1408a and 1408b representing a right hip key point and a right ankle key point (e.g., another hip-ankle pair of the subject), also have similar x coordinates (e.g., approximately 10.2 units versus 10 units) with substantially different y coordinates (e.g., approximately 14.95 units versus 1.75 units).

In some embodiments, as illustrated on the right side of FIG. 14, when the subject transitions to a lying position, the same key point pair, such as left hip and left ankle key point pair described above, has a reversed coordinate relationship. For example, in the lying position, paired key points 1404a and 1404b now have similar y coordinates (e.g., both key points having y coordinates near the same horizontal level, such as, as illustrated, 8.25 units versus 8.5 units) but substantially different x coordinates (e.g., 12.5 units versus 20 units) indicating a horizontal (e.g., y coordinate) alignment characteristic of a lying position. For another example, key point pairs 1402a-1402b, 1404a-1404b, 1406a-1406b, and 1408a-1408b have coordinate patterns consistent with a change from vertical alignment to horizontal alignment, where a difference in x coordinates becomes substantial while a difference in y coordinates diminishes.

In some embodiments, tracking the position switches with the paired key points of the subject establishes criteria for detecting a change of a position of the subject based on observed coordinate patterns. For example, tracking the position switches with the paired key points can identify a standing position when vertical key point pairs maintain x-coordinate differences within a predetermined threshold (e.g., |x₁−x₂|<threshold₁) while y-coordinate differences exceed another threshold (e.g., |y₁−y₂|>threshold₂). For another example, tracking the position switches with the paired key points can identify a lying position when the same key point pairs show y-coordinate differences within a small threshold (e.g., |y₁−y₂|<threshold₃) while x-coordinate differences become substantial (e.g., |x₁−x₂|>threshold₄). For another example, tracking the position switches with the paired key points can identify transitional positions by tracking a rate of change in these coordinate relationships across frames. In some embodiments, tracking the position switches with the paired key points of the subject implements a scoring mechanism to compute position changes. For example, tracking the position switches with the paired key points can compute a key point score based on how closely current key point coordinate relationships match expected patterns for different positions. For another example, tracking the position switches with the paired key points can generate confidence values for each position category, such as standing, sitting, and/or lying, based on multiple key point pair relationships. For another example, tracking the position switches with the paired key points can implement a weighted scoring system that prioritizes certain key point pairs that are more reliably detected and/or more informative for fall detection.

In some embodiments, tracking the position switches with the paired key points of the subject reduces computational requirements compared to full body position estimation. For example, tracking the position switches with the paired key points can focus on a minimized set of key points (e.g., 8-17 points) rather than tracking a larger number of body key points (e.g., 17-33 points in full position and/or higher compute-based position estimation models). In some embodiments, tracking the position switches with the paired key points of the subject adapts to different camera angles and/or subject orientations. For example, tracking the position switches with the paired key points can normalize detected key point coordinates relative to body dimensions of the subject to account for variations in subject size and/or distance from a camera. For another example, tracking the position switches with the paired key points can use adaptive thresholds for coordinate differences that adjust based on a detected camera angle.

In some embodiments, computing (1206b) the acceleration between the paired key points analyzes movement of the subject across sequential frames to identify a rate of change of the subject position. In some embodiments, computing the acceleration between the paired key points includes tracking positional changes of reference points of the subject between sequential frames in the media content.

In some embodiments, computing the acceleration between the paired key points analyzes movement of the subject across sequential frames to identify a rate of change of the subject position. For example, computing the acceleration between the paired key points can track displacement of shoulder, hip, knee, and/or ankle key points across sequential frames to calculate their respective velocities and accelerations. In some embodiments, computing the acceleration between the paired key points calculates velocity and/or acceleration values from key point displacement measurements. For example, computing the acceleration between the paired key points can determine a velocity vector of each key point by measuring displacement between consecutive frames and dividing by a time interval between the consecutive frames. In such an example, if a hip key point moves from coordinates (120, 245) in a first frame to coordinates (125, 200) in a second frame, with a time interval of 33.3 milliseconds between both frames, velocity can be calculated as 0.15 pixels/ms horizontally (e.g., 5 pixels÷33.3 ms) and 1.35 pixels/ms vertically (e.g., 45 pixels: 33.3 ms). Then, if in a third frame, captured 33.3 milliseconds after the second frame, the same hip key point is at coordinates (130, 140), new velocity can be 0.15 pixels/ms horizontally (e.g., 5 pixels: 33.3 ms) and 1.8 pixels/ms vertically (e.g., 60 pixels÷33.3 ms). The acceleration can then be calculated as change in velocity divided by the time interval, resulting in ˜0 pixels/ms² horizontally and 0.0135 pixels/ms2 vertically, with increasing vertical acceleration potentially indicating fall-like motion. In some embodiments, computing the acceleration between the paired key points implements filtering techniques to improve acceleration estimates. For example, computing the acceleration between the paired key points can use a Kalman filter to integrate position and/or velocity measurements while smoothing out noisy key point detections. In such an example, when a shoulder key point is identified at slightly different positions across consecutive frames (e.g., the left shoulder key point detected at position (100, 150) in frame 1, (103, 148) in frame 2, and/or (99, 152) in frame 3), the Kalman filter can predict where the shoulder key point should be located based on observed movement patterns. For example, if the left shoulder key point is moving in a consistent downward direction at approximately 2 pixels per frame, but frame-to-frame detection shows irregular positions as described above, the Kalman filter can estimate that the left shoulder key point should be at position (101, 148) in frame 2 rather than raw detected position of (103, 148) in frame 2, which can provide more consistent velocity and/or acceleration results. In such an example, the Kalman filter maintains a prediction model of expected position and velocity of each key point, then combines this prediction with detected positions of each key point to produce a filtered estimate that accounts for both movement patterns and detection confidence. For another example, computing the acceleration between paired key points can use a moving average filter over multiple frames to reduce impact of detection jitter on velocity and/or acceleration calculations. For another example, computing the acceleration between the paired key points can implement adaptive filtering that adjusts filter parameters based on detection confidence and/or motion characteristics.

In some embodiments, computing the acceleration between the paired key points provides more precise acceleration measurement compared to bounding area acceleration in tier one 1204. For example, computing the acceleration between the paired key points can track accelerations of specific body parts independently rather than relying on overall bounding area movement. In such an example, computing the acceleration between the paired key points can analyze the acceleration of hip or shoulder key points separately from limb key points to focus on core body movement informative of a fall event while reducing false signals, such as during regular arm movement.

In some embodiments, computing the acceleration between the paired key points generates an acceleration score based on computed acceleration values. For example, computing the acceleration between paired key points can normalize velocity vectors of key point accelerations to a range of 0 to 1, where higher values indicate stronger acceleration consistent with a fall event. For another example, computing the acceleration between the paired key points can apply different weights to accelerations of different key points, giving greater importance to central body key points (e.g., hip key point and/or shoulder key point) than to extremity key points (e.g., ankle key point and/or wrist key point). For another example, computing the acceleration between the paired key points can compare measured acceleration values against thresholds based on typical accelerations observed in fall events.

In some embodiments, computing (1206c) final score combines information from tracking the position switches with the paired key points of the subject and computing the acceleration between the paired key points to generate a fall detection result. In some embodiments, computing the final score applies a weighted combination of a key point score from tracking (1206a) and an acceleration score from computing (1206b). For example, computing the final score can calculate a weighted sum (e.g., key point score*W₃+acceleration score*W₄, as indicated in FIG. 12) where weights W₃ and W₄ are predetermined constants, dynamically adjusted values, or learned parameters that balance contribution of position change and acceleration. For another example, computing the final score can implement a multiplicative combination where the final score equals a product of the key point score and the acceleration score, requiring both components to indicate a fall for the final score to exceed a fall detection threshold. For another example, computing the final score can use a combination function that accounts for temporal relationships between position changes and acceleration typical of fall events. In some embodiments, computing the final score normalizes the key point score and acceleration score before combination to ensure a balanced contribution. For example, computing the final score can scale each score to a range of 0 to 1 before applying the weighted combination.

In some embodiments, computing the final score compares the combined value against a threshold to make a binary fall detection decision. For example, computing the final score can compare the weighted combination of the key point score and the acceleration score against a threshold that, when exceeded, detects a fall event. For another example, computing the final score can implement multiple thresholds corresponding to different confidence levels (e.g., possible fall, probable fall, and/or definite fall) based on detection confidence. For another example, computing the final score can use a dynamically adjusted threshold that adapts to observed movement patterns of the subject, environmental conditions, and/or time-of-day variations to minimize false fall detection.

In some embodiments, tier three 1208 implements fall detection using techniques adapted for when a higher compute level is available on the device. As illustrated in FIG. 12, tier three 1208 includes computing tier two 1206 or tier one 1204, computing (1208b) object detection score, and computing (1208c) final score by combining tier two or tier one fall detection with an object detection score.

In some embodiments, computing tier two or tier one fall detection implements either the tier one process or the tier two process based on available compute on the device. For example, computing tier two or tier one fall detection, when using tier two fall detection, and as described above with respect to 1206, can track the paired key points of the subject to identify position changes between frames in the media content. In such an example, computing tier two fall detection can generate a preliminary fall detection score based on a combined weighted key point score and acceleration score. In some embodiments, computing the object detection score increases fall detection confidence by analyzing a surrounding environment of the subject in the media content, such as objects around and/or near the subject at different times during a fall event. In some embodiments, computing the object detection score uses an object detection model to identify objects in the environment surrounding the subject. For example, computing the object detection score can identify furniture items, such as a bed, couch, chair, table, and/or other objects within the media content. For another example, computing the object detection score can detect a floor surface, carpet, stairs, room type, and/or zone. For another example, computing the object detection score can classify detected objects into categories relevant for fall detection, such as impact surfaces (e.g., hard floor and/or furniture), non-impact surfaces (e.g., bed and/or couch), and/or fall hazards (e.g., stairs and/or obstacle).

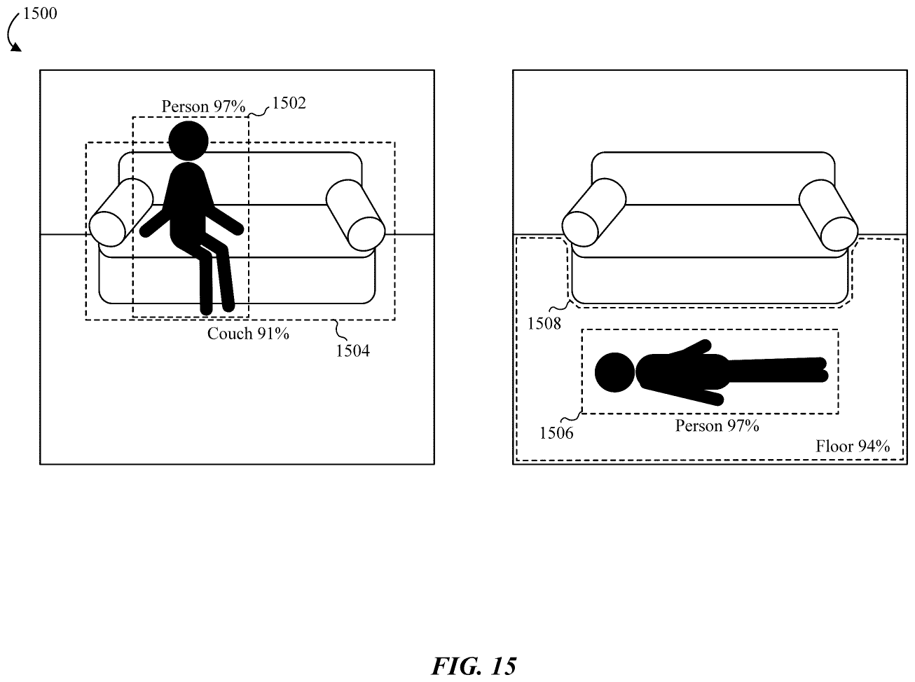

In some embodiments, computing the object detection score analyzes spatial relationships between the subject and detected objects to increase fall detection accuracy. FIG. 15 illustrates exemplary object detection results in accordance with some embodiments. FIG. 15 includes object detection results showing a position of the subject relative to objects across different frames of a potential fall event.

In some embodiments, computing the object detection score evaluates objects around the subject in an initial position and/or a final position of the subject during a potential fall event. For example, as illustrated on the left side of FIG. 15, subject 1502 is detected with confidence 97% while sitting on a couch 1504 with confidence 91% in a first frame of the media content.

For another example, as illustrated on the right side of FIG. 15, the subject is detected with confidence 97% while lying on floor 1508 with confidence 94% in a second frame that is after the first frame in the media content. In such an example, tier one and/or tier two fall detection can result in detecting a fall event with a certain confidence based on a change and/or acceleration of change of a position of the subject, that goes from a “sitting” position at the first time to a “lying” position at the second time. In some embodiments, such transition from sitting on couch 1504 to lying on floor 1508 can be recognized as a potential fall event with higher confidence than when using only position estimation (e.g., via tier one or tier two) without object detection, since in this example, the subject is detected to have fallen on a hard surface that is floor 1508.

In some embodiments, computing the object detection score can increase or decrease fall detection confidence based on objects detected in proximity to the subject. For example, computing the object detection score can assign a higher fall probability when the subject transitions from a “standing” position to a “lying” position on a hard floor surface compared to a transition to lying on a bed or couch. For another example, computing the object detection score can reduce fall detection confidence when a fast position change occurs entirely on a soft surface (e.g., falling on a bed or a couch). In such an example, computing the object detection score can assign different weights to different types of objects, such as, for example, hard floor surfaces receiving higher weights in fall detection compared to soft surfaces. For another example, computing the object detection score can factor in height of furniture items, such as transitions from an elevated surface to a lower surface potentially indicating a fall event.

In some embodiments, computing the final score combines scores from computing tier two or tier one fall detection and computing the object detection score to generate a final fall detection score. In some embodiments, computing (1208c) the final score applies a weighted combination of the tier two or tier one detection result with the object detection score. For example, computing the final score can calculate a weighted sum (e.g., object detection score*W₅+acceleration score*W₆, as indicated in FIG. 12) where weights W₅ and W₆ (e.g., W₂ from tier one, W₄ from tier two, or a different weight) are predetermined constants, dynamically adjusted values, and/or learned parameters that balance a contribution of position-based detection and object detection. For another example, computing the final score can use a combination function that prioritizes object detection input in specific scenarios, such as when the subject is detected near furniture items with higher fall risk (e.g., floor and/or stairs). In some embodiments, computing the final score adaptively adjusts a weight of object detection based on object detection confidence and/or environmental characteristics. For example, computing the final score can increase weight W₅ of object detection when objects are detected with high confidence (e.g., above 90% as illustrated in FIG. 15). For another example, computing the final score can decrease the weight of object detection in cluttered environments where object boundaries are less clearly defined. For another example, computing the final score can implement different combination strategies for different room types and/or areas within a home, such as giving greater weight to object detection in areas with known fall hazards (e.g., garage and/or kitchen).

In some embodiments, computing the final score incorporates an environmental context of a fall event to reduce false positives and/or improve fall detection accuracy. For example, computing the final score can distinguish between an intentional change in position (e.g., lying down on a bed or a couch) and a fall (e.g., falling onto a carpet and/or ground) by classifying an object detected near the subject at the start and/or end of a potential fall event. For another example, computing the final score can maintain higher detection sensitivity for high-risk scenarios (e.g., elderly subject in a kitchen area) by adjusting threshold values based on subject characteristics and/or additional environmental context parameters.

In some embodiments, adding (1210) audio model signal enhances fall detection accuracy by incorporating audio information to complement visual based fall detection performed in tier one 1204, tier two 1206, and/or tier three 1208. In some embodiments, adding the audio model signal processes audio data captured with image data in the media content to detect sounds associated with fall events. For example, adding the audio model signal can identify impact sounds, such as a thud and/or crash, that typically occurs with a fall onto a hard surface. For another example, adding the audio model signal can detect vocalizations of distress, such as an expression of pain and/or cry for help, that can follow a fall event. For another example, adding the audio model signal can analyze ambient audio patterns to identify sudden acoustic changes characterizing a fall event. In some embodiments, adding the audio model signal can be executed on a separate device (e.g., a smart speaker and/or microphone-equipped device) in a home accessory ecosystem, with results transmitted to the device performing visual based fall detection.

In some embodiments, adding the audio model signal uses an audio-based detection model trained to recognize an audio fingerprint of a fall event. In some embodiments, the audio-based detection model is trained using a teacher-student approach. For example, adding the audio model signal can implement a neural network trained on paired audio-video data where fall events identified through visual analysis provide labels (e.g., 0, 1, fall, and/or no fall) for corresponding audio segments. For another example, adding the audio model signal can use feature extraction techniques, such as Mel-frequency Cepstral Coefficients (MFCCs), to convert raw audio into numerical representations for machine learning processing. For another example, adding the audio model signal can implement temporal analysis of audio signals to detect sequence of sounds that occur during and/or after a fall, such as movement sounds followed by impact sounds followed by potential vocalizations.

In some embodiments, adding the audio model signal generates an audio confidence score indicating a likelihood that detected sounds correspond to a fall event. For example, adding the audio model signal can produce a normalized score between 0 and 1, where higher values reflect stronger confidence of a fall event. For another example, adding the audio model signal can calculate confidence scores for different types of fall-related sounds (e.g., impact sound and/or vocalization) and combine the fall-related sounds into an aggregated audio score. In some embodiments, adding the audio model signal operates in conjunction with visual-based tiers described above (e.g., tier one, tier two, or tier three). For example, adding the audio model signal can provide fall detection capabilities in low-light conditions where visual analysis can be compromised but audio remains informative. For another example, adding the audio model signal can detect a fall that occurs outside a field-of-view of the device but within audio detection range.

In some embodiments, computing (1212) the final score combines results from tier-specific detection processes and audio model signal to generate a final fall detection decision. In some embodiments, computing the final score integrates multiple detection signals through a weighted combination approach, as described with respect to 1204, 1206, 1208, and/or 1210. For example, computing the final score can apply different weights to a visual tier process output and audio signal based on detection confidence. For another example, computing the final score can dynamically adjust weights based on environmental conditions, such as increasing audio signal weight in low-light conditions or increasing visual tier weight in a noisy environment. In some embodiments, computing the final score applies different integration approaches depending on which tier process is active for visual processing. For example, when a tier one process is active due to limited compute resources, computing the final score can implement a more balanced weighting between visual and audio signals to compensate for simpler visual analysis. For another example, when a tier three process is active with object detection capabilities, computing the final score can give greater weight to visual analysis and lesser weight for audio signal. For another example, computing the final score can adjust weights of fall detection signals based on historical performance data in different scenarios. In some embodiments, computing the final score implements a multi-threshold approach for fall detection. For example, computing the final score can define different thresholds corresponding to different confidence categories, such as possible fall, probable fall, and/or definite fall. For another example, computing the final score can trigger different response actions based on which threshold is exceeded, such as monitoring for subsequent events after a possible fall or immediately initiating an assistance process after a definite fall. For another example, computing the final score can adapt thresholds based on subject-specific factors, such as using lower thresholds for subjects with known mobility issues and/or medical conditions that increase fall risk.

In some embodiments, computing the final score sends an indication of fall detection to another device. For example, computing the final score can provide contextual information about the fall event to a trusted contact and/or device within the home environment, including a portion of the media content of the fall event itself, location of the fall event within the environment, nearby objects involved, and/or characteristics of the fall event. For another example, computing the final score can interface with emergency contact services, medical alert systems, and/or home automation systems to initiate appropriate response processes based on the fall detection result.

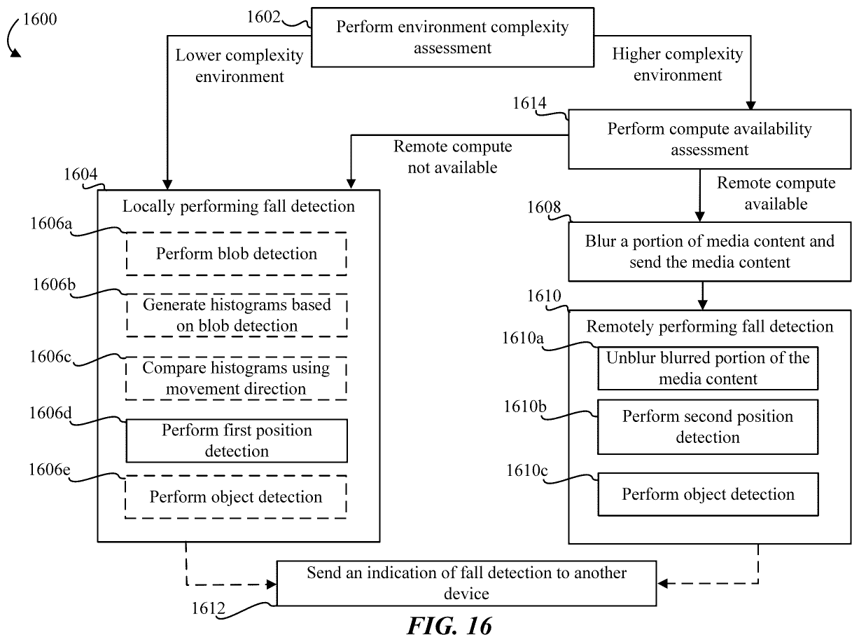

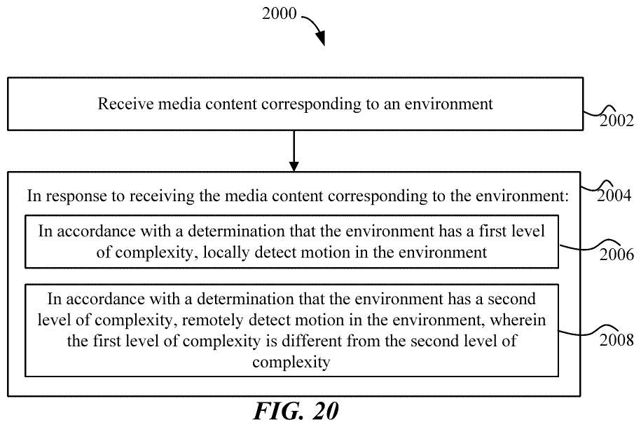

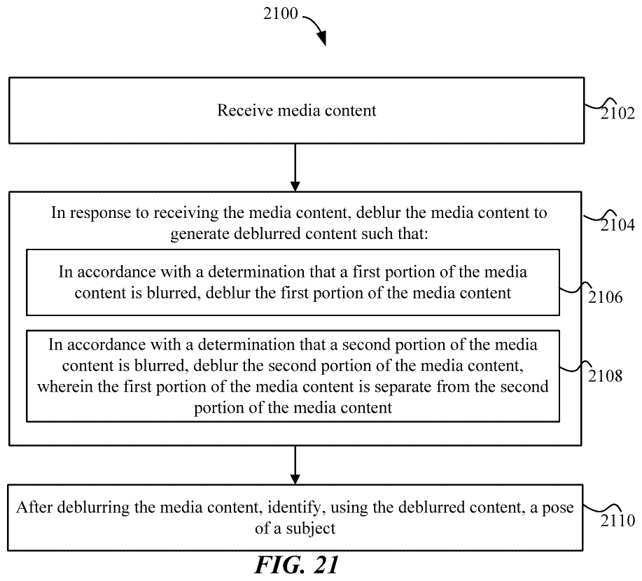

FIG. 16 illustrates an exemplary process for performing fall detection based on environment complexity in accordance with some embodiments. The process in this figure is used to illustrate the processes described below, including the processes in FIGS. 20-21. While techniques described herein are illustrated using fall detection, the same techniques can be applied to motion detection, pose detection, event detection, object detection, gesture recognition, activity recognition, and/or behavioral pattern recognition.

As illustrated in FIG. 16, process 1600 performs (1602) environment complexity assessment to determine whether an environment in media content has a lower complexity or higher complexity to determine whether to perform fall detection locally on a device or remotely (e.g., on another device different from the device). For example, performing the environment complexity assessment can analyze a number of subjects detected in a field-of-view of the device, such as counting distinct subjects (e.g., person and/or pet) and/or objects in the environment. In such an example, performing the environment complexity assessment can also evaluate distances between subjects, such as detecting overlapping or non-overlapping subjects. For another example, performing the environment complexity assessment can detect whether portions of the media content include blur, such as privacy-preserving blur applied to a facial area and/or identifying features of the subject. In such an example, intensity and/or size of blur can contribute to the assessment of the environment complexity, where a smaller and/or less intense blurred area can indicate a lower complexity environment in the media content, and a larger and/or more intense blurred area can indicate a higher complexity environment in the media content. For another example, performing the environment complexity assessment uses thresholds to categorize complexity levels, such as determining a lower complexity environment when, for example, fewer than five subjects are detected, when all or most subjects maintain positive distances from each other, and/or when blurred portions comprise, for example, less than 30% of the media content. For another example, performing the environment complexity assessment determines a higher complexity environment when more than five subjects are detected, when negative distances exist between all or most subjects, and/or when blurred portions exceed, for example, 30% of the media content. For another example, performing the environment complexity assessment can analyze audio characteristics of the media content, such as evaluating audio volume, intensity, and/or complexity of audio signals within the environment. In such an example, performing the environment complexity assessment can determine a lower complexity environment when audio levels are below a threshold, when fewer distinct audio sources are detected, and/or when audio signals have minimal overlap. For another example, performing the environment complexity assessment can determine a higher complexity environment when audio levels exceed the threshold, when multiple distinct audio sources are present (e.g., multiple people talking simultaneously and/or background music playing), and/or when audio signals have significant overlap. In some embodiments, performing the environment complexity assessment assesses a global audio complexity level from multiple devices, such as microphone, smart speaker, and/or audio sensors.

In some embodiments, performing the environment complexity assessment is performed by the device. In other embodiments, the environment complexity assessment is performed by a server in communication with the device. In some embodiments, the environment complexity assessment is performed when motion detection is requested. In other embodiments, the environment complexity assessment is continuously performed, such as without regard to when motion detection is requested. In some embodiments, performing the environment complexity assessment aggregates a global complexity level from multiple devices in a home accessory ecosystem. For example, the environment complexity assessment can assess environmental conditions across one or more cameras, accessory devices, sensors, speakers, and/or hub devices within the environment.

As illustrated in FIG. 16, when determining that the environment is a lower complexity environment, the device locally performs (1604) fall detection (e.g., using motion detection operations locally on the device). In some embodiments, in response to determining that the environment is a lower complexity environment, the device performs (1614) compute availability assessment to determine compute available on the device for selecting between locally performing (1604) fall detection and remotely (1610) performing fall detection.

In some embodiments, locally performing the fall detection implements different motion detection techniques based on a number of subjects detected in performing the environment complexity assessment and/or device capabilities (e.g., available computational resources, such as available CPU, memory, and/or current workload). In some embodiments, locally performing the fall detection includes performing (1606d) first position detection and/or performing (1606e) object detection. For example, locally performing the fall detection can include performing the first position detection, such as described above with respect to tier one 1204 or tier two 1206. For another example, locally performing the fall detection can include performing the object detection when higher compute is available on the device to identify objects surrounding the subject in a fall event, as described above with respect to tier three 1208.

In some embodiments, if more than one subject is detected in the environment, locally performing the fall detection includes performing (1606a) blob detection, generating (1606b) histograms based on blob detection, and/or comparing (1606c) histograms using movement direction, to establish subject correspondence across frames for each subject in the environment. For example, locally performing the fall detection can include performing the blob detection to identify connected components representing the subject. For another example, locally performing the fall detection can include generating the histograms representing color distributions of detected blobs representing the subject. For another example, locally performing the fall detection can include comparing the histograms across frames using directional information from a Kalman filter tracking subject movement (e.g., selecting which histograms to compare based on which direction that the movement is determined to be based on the Kalman filter).

In other embodiments, when a single subject is detected in the environment, the device does not perform (1606a) blob detection, does not generate (1606b) histograms based on blob detection, and/or does not compare (1606c) histograms using movement direction, such as because the single subject is exclusively present across frames (e.g., that can include one or more objects in the environment) and detected motion, such as a fall, automatically corresponds to the single subject and/or is easily distinguished with lighter-weight objection techniques than described with respect to blob detection and histogram generation and comparison.

In some embodiments, performing the blob detection identifies a blob and/or coherent region representing the subject in the media content. In some embodiments, performing the blob detection implements connected component analysis to group adjacent pixels with similar characteristics in the media content. For example, performing the blob detection can apply a merge distance parameter that determines how close pixels must be to receive a same blob identifier. In such an example, connected component analysis can initially assign a unique identifier to each pixel in a foreground mask, then iteratively merge an adjacent pixel into the same blob when the adjacent pixel is within the merge distance. In some embodiments, performing the blob detection can use a background subtraction result as input and then convert a binary foreground-background separation into labeled connected regions. In such an example, background subtraction can maintain a model of an average background over multiple frames, then identify pixels in a current frame that deviate significantly from the model, which produces a binary mask where foreground pixels are separated from background pixels before applying connected component analysis to group these foreground pixels into distinct blobs representing the subject and/or other subjects. In some embodiments, performing the blob detection uses a Gaussian Mixture Model (GMM) to distinguish a foreground from background in a frame for blob detection. For example, performing the blob detection can calculate mean and variance values of each pixel in the frame to measure how far a current pixel intensity deviates from an established mean. In such an example, if the current pixel intensity falls within N standard deviations of a particular distribution, the current pixel can be classified as belonging to that distribution, such as one distribution can represent the subject and another distribution can represent the background. In some embodiments, performing the blob detection can implement framewise subtraction between consecutive frames for identifying a contour of the subject and/or other subjects. In such an example, framewise subtraction can determine whether a movement corresponds to a same subject by identifying overlapping regions across consecutive frames that allows for tracking a specific and/or same subject over time. In some embodiments, performing the blob detection is used as a preprocessing step for histogram generation by isolating distinct moving entities before performing a color distribution analysis. In some embodiments, performing the blob detection allows for more precise motion tracking of the subject by focusing subsequent histogram analysis on specific regions of interest rather than on an entire environment.

In some embodiments, generating the histograms based on blob detection creates color profiles of detected blobs representing the subject and/or other subjects in the media content. In some embodiments, generating the histograms based on blob detection analyzes color information of identified blobs to create a histogram-based signature for each subject. For example, generating the histograms based on blob detection can count a number of pixels falling into different color bins within a bounding box surrounding a blob. In such an example, generating the histograms based on blob detection can create a distribution showing that a particular subject has 45% brown pixels, 30% black pixels, 15% grey pixels, and 10% other colored pixels, that serves as a unique identifier for that subject. For another example, generating the histograms based on blob detection can use configurable bin counts for color classification, such as using 256 bins to match 256 shades in RGB color space for more precise subject identification. In such an example, a higher number of bins increases distinctiveness of the color profile of the subject, such as distinguishing between multiple people wearing similar colored clothing where a shirt of the subject can register as RGB value (80, 80, 80) while a shirt of another subject registers closely at RGB value (90, 90, 90). In some embodiments, generating the histograms based on blob detection normalizes pixel count values in each color bin to a range between 0 and 1 to account for differences in blob sizes. For example, generating the histograms based on blob detection can normalize histogram values when the subject moves away from the camera and occupies a smaller portion of the frame. In such an example, normalization provides proportional values rather than absolute pixel counts, such as, for example, ensuring that the subject wearing a red shirt that occupies 50% of a bounding area in one frame can be correctly matched to the same subject in a subsequent frame where the red shirt only occupies 25% of the bounding are due to increased distance from the camera. In some embodiments, generating the histograms based on blob detection provides improved confidence in subject tracking by verifying whether detected motion corresponds to a same subject rather than merely detecting that motion, such as a fall, has occurred.

In some embodiments, comparing the histograms using movement direction determines whether blobs detected in consecutive frames correspond to the same subject. In some embodiments, comparing the histograms using movement direction uses predictive motion tracking techniques, such as Kalman filtering, to intelligently select which histogram comparisons to perform in consecutive frames of the media content.

In some embodiments, comparing the histograms using movement direction implements a Kalman filter to predict future positions of one or more subjects based on a velocity vector and/or direction of movement of each subject. For example, comparing the histograms using movement direction can track velocity and/or direction of the subject to estimate next positions where the subject is likely to appear. In such an example, if the subject is moving at 5 pixels per frame in a rightwards direction, the Kalman filter can predict that in a subsequent frame, the subject will likely appear 5 pixels further to the right. For another example, when two subjects are walking and their paths cross or the two subjects switch positions relative to the camera, the Kalman filter can maintain tracking continuity by predicting a trajectory of each of the two subjects despite spatial overlap of the two subjects. In such an example, if one subject is moving from left to right and another is moving from right to left, the Kalman filter can track respective velocities and/or directions separately, predicting that after crossing, the one subject will continue rightwards while the other will continue leftwards.

In some embodiments, comparing the histograms using movement direction uses Kalman filter predictions to limit histogram comparisons to regions where the subject is expected to be in a subsequent frame rather than comparing against all detected blobs in a frame. For example, if ten subject blobs are detected in a frame, comparing the histograms using movement direction can focus comparisons only on blob regions that align with predicted movement paths of the ten subject blobs. In such an example, this targeted comparison approach reduces computational complexity from factorial scale, where each subject would need to be compared against all possible blobs, to linear scale, where each subject is only compared against a small subset of likely candidate blobs of the same subject.

In some embodiments, after predictive motion tracking techniques identify candidate blob regions for comparison, such as using the Kalman filter described above, comparing the histograms using movement direction calculates a similarity score between histograms of different blobs. For example, comparing the histograms using movement direction can implement Bhattacharyya's coefficient to calculate overlap between color profiles of blobs in consecutive frames, such as generating a score between 0 and 1, where higher values indicate greater likelihood of histograms representing the same subject. In such an example, a score above 0.7 can indicate that two blobs represent the same subject, while scores below 0.7 can indicate that two blobs represent different subjects. In some embodiments, comparing the histograms using movement direction can maintain distinct motion tracking identities for multiple subjects even when subjects wear similar clothing by combining color histograms with movement predictions. In such an example, even when two subjects have near-identical color histograms, different movement patterns of the multiple subjects can allow for distinguishing between motion, such as a fall, of the multiple subjects.

In some embodiments, performing the first position detection identifies body position switches of the subject. For example, when monitoring the subject in a home environment, process 1600 first identifies blobs potentially representing the subject across consecutive frames, verifies that identified blobs represent the same subject across the consecutive frames using histogram comparisons and/or movement direction, and then analyzes whether movement of the subject constitutes a specific fall event based on position detection of the subject.

In some embodiments, performing the first position detection implements techniques adapted to available compute resources on the device. For example, performing the first position detection can implement tier one position detection techniques, as described with respect to FIGS. 12-13, when limited compute is available, such as tracking position changes with a bounding area of the subject between frames and computing acceleration between the frames. For another example, performing the first position detection can implement tier two position detection techniques, as described with respect to FIGS. 12 and 14, when moderate compute is available, such as tracking position changes with the paired key points of the subject between frames and computing acceleration between the frames.

In some embodiments, performing the object detection increases or decreases confidence of a fall detection event, such as a fall event, based on detected objects in proximity to the subject. In some embodiments, performing the object detection is executed when higher compute is available on the device. In some embodiments, performing the object detection implements tier three object detection techniques described with respect to FIGS. 12 and 15. For example, performing the object detection can increase confidence in fall detection when the subject transitions from a standing position to a lying position on a floor surface, or decrease confidence when a similar transition occurs onto a soft surface, such as a bed or a couch.

In some embodiments, when the device determines that the environment is a higher complexity environment, the device performs (1614) compute availability assessment to select between locally performing (1604) fall detection and remotely (1610) performing fall detection. In some embodiments, performing the compute availability assessment uses techniques described above with respect to performing (1202) device assessment, as described with respect to FIG. 12, to detect a compute level available on the device. In some embodiments, performing the compute availability assessment determines whether remote compute is available for performing fall detection, such as availability and/or established communication with a remote server, cloud environment, and/or resident device within the environment, that includes higher compute sufficient for remotely performing the fall detection. In some embodiments, the compute availability assessment is performed by the device. In other embodiments, the compute availability assessment is performed by a server in communication with the device.

In some embodiments, when performing the compute availability assessment determines that remote compute is not available and/or that the device has a sufficient compute level for locally performing the fall detection within the higher complexity environment, process 1600 proceeds with locally performing the fall detection, using techniques described above (e.g., 1606a, 1606b, 1606c, 1606d, and/or 1606e) with respect to FIG. 16.

In other embodiments, when performing the compute availability assessment determines that remote compute is available and/or that the device has an insufficient compute level for locally performing the fall detection within the higher complexity environment, process 1600 proceeds with remotely performing the fall detection. In some embodiments, before remotely performing the fall detection, process 1600 proceeds to blur (1608) a portion of the media content and send the media content (e.g., with the portion of the media content that has been blurred) for remotely performing fall detection.

In some embodiments, blurring the portion of the media content protects privacy of one or more subjects in the media content before providing the media content to another device, such as a trusted cloud server, for fall detection processing. In some embodiments, blurring the portion of the media content applies blurring to identifying features of the subject and/or other subjects, such as facial and/or torso area before sending the media content to another device. For example, blurring the portion of the media content can apply Gaussian blurring to facial regions of the subject in the media content. In such an example, Gaussian blurring can apply a convolution kernel, such as a 3×3 to 7×7 pixel matrix, over a facial area to obscure identifying features of the subject. For another example, blurring the portion of the media content can implement pixelation techniques that reduce resolution of facial regions by averaging pixel values within pixel cells of a defined grid.

In some embodiments, blurring the portion of media content applies blur to privacy-protected regions while leaving non-privacy protected regions unblurred. For example, blurring the portion of media content can identify and blur multiple facial regions when multiple subjects are present in the media content. For another example, blurring the portion of media content can apply blur only to identifying features, such as face, upper torso, and/or tattoo area, while leaving other body areas unblurred for streamlined subsequent position detection.

In some embodiments, blurring the portion of the media content is performed on the device that captures the media content. In such an example, even if network transmission is intercepted, identifying features of the subject can remain protected. In other embodiments, blurring the portion of the media content is performed on another device securely connected to the device. For example, encrypted raw media content can be sent to a trusted intermediary device within a home accessory ecosystem that can apply blurring before sending the media content to a cloud server. In some embodiments, the portion of the media content is blurred progressively more as the media content moves further from its originating device. For example, a camera can apply a moderate blur to the portion of the media content when the media content is sent to a resident device, and the resident device can apply more blur when the media content is sent to a cloud server for fall detection processing.

In some embodiments, after blurring the portion of the media content, the blurred media content is sent to another device, a remote server, and/or cloud environment for fall detection processing. For example, the blurred media content can be securely transmitted to a trusted server with higher available compute and/or device capabilities capable of processing fall detection in a higher complexity environment. In some embodiments, the media content metadata is also sent to the other device, such as information about blur regions, subject bounding areas, and/or preliminary fall detection results.

In some embodiments, the fall detection is remotely performed (1610) on a remote server, cloud environment, and/or another device with higher compute available, such as a resident device in a home accessory environment. In such embodiments, a higher compute level is remotely available, such as a compute level higher than the compute level detected for performing tier three 1208, as described with respect to FIG. 12.

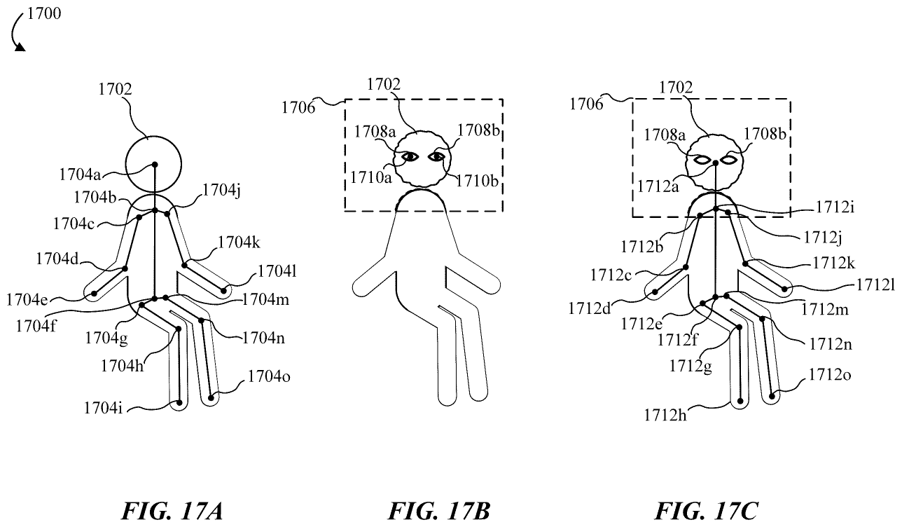

In some embodiments, the blurred portion of the media content is unblurred (1610a) for performing (1610b) second position detection. FIG. 17A illustrates position detection with key points 1704a-1704o on subject 1702 in a baseline scenario where position detection is performed directly on the subject, where the media content does not include a blurred portion, using techniques described earlier with respect to tracking position changes using the paired key points of the subject in FIGS. 12 and 14. For example, FIG. 17A illustrates key point identification throughout a body of subject 1702, beginning with head key point 1704a, continuing through shoulder key points 1704c and 1704j, chest key point 1704b, elbow key points 1704d and 1704k, wrist key points 1704e and 1704l, hip key points 1704g, 1704f, and 1704m, knee key points 1704h and 1704n, and ending with ankle key points 1704i and 1704o.

In some embodiments, subject 1702 has a facial region blurred, such as with a lower blur intensity. In such embodiments, the facial region can be unblurred (1610a) using a stable diffusion model to recover sufficient structural information to establish head key point 1704a, that provides a landmark for detecting subsequent body key points 1704b-1704o. For example, the stable diffusion model can denoise the facial region enough to identify a general shape and/or position of a head of the subject without requiring facial details, that serves as a starting point (e.g., head key point 1704a) for position detection.

In some embodiments, such as when a more intensive blur is applied to the facial region of the subject, a blurred region is processed using a multi-step approach as illustrated in FIGS. 17B-17C for performing (1610b) the second position detection. For example, as illustrated in FIG. 17B, subject 1702 has a facial region covered by blur region 1706. In some embodiments, the facial region is unblurred using one or more techniques described above.

In some embodiments, after or without unblurring the facial region, one or more edge detection techniques are applied to the facial region to identify distinct features within the facial region. For example, Canny edge detection can be applied to the facial region to outline boundaries around facial elements, such as identifying two central blobs corresponding to eye regions. In such an example, the Canny edge detection algorithm can trace contours around areas of contrast and highlight structures that correspond to eye locations without recovering actual eye appearance. For example, as illustrated in FIG. 17B, two distinct regions 1708a and 1708b corresponding to eye positions can be identified.

In some embodiments, once two distinct regions 1708a and 1708b corresponding to eye positions are identified, the second position detection is performed by placing reference points at the two distinct regions 1708a and 1708b corresponding to eye positions. For example, as illustrated in FIG. 17B, performing the second position detection can include establishing left eye reference point 1710a and right eye reference point 1710b on regions 1708a and 1708b respectively. In some embodiments, these reference points serve as anchors for detecting subsequent key points of the subject. For example, left eye reference point 1710a and right eye reference point 1710b provide facial landmarks from which body key points can be extrapolated. In such embodiments, performing the second position detection continues with averaging reference points (e.g., left eye reference point 1710a and right eye reference point 1710b) to create a primary reference point for the head of the subject. In some embodiments, as illustrated in FIG. 17C, performing the second position detection calculates an average position along an x-axis between left eye reference point 1710a and right eye reference point 1710b to establish a head key point 1712a, such as on a potential nose location of the subject. In some embodiments, this averaging process provides a central reference point that aligns with the baseline scenario, as illustrated in FIG. 17A, and the second position detection performed using head key point 1704a. In some embodiments, after establishing head key point 1712a, the second position detection extends key point detection throughout the body of the subject, using techniques similar to those described with respect to FIGS. 12, 14, and 17A. In some embodiments, as illustrated in FIG. 17C, the second position detection progresses from identifying head key point 1712a to identifying shoulder key points 1712b and 1712j, chest key point 1712i, elbow key points 1712c and 1712k, wrist key points 1712d and 1712l, hip key points 1712e, 1712f, and 1712m, knee key points 1712g and 1712n, and ankle key points 1712h and 1712o. In some embodiments, the second position detection implements more comprehensive position detection compared to the first position detection. For example, the second position detection can use 33 key points compared to 17 key points used in the first position detection when tier two 1206 is employed for the first position detection, or compared to bounding area detection when tier one 1204 is employed in the first position detection. In other embodiments, performing the second position detection implements the same position detection approach as the first position detection.

In some embodiments, sending (1612) an indication of fall detection to another device provides notification of a detected fall event to other devices. In some embodiments, sending the indication of the fall detection to the other device is performed after either locally performing the fall detection or remotely performing the fall detection. For example, the indication of the fall detection can be sent as a notification to a trusted contact when fall detection identifies a fall event of the subject and/or other subjects. In some embodiments, the indication of the fall detection can be sent to emergency response systems when fall detection determines that a fall event has occurred. In some embodiments, sending the indication of fall detection to another device includes sending metadata of the fall detection. For example, the indication of fall detection can include fall detection confidence score, detected position details, object detection score, one or more device identifiers, time of occurrence and/or a location within an environment where the fall event was detected, and/or portion from the media content showcasing the fall event.

In some embodiments, the indication of fall detection maintains privacy protection, such as blurring a portion of the media content before including the media content in the indication of fall detection.

FIG. 18 is a flow diagram illustrating a process (e.g., process 1800) for detecting a fall of a subject using acceleration in accordance with some embodiments. Some operations in process 1800 are, optionally, combined, the orders of some operations are, optionally, changed, and some operations are, optionally, omitted.

As described below, process 1800 provides an intuitive way for detecting a fall of a subject using acceleration in accordance with some embodiments. Process 1800 reduces the cognitive burden on a user, thereby creating a more efficient human-machine interface. For battery-operated computing devices, enabling a user to interact with such devices faster and more efficiently conserves power and increases the time between battery charges.

In some embodiments, process 1800 is performed at a device (e.g., a computer system, a sensor device, a sender device, and/or an electronic device). In some embodiments, the device is a watch, a phone, a tablet, a fitness tracking device, a processor, a head-mounted display (HMD) device, a communal device, a media device, a speaker, a television, an electronic device, and/or a personal computing device. In some embodiments, one or more operations described below are performed by a process of the device.

The device receives (1802) a first position (e.g., first pose, first orientation, and/or first location) (e.g., an image that includes a representation of a subject as described with respect to 1204a, 1206a, 1208a, 1302, 1304, and/or 1306 and/or positions corresponding to the subject as described as corners of the bounding box of 1302, 1304, and/or 1306 and/or 1402a, 1402b, 1404a, 1404b, 1406a, 1406b, 1408a, and/or 1408b) of a subject at a first time and a second position (e.g., second pose, second orientation, and/or second location) (e.g., an image that includes a representation of a subject as described with respect to 1204a, 1206a, 1208a, 1302, 1304, and/or 1306 and/or positions corresponding to the subject as described as corners of the bounding box of 1302, 1304, and/or 1306 and/or 1402a, 1402b, 1404a, 1404b, 1406a, 1406b, 1408a, and/or 1408b) of the subject at a second time different from the first time. In some embodiments, the second time is after the first time. In some embodiments, the second position is different from the first position. In some embodiments, the first position of the subject at the first time and the second position of the subject at the second time are received from another device separate from the device. In some embodiments, the device detects, via one or more sensors of the device, the first position of the subject at the first time and the second position of the subject at the second time. In some embodiments, the first position of the subject at the first time and the second position of the subject at the second time are received at the same time (e.g., in one message and/or notification). In some embodiments, the first position of the subject at the first time and the second position of the subject at the second time are received at different times (e.g., in a plurality of messages and/or notifications). In some embodiments, the first position of the subject at the first time is identified using an image captured at the first time. In some embodiments, the second position of the subject at the second time is identified using an image captured at the second time. In some embodiments, the first position and/or the second position are received by the process from another process of the device. In some embodiments, the first position is received as an image. In some embodiments, the second position is received as an image.

In response to (1804) receiving the first position and the second position, in accordance with a determination that a first set of one or more criteria is satisfied, wherein the first set of one or more criteria includes a criterion that is satisfied when a value computed using an acceleration (e.g., as described above with respect to 1204b and/or 1206b) of a set of one or more points (e.g., bounding box points or body key points of the subject) (e.g., as described above with respect to FIGS. 13 and/or 14) between the first position and the second position exceeds a threshold, the device outputs (1806) an indication that the subject has fallen (e.g., as described above with respect to FIG. 12). In some embodiments, outputting the indication includes transmitting a message including the indication to another device separate from the device. In some embodiments, outputting the indication includes displaying the indication. In some embodiments, outputting the indication includes outputting audio indicative that the subject has fallen. In some embodiments, the set of one or more points includes one or more corners of a bounding box around the subject. In some embodiments, the set of one or more points includes one or more body points (e.g., left ankle, left hip, right ankle, right hip, left knee, left shoulder, right knee, and/or right shoulder) identified in one or more images. In some embodiments, the threshold is determined using an unsupervised learning model (e.g., Gaussian Mixture Model (GMM), clustering model, distribution learning model, and/or probabilistic model). In some embodiments, the acceleration is determined by calculating a change in velocity between the first position of the subject at the first time and the second position of the subject at the second time. In some embodiments, the threshold is dynamically adjusted based on feedback corresponding to previous fall detections. In some embodiments, the value is computed based on comparing a height-to-width ratio of a shape of the set of one or more points to distributions corresponding to different position categories (e.g., standing, sitting, and/or lying). In some embodiments, the value is computed by combining a first score based on the distributions corresponding to the different position categories with a second score based on the acceleration of the set of one or more points between the first position and the second position. In some embodiments, the value is computed by applying different weights to a combination of the first score and the second score (e.g., 0.4 times the first score plus 0.6 times the second score).

In response to (1804) receiving the first position and the second position, in accordance with a determination that a second set of one or more criteria is satisfied, wherein the second set of one or more criteria includes a criterion that is satisfied when the value computed using the acceleration of the set of one or more points between the first position and the second position is below the threshold, the device forgoes (1808) output of the indication that the subject has fallen (e.g., as described above with respect to FIG. 12).

In some embodiments, the first set of one or more criteria includes a criterion that is satisfied when a particular position (e.g., the first position and/or the second position) of the subject is within a distribution for a pre-defined position (e.g., pose, orientation, and/or location) (e.g., as described above with respect to FIG. 12). In some embodiments, the pre-defined position corresponds to a falling position. In some embodiments, the first set of one or more criteria includes a criterion that is satisfied when the first position is within a distribution for one or more initial positions (e.g., a non-falling position, such as standing, lying, or sitting) and the second position is within the distribution for the pre-defined position.

In some embodiments, in conjunction with (e.g., before, while, or after) outputting the indication that the subject has fallen, the device updates (e.g., continuously or intermittently updates) the distribution based on at least some of the set of one or more points (e.g., as described above with respect to FIG. 12). In some embodiments, updating the distribution causes different positions or less positions to be within the position. In some embodiments, the distribution is updated in response to or after a user indicates whether the subject had fallen (e.g., the indication that the subject has fallen was correct).

In some embodiments, after outputting the indication that the subject has fallen and after the computer system has been physically moved (e.g., to another location in an environment, such as a person relocated the computer system), the device updates (e.g., continuously or intermittently updates) the distribution based on a set of one or more points of a subject detected after the computer system has been physically moved (e.g., as described above with respect to FIG. 12). In some embodiments, the distribution is updated based on the set of one or more points that is detected after the computer system has been physically moved to compensate for the computer system being located in a different position and/or subjects having different positions relative to the computer system at the different position.

In some embodiments, the set of one or more points includes one or more corners of a bounding area (e.g., outline, rectangle, and/or shape) around the subject (e.g., as described with respect to FIG. 13). In some embodiments, the set of one or more points includes a top right corner, a top left corner, a bottom right corner, and/or a bottom left corner. In some embodiments, the bounding area is a bounding box such as a shape that includes four or six corners.

In some embodiments, the first set of one or more criteria includes a criterion that is satisfied when a value of a height-to-width ratio of the bounding area at the first time exceeds a threshold difference from a height-to-width ratio of the bounding area at the second time (e.g., as described with respect to FIG. 13). In some embodiments, the height-to-width ratio of the bounding area at the first time is a ratio of a height and a width of the bounding area at the first time. In some embodiments, the height-to-width ratio of the bounding area at the second time is a ratio of a height and a width of the bounding area at the second time. In some embodiments, the bounding area at the first time includes a height and a width at the first time. In some embodiments, the bounding area at the second time includes a height and a width at the second time.

In some embodiments, the set of one or more points includes a position of a portion (e.g., knee, foot, ankle, leg, torso, shoulder, elbow, wrist, arm, hand, head, and/or neck) of the subject (e.g., as described above with respect to FIG. 14). In some embodiments, the set of one or more points includes a position of a first portion of the subject. In some embodiments, the set of one or more points includes a position of a second portion of the subject. In some embodiments, the position of the first portion is separate and/or different from the position of the second portion. In some embodiments, the first portion of the subject is different from the second portion of the subject.

In some embodiments, the set of one or more points is a first set of one or more points. In some embodiments, in response to receiving the first position and the second position, in accordance with a determination that a third set of one or more criteria is satisfied, wherein the third set of one or more criteria includes a criterion that is satisfied when a first compute level (e.g., higher compute level) (e.g., as described above with respect to 1202) is available, wherein the third set of one or more criteria includes a criterion that is satisfied when a value computed using an acceleration of a second set of one or more points between the first position and the second position exceeds the threshold, the device outputs an indication that the subject has fallen (e.g., as described above with respect to FIG. 12). In some embodiments, the second set of one or more points is the first set of one or more points. In some embodiments, the second set of one or more points is different from and/or separate from the first set of one or more points. In some embodiments, the second set of one or more points includes the first set of one or more points. In some embodiments, the second set of one or more points does not include the first set of one or more points. In some embodiments, in response to receiving the first position and the second position, in accordance with a determination that a fourth set of one or more criteria is satisfied, wherein the fourth set of one or more criteria includes a criterion that is satisfied when a second compute level (e.g., as described above with respect to 1202) is available (e.g., lower compute level), wherein the fourth set of one or more criteria includes a criterion that is satisfied when a value computed using an acceleration of a third set of one or more points (e.g., bounding box points or body key points of the subject) between the first position and the second position exceeds the threshold (e.g., without using the acceleration of the first set of one or more points), the device outputs an indication that the subject has fallen (e.g., as described above with respect to FIG. 12), wherein the second compute level is different from (e.g., higher or lower than) the first compute level, wherein the fourth set of one or more criteria is different from the third set of one or more criteria, and wherein the third set of one or more points is different from the second set of one or more points. In some embodiments, in response to receiving the first position and the second position and in accordance with a determination that a fifth set of one or more criteria is satisfied, the device forgoes output of the indication that the subject has fallen. In some embodiments, the fifth set of one or more criteria includes a criterion that is satisfied when the first compute level is available. In some embodiments, the fifth set of one or more criteria includes a criterion that is satisfied when the second compute level is available. In some embodiments, the fifth set of criteria includes a criterion that is satisfied when a value computed using an acceleration of a fourth set of one or more points between the first position and the second position is below the threshold. In some embodiments, the fourth set of one or more points is the first set of one or more points or the second set of one or more points. In some embodiments, the third set of one or more points has more points or less points than the second set of one or more points. In some embodiments, the second set of one or more points corresponds to points of the bounding area. In some embodiments, the second set of one or more points are boundaries and/or corners of the bounding area. In some embodiments, the second set of one or more points and/or the third set of one or more points correspond to one or more portions of the subject.

In some embodiments, in response to receiving the first position and the second position, in accordance with a determination that a sixth set of one or more criteria is satisfied, wherein the sixth set of one or more criteria includes a criterion that is satisfied when an object associated with (e.g., near, in contact with, and/or overlapping with) the subject at the first time is a first object (e.g., floor, carpet, and/or hard surface) (e.g., as described above with respect to 1208 and/or FIG. 15), wherein the sixth set of one or more criteria includes a criterion that is satisfied when a value computed using the acceleration of the set of one or more points between the first position and the second position exceeds the threshold, the device outputs an indication that the subject has fallen. In some embodiments, the object being the first object increases a confidence associated with outputting the indication that the subject has fallen.

In some embodiments, in response to receiving the first position and the second position, in accordance with a determination that a seventh set of one or more criteria is satisfied, wherein the seventh set of one or more criteria includes a criterion that is satisfied when the object associated with the subject at the first time is a second object (e.g., couch, bed, and/or soft surface) (e.g., as described above with respect to 1208 and/or FIG. 15), wherein the seventh set of one or more criteria includes a criterion that is satisfied when a value computed using the acceleration of the set of one or more points between the first position and the second position exceeds the threshold, the device forgoes output of the indication that the subject has fallen, wherein the second object is separate from the first object, and wherein the sixth set of one or more criteria is different from the seventh set of one or more criteria. In some embodiments, the object being the first object decreases a confidence associated with outputting the indication that the subject has fallen.

In some embodiments, in response to receiving the first position and the second position, in accordance with a determination that an eighth set of one or more criteria is satisfied, wherein the eighth set of one or more criteria includes a criterion that is satisfied when an object associated with (e.g., near, in contact with, and/or overlapping with) the subject at the second time is a third object (e.g., floor, carpet, and/or hard surface) (e.g., as described above with respect to 1208 and/or FIG. 15), wherein the eighth set of one or more criteria includes a criterion that is satisfied when a value computed using the acceleration of the set of one or more points between the first position and the second position exceeds the threshold, the device outputs an indication that the subject has fallen (e.g., as described with respect to FIG. 15). In some embodiments, the object being the third object increases a confidence associated with outputting the indication that the subject has fallen. In some embodiments, the third object is the first object. In some embodiments, the third object is different from the first object and/or the second object.

In some embodiments, in response to receiving the first position and the second position, in accordance with a determination that an ninth set of one or more criteria is satisfied, wherein the ninth set of one or more criteria includes a criterion that is satisfied when the object associated with the subject at the second time is a fourth object (e.g., couch, bed, and/or soft surface) (e.g., as described above with respect to 1208 and/or FIG. 15), wherein the ninth set of one or more criteria includes a criterion that is satisfied when a value computed using the acceleration of the set of one or more points between the first position and the second position exceeds the threshold, the device forgoes output of the indication that the subject has fallen, wherein the fourth object is separate from the third object, and wherein the eighth set of one or more criteria is different from the ninth set of one or more criteria (e.g., as described with respect to FIG. 15). In some embodiments, the object being the fourth object decreases a confidence associated with outputting the indication that the subject has fallen. In some embodiments, the fourth object is the second object. In some embodiments, the fourth object is different from the first object and/or the second object.

In some embodiments, the eighth set of one or more criteria includes a criterion that is satisfied when an object associated with (e.g., near, in contact with, and/or overlapping with) the subject at the first time is a fifth object (e.g., floor, carpet, and/or hard surface), outputting the indication that the subject has fallen (e.g., as described above with respect to 1208 and/or FIG. 15). In some embodiments, the ninth set of one or more criteria includes a criterion that is satisfied when the object associated with (e.g., near, in contact with, and/or overlapping with) the subject at the first time is a sixth object (e.g., couch, bed, and/or soft surface), the device forgoes output of the indication that the subject has fallen. In some embodiments, the fifth object is the third object. In some embodiments, the fifth object is the fourth object.

In some embodiments, in response to receiving the first position and the second position, in accordance with a determination that a tenth set of one or more criteria is satisfied, wherein the tenth set of one or more criteria includes a criterion that is satisfied when a third compute level (e.g., higher compute level) (e.g., as described above with respect to 1202) is available, wherein the tenth set of one or more criteria includes a criterion that is satisfied based on detecting an object (e.g., floor, carpet, and/or hard surface) associated with (e.g., near, in contact with, and/or overlapping with) the subject (e.g., at the first time and/or the second time), the device outputs an indication that the subject has fallen. In some embodiments, the tenth set of one or more criteria includes a criterion that is satisfied when a value computed using the acceleration of the set of one or more points between the first position and the second position exceeds the threshold.

In some embodiments, in response to receiving the first position and the second position, in accordance with a determination that an eleventh set of one or more criteria is satisfied, wherein the eleventh set of one or more criteria includes a criterion that is satisfied when a fourth compute level (e.g., lower compute level) (e.g., as described above with respect to 1202) is available, wherein the eleventh set of one or more criteria does not include a criterion that is satisfied based on detecting an object (e.g., floor, carpet, and/or hard surface) associated with (e.g., near, in contact with, and/or overlapping with) the subject (e.g., at the first time and/or the second time), the device outputs an indication that the subject has fallen, wherein the fourth compute level is different from the third compute level. In some embodiments, the eleventh set of one or more criteria includes a criterion that is satisfied when a value computed using the acceleration of the set of one or more points between the first position and the second position exceeds the threshold. In some embodiments, the device uses an object detection score (e.g., with a weight) that the subject was associated with at the first position and/or the second position when the third compute level (e.g., higher compute level) is available and not when the fourth compute level is available.

In some embodiments, the device includes one or more output devices (e.g., a display generation component, an audio generation component, and/or a haptic generation component). In some embodiments, outputting the indication that the subject has fallen includes outputting, via the one or more output devices, the indication that the subject has fallen. In some embodiments, outputting the indication that the subject has fallen includes triggering a voice assistant to communicate with the subject through a device, such as the device, nearest to the subject. In some embodiments, outputting the indication that the subject has fallen includes notifying the subject with a request to call emergency services and/or assistance.

In some embodiments, the device includes one or more input devices (e.g., a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface). In some embodiments, after outputting the indication that the subject has fallen, the device detects, via the one or more input devices, a response (e.g., verbal response, gesture, touch input, and/or lack of response within a predetermined period of time) to the indication that the subject has fallen. In some embodiments, in response to detecting the response to the indication that the subject has fallen, in accordance with a determination that the response is a first response (e.g., confirmation that assistance is needed, request to call for help, and/or response within a predetermined period of time), the device performs a first operation (e.g., as described above with respect to FIG. 12). In some embodiments, performing the first operation includes calling emergency services, notifying trusted contacts (e.g., in a home and/or environment where the subject is located), and/or sending footage of the fall of the subject to other subjects in the home.

In some embodiments, in response to detecting the response to the indication that the subject has fallen, in accordance with a determination that the response is a second response (e.g., cancellation request, confirmation that the subject is unharmed, and/or correction that no fall occurred) different from the first response, the device performs a second operation (e.g., as described above with respect to FIG. 12) different from the first operation. In some embodiments, the response to the indication that the subject has fallen is used in a feedback-loop for refining fall detection accuracy and/or thresholds for future fall detections.

In some embodiments, after outputting the indication that the subject has fallen and in accordance with a determination that no response to the indication (e.g., image and/or video) that the subject has fallen has been detected within a predetermined period of time of outputting the indication that the subject has fallen (and/or after outputting a plurality of indications that the subject has fallen), the device sends, to another device separate from the device, an indication that the subject has fallen (e.g., as described above with respect to FIG. 12). In some embodiments, sending the indication that the subject has fallen includes transmitting footage of the fall of the subject to trusted contacts when the subject is unresponsive.

In some embodiments, in response to receiving the first position and the second position and in accordance with the determination that the first set of one or more criteria is satisfied, the device outputs, to a second device separate from the device, an indication that the subject has fallen (e.g., sending an indication of fall detection to another device as described with respect to FIG. 12). In some embodiments, outputting, to the second device, the indication includes transmitting, to the second device, video and/or one or more images corresponding to the fall of the subject for viewing by one or more trusted subjects. In some embodiments, outputting, to the second device, the indication includes transmitting, to the second device, a request for whether assistance is needed for the subject, initiating emergency services and/or a call with the subject. In some embodiments, outputting, to the second device, the indication includes transmitting, to the second device, a request for confirming that the subject has fallen.

In some embodiments, the device is in an environment (e.g., home, establishment, and/or location where the subject is located). In some embodiments, the second device is in the environment (e.g., as described with respect to FIG. 12). In some embodiments, the second device is determined to be in the same environment as the device based on being connected to a same network (e.g., local area network and/or home network) as the device. In some embodiments, the second device is determined to be in the same environment as the device based on being within a threshold distance of the device (e.g., using Bluetooth signal, near-field communication, GPS location data, and/or Wi-Fi signal strength). In some embodiments, the second device is registered as a trusted device within the environment. In some embodiments, the environment includes multiple areas (e.g., room, floor, and/or section) and the second device is in a separate area from the device.

In some embodiments, the second device is associated with (e.g., corresponds to, is defined as, identified with, connected to, and/or operated by) an emergency contact of the subject (e.g., as described with respect to FIG. 12). In some embodiments, the emergency contact is pre-configured by the subject (e.g., for receiving fall detection and/or emergency notification). In some embodiments, the emergency contact is automatically selected when no emergency contacts are pre-configured by the subject, such as emergency services and/or a contact most historically active with the subject.

In some embodiments, the second device is associated with (e.g., corresponds to, identified with, connected to, and/or operated by) an emergency service (e.g., 911, first responders, fire department, and/or medical personnel) (e.g., as described with respect to FIGS. 12 and/or 16). In some embodiments, the indication of the fall of the subject is output to the emergency service after a pre-determined period of time with no response and/or after sending one or more indications of the fall of the subject to one or more devices of the subject and/or a device of one or more trusted contacts of the subject. In some embodiments, outputting, to the second device, the indication of the fall of the subject includes transmitting, to the second device, a summary (e.g., voice summary, automatically generated summary, location information, and/or footage of the fall of the subject) of the fall of the subject. In some embodiments, outputting, to the second device, the indication of the fall of the subject includes establishing a communication channel between the emergency service and a device near the subject.

In some embodiments, the first set of one or more criteria includes a criterion that is satisfied when audio associated with (e.g., detected in proximity to and/or corresponding to movement of) the subject is determined to be indicative that the subject has fallen (e.g., 1210 and/or audio signal described with respect to FIG. 12). In some embodiments, the audio includes ambient sounds before a potential fall event and/or impact sounds during or after the potential fall event. In some embodiments, the audio is detected via one or more input devices of the device and/or another device in an environment of the subject. In some embodiments, the audio associated with the subject is determined to be indicative that the subject has fallen using an audio model trained on a dataset of labelled fall sounds. In some embodiments, the audio is processed into one or more numerical feature representations for inputting to the audio model. In some embodiments, the audio associated with the subject is used to generate a value that is combined with a value computed using acceleration (e.g., as described above) to produce a weighted confidence score for fall detection of the subject.

In some embodiments, the audio associated with the subject is determined to be indicative that the subject has fallen based on detecting one or more keywords (e.g., verbal expression of distress, call for help, and/or exclamation of pain) in the audio (e.g., 1210 and/or vocalization described with respect to FIG. 12). In some embodiments, the one or more keywords includes learned phrases that the subject is likely to utter during a fall and/or after the fall.

In some embodiments, the audio associated with the subject is determined to be indicative that the subject has fallen based on comparing a set of one or more audio characteristics (e.g., pitch, tempo, volume, frequency, duration, and/or intensity) of the audio with a set of one or more audio characteristics (e.g., impact sound and/or abrupt noise pattern) associated with a pre-defined fall event (e.g., 1210 and/or as described with respect to FIG. 12). In some embodiments, comparing the set of one or more audio characteristics of the audio with the set of one or more audio characteristics associated with the pre-defined fall event includes using a trained audio model that outputs a likelihood that the audio matches audio characteristics of the pre-defined fall event.

In some embodiments, the device includes (and/or is) a camera (e.g., a periscope camera, a telephoto camera, a wide-angle camera, and/or an ultra-wide-angle camera). In some embodiments, the first position and the second position are detected using the camera (e.g., as described with respect to FIG. 12).

In some embodiments, receiving the first position of the subject at the first time and the second position of the subject at the second time includes receiving sensor data (e.g., video, image, audio, accelerometer data, gyroscope data, and/or motion sensor data) from one or more other devices separate from the device (e.g., as described with respect to FIG. 12). In some embodiments, the sensor data is received from a plurality of devices separate from the device in an environment associated with the subject. In some embodiments, a first portion of the sensor data corresponding to the first position is received from a first other device and a second portion of the sensor data corresponding to the second position is received from a second other device separate from the first other device. In some embodiments, the device selects which of the one or more other devices to receive sensor data from based on proximity to the subject. In some embodiments, a remote device (e.g., server and/or cloud service) selects which of the one or more other devices to receive sensor data from based on proximity to the subject. In some embodiments, the value computed using the acceleration of the set of one or more points is determined using at least a portion of the sensor data from the one or more other devices.

In some embodiments, the threshold is updated based on a previous fall detection event (e.g., as described with respect to FIG. 12). In some embodiments, the threshold used to determine whether the value computed using the acceleration of the set of one or more points between the first position and the second position exceeds the threshold is dynamically updated based on feedback received from the previous fall detection event. In some embodiments, updating the threshold includes adjusting a value of the threshold by an exponential factor based on whether the previous fall detection event was confirmed or corrected. In some embodiments, the threshold for the acceleration of the set of one or more points is selectively updated while maintaining another set of one or more criteria for fall detection, such as audio detection and/or object detection.

Note that details of the processes described above with respect to process 1800 (e.g., FIG. 18) are also applicable in an analogous manner to other processes described herein. For example, process 2100 optionally includes one or more of the characteristics of the various processes described above with reference to process 1800. For example, receiving the first position and the second position in process 1800 can use the deblurred content of process 2100. For brevity, these details are not repeated herein.

FIG. 19 is a flow diagram illustrating a process (e.g., process 1900) for selectively using an object for detecting a fall of a subject in accordance with some embodiments. Some operations in process 1900 are, optionally, combined, the orders of some operations are, optionally, changed, and some operations are, optionally, omitted.

As described below, process 1900 provides an intuitive way for selectively using an object for detecting a fall of a subject in accordance with some embodiments. Process 1900 reduces the cognitive burden on a user, thereby creating a more efficient human-machine interface. For battery-operated computing devices, enabling a user to interact with such devices faster and more efficiently conserves power and increases the time between battery charges.

In some embodiments, process 1900 is performed at a device (e.g., a computer system, a sensor device, a sender device, and/or an electronic device) including (and/or in communication with) one or more sensors (e.g., a camera, a microphone, a gyroscope, heartrate sensor, light sensor, infrared sensor, ultrasonic sensor, touch sensor, accelerometer, and/or a temperature sensor). In some embodiments, the device is the sensor, such as a camera and/or a microphone. In some embodiments, the device is a watch, a phone, a tablet, a fitness tracking device, a processor, a head-mounted display (HMD) device, a communal device, a media device, a speaker, a television, an electronic device, and/or a personal computing device.

The device receives (1902) an indication (e.g., alert, request, and/or message) of a fall (e.g., sudden pose change, descent to ground, and/or transition from an upright to a horizontal position) of a subject (e.g., a person, an individual, an object, a device, an electronic device, and/or a user) (e.g., as described above with respect to 1208a), wherein the indication of the fall of the subject includes a confidence score (e.g., 0-1 and/or 0-99%) (e.g., as described above with respect to 1208a) associated with (e.g., representing and/or quantifying a probability of) the fall of the subject. In some embodiments, the fall of the subject is determined by another device separate from the device using a machine learning model (e.g., unsupervised learning model, clustering model, distribution learning model, and/or probabilistic model).

The device receives (1904) media content (e.g., image, video, and/or audio) (e.g., as described above with respect to FIG. 12). In some embodiments, the media content is received from another device separate from the device. In some embodiments, the media content is captured by the device, such as via the one or more sensors. In some embodiments, the media content corresponds to (and/or supports) the indication of the fall of the subject.

After (and/or in response to) receiving the media content (and/or after and/or in response to receiving the indication of the fall of the subject), the device detects (1906), via the one or more sensors, an object (e.g., as described above with respect to 1208b) associated with (e.g., near, in contact with, surrounding, underneath, supporting, and/or within a threshold distance of) the subject, wherein the object is separate from the subject. In some embodiments, detecting the object includes using an object detection model (e.g., of a small size) to detect, locate, and/or identify the object. In some embodiments, detecting the object includes classifying the object onto one or more categories (e.g., furniture, support surface, cushioned surface, ground surface, vertical surface, horizontal surface, and/or hard surface). In some embodiments, detecting the object includes processing a region (e.g., of one or more images and/or video frames) around the subject. In some embodiments, detecting the object is not performed without receiving the indication of the fall of the subject. In some embodiments, the object is detected at a starting position of the subject within the fall (e.g., movement and/or change of position) of the subject (and/or at a first time) in the media content. In some embodiments, the object is detected at an ending position, different from the starting position, of the subject within the fall of the subject (and/or at a second time after the first time) in the media content.

After (1908) (and/or in response to) detecting the object associated with the subject (and/or after and/or in response to receiving the media content and/or receiving the indication of the fall of the subject), in accordance with a determination that the object is a first object (e.g., floor, ground, hard surface, and/or non-cushioned surface), the device increases (1910) the confidence score associated with the fall of the subject (e.g., as described above with respect to 1208c). In some embodiments, increasing the confidence score associated with the fall of the subject includes applying a first adjustment factor to the confidence score. In some embodiments, the first adjustment factor is based on a type of movement of the subject associated with the first object. In some embodiments, the first adjustment factor is dynamically adjusted based on feedback associated with previous fall detections.

After (1908) detecting the object associated with the subject, in accordance with a determination that the object is a second object (e.g., bed, couch, and/or soft surface), the device forgoes (1912) increase of (e.g., decreases or maintains) the confidence score associated with the fall of the subject (e.g., as described above with respect to 1208c), wherein the second object is different from the first object. In some embodiments, forgoing increase of the confidence score includes maintaining the confidence score associated with the fall of the subject (e.g., regardless of a detected object). In some embodiments, decreasing the confidence score includes applying a second adjustment factor (e.g., different from the first adjustment factor) to the confidence score. In some embodiments, the second adjustment factor is based on a type of movement of the subject associated with the second object. In some embodiments, the second adjustment factor is dynamically adjusted based on feedback associated with previous fall detections.

In some embodiments, detecting the object associated with (e.g., near, in contact with, surrounding, underneath, supporting, and/or within a threshold distance of) the subject includes detecting, via the one or more sensors, the object at a starting location (e.g., initial location, beginning point, and/or origin) of the subject (e.g., at a first time and/or at a starting time of the fall) (e.g., as described above with respect to 1208b). In some embodiments, detecting the object at the starting location of the subject includes analyzing a first portion (e.g., a starting portion, first segment, initial frame, and/or earlier interval) of the media content. In some embodiments, detecting the object at the starting location of the subject informs the object from which the subject fell.

In some embodiments, detecting the object associated with (e.g., near, in contact with, surrounding, underneath, supporting, and/or within a threshold distance of) the subject includes detecting, via the one or more objects, the object at an ending location (e.g., final location, ending point, and/or landing position) of the subject (e.g., at a second time and/or at an ending time of the fall) (e.g., as described above with respect to 1208b). In some embodiments, detecting the object at the ending location of the subject informs the object onto which the subject fell. In some embodiments, detecting the object at the ending location of the subject corresponds to analyzing a second portion (e.g., an ending portion, last segment, subsequent frame, and/or later interval) of the media content. In some embodiments, detecting the object at the starting location of the subject informs the object that the subject fell and/or landed on.

In some embodiments, after detecting the object associated with the subject, the device detects, via the one or more sensors, another object associated with the subject, wherein the other object is separate from the object (e.g., as described above with respect to 1208b). In some embodiments, detecting the other object includes detecting, using an object detection model (e.g., of a small size) to detect, locate, and/or identify, the second object. In some embodiments, detecting the other object includes classifying the other object into one or more categories (e.g., furniture, support surface, cushioned surface, ground surface, vertical surface, horizontal surface, and/or hard surface). In some embodiments, detecting the other object includes processing a region (e.g., of one or more images and/or video frames) around the subject. In some embodiments, detecting the other object is not performed without receiving the indication of the fall of the subject. In some embodiments, the other object is detected at a starting position of the subject within the fall (e.g., movement and/or change of position) of the subject (and/or at a first time) in the media content. In some embodiments, the other object is detected at an ending position, different from the starting position, of the subject within the fall of the subject (and/or at a second time after the first time) in the media content.

In some embodiments, the object is detected at a first time (e.g., starting time of the fall, initial time in the media content, ending time of the fall, time during the fall, time after the fall, and/or later time in the media content). In some embodiments, the other object is detected at a second time (e.g., starting time of the fall, initial time in the media content, ending time of the fall, time during the fall, time after the fall, and/or later time in the media content) different from the first time (e.g., as described above with respect to 1208b). In some embodiments, the object is detected at a first portion (e.g., starting portion, first segment, initial frame, earlier interval, and/or portion at the first time) of the media content and the other object is detected at a second portion (e.g., ending portion, last segment, subsequent frame, later interval, and/or portion at the second time) of the media content.

In some embodiments, the object is detected at a first location (e.g., starting location of the subject, initial position of the subject, elevated position, standing position, seated position, location above a floor surface, ending location of the subject, final position of the subject, location where the subject landed, horizontal position, and/or location on the floor surface). In some embodiments, the other object is detected at a second location (e.g., starting location of the subject, initial position of the subject, elevated position, standing position, seated position, location above a floor surface, ending location of the subject, final position of the subject, location where the subject landed, horizontal position, and/or location on the floor surface) (e.g., as described above with respect to 1208b) different from the first location.

In some embodiments, after detecting the object associated with the subject and the other object associated with the subject, in accordance with a determination that the object is the first object and the other object is the second object, the device increases the confidence score associated with the fall of the subject (e.g., as described above with respect to 1208c). In some embodiments, after detecting the object associated with the subject and the other object associated with the subject, in accordance with a determination that the object is the second object and the other object is the first object, the device forgoes increase of (e.g., decreases or maintains) the confidence score associated with the fall of the subject (e.g., as described above with respect to 1208c). In some embodiments, the other object is detected at a first time (e.g., before and/or at a start of the fall) and the object is detected at a second time (e.g., during and/or after the fall) after the first time in the media content. In some embodiments, the object is detected at the first time (e.g., before and/or at a start of the fall) and the other object is detected at the second time (e.g., during and/or after the fall) after the first time in the media content. In some embodiments, in accordance with a determination that the object is the first object and the other object is the second object, forgoing increase of (e.g., decreases or maintains) the confidence score associated with the fall of the subject.

In some embodiments, detecting the object associated with the subject includes classifying (e.g., label, categorize, and/or identify) the object using a machine learning model (e.g., object detection model, computer vision model, probabilistic model, and/or neural network) (e.g., as described above with respect to 1208b). In some embodiments, the device classifying the object includes categorizing the object into one or more categories, such as bed, couch, other, soft surface, hard surface, impact surface, and/or non-impact surface. In some embodiments, the device forgoes classifying the object using the machine learning model when the indication of the fall of the subject is not received.

In some embodiments, detecting the object associated with the subject includes processing a region (e.g., area, portion, section, zone and/or boundary) associated (e.g., around, peripherical, and/or surrounding) with the subject (e.g., as described above with respect to 1208b). In some embodiments, the device processes the region associated with the subject based on a detected position and/or location of the subject in the media content. In some embodiments, the device processes the region associated with the subject based on an available compute level, such as processing a smaller region when lower compute is available and processing a larger region when higher compute is available. In some embodiments, the device forgoes processing the region associated with the subject when the indication of the fall of the subject is not received.

In some embodiments, classifying the object using the machine learning model includes identifying (e.g., label, classify, and/or categorize) the object as an object of a first type (e.g., furniture type, surface type, and/or structural element type) (e.g., as described above with respect to 1208b). In some embodiments, the first type is a pre-defined (e.g., pre-determined, fixed, pre-configured and/or non-dynamic) type in a set of one or more pre-defined types (e.g., as described above with respect to 1208b). In some embodiments, the set of one or more pre-defined types is a first set of one or more pre-defined types when the device determines that a first compute level (e.g., lower compute level) is available, such as the first set of one or more pre-defined types including a limited number of pre-defined types (e.g., couch, bed, and/or other). In some embodiments, the set of one or more pre-defined types is a second set of one or more pre-defined types when the device determines that a second compute level (e.g., higher compute level) is available, such as the second set of one or more pre-defined types including a higher number of pre-defined types (e.g., couch, bed, chair, floor, table, hard surface, cushioned surface, soft surface, impact surface, and/or elevated surface). In some embodiments, the device increases the confidence score associated with the fall of the subject based on the object being the first type (e.g., floor, table and/or impact surface). In some embodiments, the device forgoes increase of the confidence score associated with the fall of the subject based on the object being the second type (e.g., couch, bed and/or cushioned surface).

In some embodiments, after receiving the media content and detecting the object associated with the subject, in accordance with a determination that a first set of one or more criteria is satisfied, wherein the first set of one or more criteria includes a criterion that is satisfied when the subject physically moved in a first manner (e.g., slow descent, gradual movement, smooth transition and/or low acceleration movement), wherein the first set of one or more criteria includes a criterion that is satisfied when the object is the first object, the device increases, by a first amount (e.g., lower amount, minimal adjustment and/or conservative increase), the confidence score associated with the fall of the subject (e.g., as described above with respect to 1208c). In some embodiments, after receiving the media content and detecting the object associated with the subject, in accordance with a determination that a second set of one or more criteria is satisfied, wherein the second set of one or more criteria includes a criterion that is satisfied when the subject physically moved in a second manner (e.g., fast descent, abrupt movement, sudden transition, and/or high acceleration movement), wherein the second set of one or more criteria includes a criterion that is satisfied when the object is the second object, the device increases, by a second amount (e.g., higher amount, substantial adjustment, and/or larger increase) different from the first amount, the confidence score associated with the fall of the subject (e.g., as described above with respect to 1208c), wherein the first set of one or more criteria is different from the second set of one or more criteria, and wherein the first manner is different from the second manner. In some embodiments, in response to receiving the media content and detecting the object associated with the subject and in accordance with a determination that a third set of one or more criteria is satisfied, the device increases, by a third amount higher than the first amount, the confidence score associated with the fall of the subject. In some embodiments, the third amount is the second amount. In some embodiments, the third set of one or more criteria includes a criterion that is satisfied when the subject physically moved between the first portion of content and the second portion of content in the second manner. In some embodiments, the third set of one or more criteria includes a criterion that is satisfied when the object is the first object. In some embodiments, in response to receiving the media content and detecting the object associated with the subject and in accordance with a determination that fourth set of one or more criteria is satisfied, the device increases, by a fourth amount lower than the second amount, the confidence score associated with the fall of the subject. In some embodiments, the third amount is the first amount. In some embodiments, the fourth set of one or more criteria includes a criterion that is satisfied when the subject physically moves in the first manner. In some embodiments, the fourth set of one or more criteria includes a criterion that is satisfied when the object is the second object. In some embodiments, in response to receiving the media content and detecting the object associated with the subject and in accordance with a determination that fourth set of one or more criteria is satisfied, the device forgoes increase of the confidence score associated with the fall of the subject.

In some embodiments, after receiving the media content and detecting the object associated with the subject, in accordance with a determination that a fifth set of one or more criteria is satisfied, wherein the fifth set of one or more criteria includes a criterion that is satisfied when the object is the first object, wherein the fifth set of one or more criteria includes a criterion that is satisfied when detecting, via the one or more sensors, a first audio (e.g., impact sound, loud noise, high-intensity sound, and/or abrupt audio pattern) associated with (e.g., near, identified with, and/or temporally aligned with) the object, the device increases, by a first amount, the confidence score associated with the fall of the subject (e.g., as described above with respect to 1210 and/or 1212). In some embodiments, after receiving the media content and detecting the object associated with the subject, in accordance with a determination that a sixth set of one or more criteria is satisfied, wherein the sixth set of one or more criteria includes a criterion that is satisfied when the object is the first object, wherein the sixth set of one or more criteria includes a criterion that is satisfied when detecting, via the one or more sensors, a second audio (e.g., soft sound, low-intensity audio, and/or gradual audio pattern) associated with the object, the device increases, by a second amount different from the first amount, the confidence score associated with the fall of the subject (e.g., as described above with respect to 1210 and/or 1212), wherein the first audio is different from the second audio. In some embodiments, the second amount is lower than the first amount. In some embodiments, in response to receiving the media content and detecting the object associated with the subject and in accordance with a determination that the sixth set of one or more criteria is satisfied, the device forgoes increase of (e.g., decreases and/or maintains) the confidence score associated with the fall of the subject.

In some embodiments, the indication of the fall of the subject is generated based on (e.g., processed from and/or informed by) sensor data (e.g., video, image, audio, accelerometer data, gyroscope data, and/or motion sensor data) from a plurality of devices (e.g., as described above with respect to FIG. 12). In some embodiments, the plurality of devices include the device. In some embodiments, the plurality of devices does not include the device. In some embodiments, the plurality of devices are within an environment of the subject and/or connected to a local area network of the environment of the subject. In some embodiments, the plurality of devices are trusted devices by the subject.

In some embodiments, the indication of the fall of the subject is received from another device (e.g., a camera, a periscope camera, a telephoto camera, a wide-angle camera, and/or an ultra-wide-angle camera) (e.g., as described above with respect to FIG. 12) separate from the device.

In some embodiments, the device includes (and/or is) a camera (e.g., a periscope camera, a telephoto camera, a wide-angle camera, and/or an ultra-wide-angle camera). In some embodiments, the media content is captured via the camera. In some embodiments, the indication that the subject has fallen is determined using media from the camera.

Note that details of the processes described above with respect to process 1900 (e.g., FIG. 19) are also applicable in an analogous manner to other processes described herein. For example, process 2000 optionally includes one or more of the characteristics of the various processes described above with reference to process 1900. For example, determining the level of complexity of the environment in process 2000 can use detecting of the object associated with the subject in process 1900. For brevity, these details are not repeated herein.

FIG. 20 is a flow diagram illustrating a process (e.g., process 2000) for performing motion detection on a device based on environment complexity in accordance with some embodiments. Some operations in process 2000 are, optionally, combined, the orders of some operations are, optionally, changed, and some operations are, optionally, omitted.

As described below, process 2000 provides an intuitive way for performing motion detection on a device based on environment complexity in accordance with some embodiments. Process 2000 reduces the cognitive burden on a user, thereby creating a more efficient human-machine interface. For battery-operated computing devices, enabling a user to interact with such devices faster and more efficiently conserves power and increases the time between battery charges.

In some embodiments, process 2000 is performed at a device (e.g., a computer system, a sensor device, a sender device, and/or an electronic device). In some embodiments, the device is and/or includes a sensor, such as a camera and/or a microphone. In some embodiments, the device is a watch, a phone, a tablet, a fitness tracking device, a processor, a head-mounted display (HMD) device, a communal device, a hub device, a resident device, a media device, a speaker, a television, an electronic device, and/or a personal computing device.

The device receives (2002) media content (e.g., image, video, and/or audio) (e.g., media content described with respect to FIG. 16) corresponding to an environment (e.g., environment described with respect to FIG. 16). In some embodiments, the media content is received from another device separate from the device. In some embodiments, the media content is captured by the device, such as via one or more sensors. In some embodiments, the media content corresponds to (and/or represents) a field-of-view of a device (e.g., the device or another device separate from the device). In some embodiments, the environment is a room, an area, and/or a zone in a home or establishment. In some embodiments, the environment includes one or more subjects (e.g., user, person, object, another device separate from the device, and/or animal).

In response to (2004) receiving the media content corresponding to (e.g., representing and/or capturing) the environment, in accordance with a determination that the environment has a first level of complexity (e.g., lower complexity environment described with respect to FIG. 16), the device locally detects (2006) motion (e.g., 1604) (e.g., motion detection of a subject within the environment, pose detection of the subject, and/or object detection of one or more objects surrounding the subject) in the environment. In some embodiments, locally detecting motion in the environment includes performing (e.g., executing and/or running) a motion operation on the device (and/or without performing another motion operation on another device different from the device). In some embodiments, motion is locally detected in the environment using or based on the media content. In some embodiments, the determination that the environment has the first level of complexity is based on the media content. In some embodiments, the determination that the environment has the first level of complexity includes a determination that a number of subjects detected in the environment is under a threshold number (e.g., 1-10 or 10-20). In some embodiments, the determination that the environment has the first level of complexity includes a determination that a distance between one or more subjects detected in the environment is above a threshold distance (e.g., 0-2 feet), such as a non-zero or positive distance. In some embodiments, the determination that the environment has the first level of complexity includes a determination that the media content does not includes a threshold amount (e.g., 0-60%) of blurred portions.

In response to (2004) receiving the media content corresponding to the environment, in accordance with a determination that the environment has a second level of complexity (e.g., higher complexity environment described with respect to FIG. 16), the device remotely detects (2008) (e.g., via another device different from the device) motion (e.g., 1608 and/or 1610) in the environment, wherein the first level of complexity is different from (e.g., a greater level than) the second level of complexity. In some embodiments, remotely detecting motion in the environment includes performing (e.g., executing and/or running) a motion operation on another device (e.g., computer system, server, cloud-based device, and/or electronic device) separate from the device. In some embodiments, motion is remotely detected in the environment using or based on the media content. In some embodiments, the determination that the environment has the second level of complexity is based on the media content. In some embodiments, the determination that the environment has the second level of complexity includes a determination that a number of subjects detected in the environment is above the threshold number. In some embodiments, the determination that the environment has the second level of complexity includes a determination that a distance between one or more subjects detected in the environment is under the threshold distance. In some embodiments, the determination that the environment has the second level of complexity includes a determination that the media content includes the threshold amount of blurred portions.

In some embodiments, the determination that the environment has the first level of complexity includes a determination that the environment (e.g., the media content and/or an image of the environment and/or a field-of-view of an area, room, and/or zone within the environment) has (and/or includes) a first number of subjects (e.g., 0-10). In some embodiments, the determination that the environment has the second level of complexity includes a determination that the environment (e.g., the media content and/or an image of the environment and/or a field-of-view of an area, room, and/or zone within the environment) has (and/or includes) a second number of subjects (e.g., more than 10). In some embodiments, the second number of subjects is different from the first number of subjects (e.g., as described with respect to FIG. 16). In some embodiments, a subject is a user, a person, an object, another device separate from the device, and/or an animal. In some embodiments, the determination that the environment has the first number of subjects includes a determination that the environment has a first number of a particular type of subject (e.g., people, occluding objects, and/or objects less than a particular size). In some embodiments, the determination that the environment has the second number of subjects includes a determination that the environment has a second number of the particular type of subject. In some embodiments, the second number of the particular type of subject is different from the first number of the particular type of subject.

In some embodiments, the determination that the environment has the first level of complexity includes a determination that a first number of subjects (e.g., 0-10) are overlapping at least one subject. In some embodiments, the determination that the environment has the second level of complexity includes a determination that a second number of subjects (e.g., more than 10) are overlapping at least one subject. In some embodiments, the second number of subjects is different from the first number of subjects (e.g., as described with respect to FIG. 16). In some embodiments, an overlap between a subject and another subject includes a negative distance between a first bounding area corresponding to (e.g., of and/or representing) the subject and a second bounding area corresponding to the other subject. In some embodiments, an overlap between a subject and another subject includes a visual overlap detected by the device in a field-of-view of the environment. In some embodiments, an overlap between a subject and another subject includes a physical overlap between the subject and the other subject.

In some embodiments, the determination that the environment has the first level of complexity includes a determination that a subject is a first distance (e.g., 0-2 feet) from another subject. In some embodiments, the determination that the environment has the second level of complexity includes a determination that a subject is a second distance (e.g., more than 2 feet) from another subject. In some embodiments, the second distance is different from (e.g., greater or less than) the first distance (e.g., positive and negative distances between subjects described with respect to FIG. 16). In some embodiments, the first distance is above a distance threshold (e.g., 0-10 feet) and the second distance is below the distance threshold. In some embodiments, the first distance is a positive distance and the second distance is a negative distance (e.g., representing an overlap between the fifth subject and the sixth subject). In some embodiments, the determination that the environment has the first level of complexity includes a determination based on distance between subjects. In some embodiments, the determination that the environment has the second level of complexity includes a determination based on distance between subjects.

In some embodiments, the determination that the environment has the first level of complexity includes a determination that the environment (e.g., the media content and/or an image of the environment and/or a field-of-view of an area, room, and/or zone within the environment) has (and/or includes) a first audio level (e.g., volume, intensity, and/or complexity and/or overlap of audio signals). In some embodiments, the determination that the environment has the second level of complexity includes a determination that the environment has (and/or includes) a second audio level. In some embodiments, the first audio level is different from (e.g., lower, includes less one or more audio signals, and/or is from different and/or a smaller number of audio sources) the second audio level. In some embodiments, locally detecting motion and remotely detecting motion is based on an image (e.g., video frame, video segment, image extracted from video stream) of the media content (e.g., as described with respect to FIG. 16). In some embodiments, the determination that the environment has the first level of complexity and the determination that the environment has the second level of complexity is based on an audio portion of the media content while the device locally or remotely detecting motion is based on an image portion of the media content.

In some embodiments, the device receives new media content (e.g., image, video, and/or audio). In some embodiments, the new media content is received from another device separate from the device. In some embodiments, the new media content is captured by the device, such as via one or more sensors. In some embodiments, the new media content corresponds to (and/or represents) a field-of-view of the device or another device separate from the device. In some embodiments, the new media content is the media content. In some embodiments, the new media content is different and/or separate from the media content. In some embodiments, in response to receiving the new media content, in accordance with a determination that a first level of compute (and/or resources, such as power, processing, workload level, CPU bandwidth, memory bandwidth, and/or network bandwidth) (e.g., higher compute and/or moderate compute described with respect to FIG. 16) is currently available on the device, the device locally detects motion. In some embodiments, locally detecting motion in the environment requires a compute level that is below a particular level of compute currently available on the device. In some embodiments, in response to receiving the new media content, in accordance with a determination that a second level of compute (and/or resources, such as power, processing, workload level, CPU bandwidth, memory bandwidth, and/or network bandwidth) (e.g., limited compute described with respect to FIG. 16) is currently available on the device, the device remotely detects motion, wherein the second level of compute is lower than the first level of compute. In some embodiments, remotely detecting motion uses a first set of one or more motion detection techniques and locally detecting motion uses a second set of one or more motion detection techniques. In some embodiments, the first set of one or more motion detection techniques is different from the second set of one or more motion detection techniques. In some embodiments, the first set of one or more motion detection techniques is the same as the second set of one or more motion detection techniques.

In some embodiments, the device receives new media content (e.g., image, video, and/or audio). In some embodiments, the new media content is received from another device separate from the device. In some embodiments, the new media content is captured by the device, such as via one or more sensors. In some embodiments, the new media content corresponds to (and/or represents) a field-of-view of the device or another device separate from the device. In some embodiments, the new media content is the media content. In some embodiments, the new media content is different and/or separate from the media content. In some embodiments, in response to receiving the new media content, in accordance with a determination that a first level of compute (and/or resources, such as power, processing, workload level, CPU bandwidth, memory bandwidth, and/or network bandwidth) is currently available on the device, the device detects (e.g., locally or remotely detects) motion in a first manner (e.g., performing first position detection described with respect to FIG. 16). In some embodiments, detecting motion in the first manner includes using a first set of one or more motion detection techniques, such as using bounding area-based pose detection, key points-based pose detection, and/or object detection. In some embodiments, in response to receiving the new media content, in accordance with a determination that a second level of compute (and/or resources, such as power, processing, workload level, CPU bandwidth, memory bandwidth, and/or network bandwidth) is currently available on the device, the device detects (e.g., locally or remotely detects) motion in a second manner (e.g., performing second position detection described with respect to FIG. 16) different from the first manner, and wherein the second level of compute is lower than the first level of compute. In some embodiments, detecting motion in the second manner includes using a second set of one or more motion detection techniques different from the first set of one or more motion detection techniques, such as using bounding area-based pose detection, key points-based pose detection, and/or object detection.

In some embodiments, the device receives new media content (e.g., image, video, and/or audio). In some embodiments, the new media content is received from another device separate from the device. In some embodiments, the new media content is captured by the device, such as via one or more sensors. In some embodiments, the new media content corresponds to (and/or represents) a field-of-view of the device or another device separate from the device. In some embodiments, the new media content is the media content. In some embodiments, the new media content is different and/or separate from the media content. In some embodiments, in response to receiving the new media content, in accordance with a determination that the new media content includes a portion with a first amount of blur (e.g., first amount of distortion, pixelation, diffusion, anonymization, transformation, masking, and/or obfuscation) (e.g., smaller and/or less intense blurred area described with respect to FIG. 16), the device locally detects motion. In some embodiments, the portion is an image, a video fragment, and/or segment extracted from the new media content at a point in time of the media content. In some embodiments, in response to receiving the new media content, in accordance with a determination that the new media content includes a portion with a second amount of blur (e.g., second amount of distortion different from the first amount of distortion, second amount of pixelation different from the first amount of pixelation, second amount of diffusion different from the first amount of diffusion, first amount of anonymization different from the first amount of anonymization, first amount of transformation different from the first amount of transformation, first amount of masking different from the first amount of masking, and/or first amount of obfuscation different from the first amount of obfuscation) (e.g., larger and/or more intense blurred area described with respect to FIG. 16), the device remotely detects motion, wherein the first amount of blur is different from (e.g., lower than, smaller than, less intense than, and/or less significant than) the second amount of blur.

In some embodiments, locally detecting motion uses a first pose detection technique (e.g., tier one, tier two, and/or tier three position detection techniques described with respect to FIG. 16) corresponding to (e.g., of, representing, identifying, and/or indicating motion of) a subject. In some embodiments, remotely detecting motion uses a second pose detection technique (e.g., tier one, tier two, and/or tier three position detection techniques described with respect to FIG. 16) corresponding to a subject. In some embodiments, the first pose detection technique is different from the second pose detection technique. In some embodiments, the first pose detection technique compares a first bounding area of a subject at a first time and a second bounding area of the subject at a second time different from the first time. In some embodiments, the second pose detection technique compares a first set of one or more key points of a subject at a first time and a second set of one or more key points of the subject at a second time different from the first time. In some embodiments, the first pose detection technique and the second pose detection technique use a different set of one or more key points corresponding to (e.g., on, on a representation of, contouring, and/or marking and/or identifying body parts of) a subject for identifying a pose (e.g., standing, sitting, lying, vertical position, and/or horizontal position) of the subject. In some embodiments, the first pose detection technique uses a first number of one or more key points (e.g., 8-17) corresponding to a subject and the second pose detection technique uses a second number of one or more key points (e.g., 17-33) corresponding to the subject. In some embodiments, the first number of one or more key points is lower than the second number of one or more key points. In some embodiments, the first number of one or more key points is the same as the second number of one or more key points.

In some embodiments, remotely detecting motion in the environment uses object detection. In some embodiments, locally detecting motion does not use object detection (e.g., 1606e or 1610c). In some embodiments, using object detection includes detecting an object surrounding a subject in the environment. In some embodiments, using object detection includes increasing a confidence score of detected motion (e.g., locally detected motion or remotely detected motion) when an object surrounding the subject is an object of a first type (e.g., floor and/or hard surface). In some embodiments, using object detection includes decreasing or maintaining the confidence score of detected motion (e.g., locally detected motion or remotely detected motion) when the object surrounding the subject is an object of a second type different from the first type (e.g., couch, bed, and/or soft surface).

In some embodiments, after detecting motion (e.g., locally and/or remotely) in the environment, the device sends, to another device (e.g., computer system, electronic device, phone, tablet, watch, resident device, personal computing device, and/or server) different from the device, an indication of motion detection (e.g., 1612). In some embodiments, sending the indication of motion detection to the other device includes sending a notification and/or alert (e.g., including a type, time, trajectory of motion, and/or indication of the environment where motion was detected) to a trusted contact corresponding to the other device. In some embodiments, sending the indication of motion detection to the other device includes sending an alert to emergency services when detected motion corresponds to a fall event and/or irregular motion pattern.

In some embodiments, remotely detecting motion includes sending, to another device (e.g., cloud, server, and/or remote compute system) different from the device, the media content (e.g., sending the media content for remote motion detection described with respect to FIG. 16).

In some embodiments, before sending the media content, the device anonymizes (e.g., blur, distort, diffuse, transform, mask, and/or obfuscate) a portion of the media content (e.g., blurring a portion of the media content and sending the media content for remote motion detection described with respect to FIG. 16). In some embodiments, the portion of the media content includes an identifying portion of a subject, such as a face and/or body portion that can recognize a subject and/or distinguish a subject from a set of subjects.

In some embodiments, locally detecting motion in the environment includes: detecting a subject at a first time; generating (e.g., 1606b), by the device, a first histogram corresponding to the subject at the first time; detecting the subject at a second time after the first time; generating, by the device, a second histogram corresponding to the subject at the second time; and comparing (e.g., 1606c) the first histogram with the second histogram. In some embodiments, the first histogram includes a first set of one or more frequencies of colors corresponding to pixels representing a subject in the environment at the first time. In some embodiments, the second histogram includes a second set of one or more frequencies of colors corresponding to pixels representing the subject in the environment at the second time. In some embodiments, comparing the first histogram with the second histogram includes identifying an overlap, intersection, and/or similarity level between the first set of one or more frequencies of colors and the second set of one or more frequencies of colors. In some embodiments, comparing the first histogram with the second histogram identifies whether the subject is the same subject at the first time and the second time.

In some embodiments, the first histogram is generated using blob detection. In some embodiments, the second histogram is generated using blob detection (e.g., 1606a). In some embodiments, using blob detection includes applying connected component analysis to identify neighboring pixels that belong to a single object. In some embodiments, using blob detection includes applying framewise subtraction for identifying a contour of a subject by separating the contour of the subject from a background. In some embodiments, generating the first histogram corresponding to the subject at the first time includes identifying a first blob corresponding to the subject at the first time. In some embodiments, generating the second histogram corresponding to the subject at the second time includes identifying a second blob corresponding to the subject at the second time. In some embodiments, the first histogram includes a third set of one or more frequencies of colors of the first blob. In some embodiments, the second histogram includes a fourth set of one or more frequencies of colors of the second blob.

In some embodiments, the first histogram with the second histogram are compared using direction of movement of the subject between the first time to the second time (e.g., selecting which histograms to compare based on which direction that the movement is determined described with respect to FIG. 16). In some embodiments, using direction of movement of the subject includes applying a Kalman filter to track velocity and/or direction of the subject for predicting a next position of the subject. In some embodiments, using direction of movement of the subject reduces computational complexity by limiting histogram comparisons to predicted regions.

Note that details of the processes described above with respect to process 2000 (e.g., FIG. 20) are also applicable in an analogous manner to other processes described herein. For example, process 1900 optionally includes one or more of the characteristics of the various processes described above with reference to process 2000. For example, none. For brevity, these details are not repeated herein.

FIG. 21 is a flow diagram illustrating a process (e.g., process 2100) for performing position detection of a subject based on a blurred portion in media content in accordance with some embodiments. Some operations in process 2100 are, optionally, combined, the orders of some operations are, optionally, changed, and some operations are, optionally, omitted.

As described below, process 2100 provides an intuitive way for performing position detection of a subject based on a blurred portion in media content in accordance with some embodiments. Process 2100 reduces the cognitive burden on a user, thereby creating a more efficient human-machine interface. For battery-operated computing devices, enabling a user to interact with such devices faster and more efficiently conserves power and increases the time between battery charges.

In some embodiments, process 2100 is performed at a device (e.g., a computer system, a server, a sensor device, and/or an electronic device). In some embodiments, the device is and/or includes a sensor, such as a camera and/or a microphone. In some embodiments, the device is a watch, a phone, a tablet, a fitness tracking device, a processor, a head-mounted display (HMD) device, a communal device, a hub device, a resident device, a media device, a speaker, a television, an electronic device, and/or a personal computing device.

The device receives (2102) media content (e.g., image, video, and/or audio). In some embodiments, the media content is received from another device separate from the device. In some embodiments, the media content is captured by the device, such as via one or more sensors. In some embodiments, the media content corresponds to (and/or represents) a field-of-view of a device (e.g., the device or another device separate from the device).

In response to receiving the media content, the device deblurs (2104) (e.g., reconstruct, restore, remove pixelation, denoise, and/or deanonymize) the media content to generate deblurred content (e.g., 1610a) such that: (2106) in accordance with a determination that a first portion of the media content is blurred (e.g., distorted, pixelated, diffused, anonymized, fuzzed, transformed, masked, and/or obfuscated) (e.g., 1706), deblurring the first portion of the media content; and in accordance with (2108) a determination that a second portion of the media content is blurred (e.g., 1706), deblurring the second portion of the media content (e.g., without deblurring the first portion of the media content), wherein the first portion of the media content is separate from the second portion of the media content. In some embodiments, the first portion of the media content includes a portion (e.g., partial representation, identifying section, and/or body part) of one or more subjects, such as a face of a person and/or a portion of an object near the person. In some embodiments, the first portion of the media content being blurred anonymizes an identity of a subject. In some embodiments, the first portion of the media content being deblurred is used for identifying a pose (e.g., standing, sitting, lying, horizontal orientation, or vertical orientation) of a subject. In some embodiments, the second portion of the media content includes a portion (e.g., partial representation, identifying section, and/or body part) of one or more subjects, such as a face of a person and/or a portion of an object near the person. In some embodiments, the second portion of the media content being blurred anonymizes an identity of a subject. In some embodiments, the second portion of the media content being deblurred is used for identifying a pose (e.g., standing, sitting, lying, horizontal orientation, or vertical orientation) of a subject.

After deblurring the media content, the device identifies (2110), using the deblurred content, a pose of a subject (e.g., user, person, object, another device separate from the device, and/or animal) (e.g., 1610b). In some embodiments, identifying the pose of the subject includes identifying a first set of one or more key points (e.g., eyes, nose, and/or head) of the subject and using the first set of one or more key points of the subject for identifying another set of one or more key points (e.g., torso, knee, foot, ankle, leg, torso, shoulder, elbow, wrist, arm, hand, and/or neck) of the subject. In some embodiments, the first portion of the media content includes a first portion (e.g., head, face, torso, knee, foot, ankle, leg, torso, shoulder, elbow, wrist, arm, hand, and/or neck) corresponding to (e.g., of and/or representing) the subject and the second portion of the media content includes a second portion (e.g., head, face, torso, knee, foot, ankle, leg, torso, shoulder, elbow, wrist, arm, hand, and/or neck) corresponding to the subject. In some embodiments, the first portion of the media content includes a portion corresponding to the subject and the second portion of the media content does not include a portion corresponding to the subject. In some embodiments, the second portion of the media content includes a portion corresponding to the subject and the first portion of the media content does not include a portion corresponding to the subject.

In some embodiments, the first portion of the media content is deblurred without deblurring another portion (e.g., a portion that is not blurred) of the media content different form the first portion. In some embodiments, the second portion of the media content is deblurred without deblurring another portion (e.g., a portion that is not blurred) of the media content different from the second portion (e.g., as described with respect to FIGS. 16 and 17). In some embodiments, in response to receiving the media content and in accordance with a determination that the media content includes a plurality of blurred portions (e.g., face, torso, and/or plurality of subjects), the device deblurs the plurality of blurred portions.

In some embodiments, identifying, using the deblurred content, the pose of the subject includes: identifying a plurality of key points (e.g., 1710a and/or 1710b) corresponding to (e.g., of an eye region, a facial landmark, and/or an edge-detected feature of) the subject within the deblurred content; and averaging locations of the plurality of key points (e.g., landmark and/or coordinate) corresponding to the subject to generate a single location (e.g., 1712a) corresponding to the plurality of key points. In some embodiments, averaging the plurality of key points includes identifying an average point across an x-axis between the plurality of key points. In some embodiments, averaging the plurality of key points includes generating a first key point of a first set of one or more key points for identifying the pose of the subject. In some embodiments, the plurality of key points includes two key points corresponding to eyes (e.g., left eye and right eye) of the subject. In some embodiments, the plurality of key points is identified using blob and/or edge detection (e.g., Canny edge detection, Sobel operators, and/or Gaussian filters) on the deblurred content. In some embodiments, the plurality of key points is identified when a respective portion (e.g., the first portion or the second portion) of the media content is blurred above a threshold level of blur and/or when the respective portion of the media content has a size above a threshold size.

In some embodiments, identifying, using the deblurred content, the pose of the subject includes: after averaging the locations of the plurality of key points corresponding to the subject to generate the single location corresponding to the plurality of key points, identifying a set of one or more other key points (e.g., landmark and/or coordinate) (e.g., 1712b-1712o) for identifying the pose of the subject. In some embodiments, the pose of the subject includes the single location and the set of one or more other key points. In some embodiments, the first set of one or more other key points is identified in an unblurred portion of the media content. In some embodiments, the first set of one or more other key points includes one or more of a torso, knee, ankle, hip, shoulder, elbow, arm, wrist, hand, and/or neck key points of a body of the subject.

In some embodiments, identifying, using the deblurred content, the pose of the subject includes identifying a single key point (e.g., 1704a) corresponding to (e.g., of an eye region, a facial landmark, and/or an edge-detected feature of) the subject within the deblurred content (e.g., without identifying another key point within the deblurred content and/or without identifying another key point within the deblurred content that is used as a point of the pose of the subject). In some embodiments, the single key point is identified when a respective portion (e.g., the first portion or the second portion) of the media content is blurred below a threshold level of blur and/or when the respective portion of the media content has a size below a threshold size. In some embodiments, the single key point corresponds to a facial landmark of the subject, such as a nose position. In some embodiments, identifying the single key point includes identifying a first key point of a second set of one or more key points for identifying the pose of the subject.

In some embodiments, identifying, using the deblurred content, the pose of the subject includes, after identifying the single key point corresponding to the subject within the deblurred content, identifying a set of one or more other key points (e.g., landmark and/or coordinate) (e.g., 1704b-1704o) for identifying the pose of the subject. In some embodiments, the set of one or more other key points is identified in an unblurred portion of the media content. In some embodiments, the set of one or more other key points includes one or more of a torso, knee, ankle, hip, shoulder, elbow, arm, wrist, hand, and/or neck key points of a body of the subject.

In some embodiments, after deblurring the media content and identifying, using the deblurred content, the pose of the subject: identifying another subject in the media content (e.g., performing object detection described with respect to FIG. 16), wherein the other subject is different from the subject; and using the identification of the other subject and the pose of the subject to perform fall detection corresponding to (e.g., of and/or relating to) the subject (e.g., as described with respect to FIG. 16). In some embodiments, the other subject is an object, such as furniture and/or household object. In some embodiments, identifying the other subject includes classifying the other subject into one or more categories, such as bed, couch, soft surface, hard surface, and/or other. In some embodiments, identifying the other subject includes identifying the other subject at a first time, such as at a start of a fall of the subject, and/or at a second time after the first time, such as at an end of a fall of the subject. In some embodiments, using the identification of the other subject includes increasing and/or decreasing a likelihood of a fall corresponding to the subject based on a category of the other subject. In some embodiments, using the pose of the subject includes identifying a change in a pose of the subject at a third time, such as at a start of a fall of the subject, and at a fourth time after the third time, such as at an end of a fall of the subject. In some embodiments, using the identification of the other subject and the pose of the subject provides a combination of signals for identifying a confidence score of performing fall detection corresponding to the subject.

In some embodiments, the deblurred content is generated by deblurring using a stable diffusion model (e.g., facial region being unblurred using a stable diffusion model described with respect to FIG. 16). In some embodiments, the stable diffusion model deblurs and/or denoises a blurred portion (e.g., the first portion or the second portion) of content to reveal a facial structure and/or landmark of the subject (e.g., eyes, nose, mouth, and/or distance between facial elements). In some embodiments, the stable diffusion model executes and/or runs on another device separate from the device, such as a cloud server. In some embodiments, the stable diffusion model executes and/or runs on the device. In some embodiments, the stable diffusion model is only applied to a blurred portion (e.g., the first portion or the second portion) of content.

In some embodiments, the pose of the subject corresponds to a first time. In some embodiments, the first time is at a start of a fall of the subject. In some embodiments, after identifying, the device uses the deblurred content, the pose of the subject, detecting, using the pose of the subject, whether the subject has fallen (e.g., as described with respect to FIG. 16). In some embodiments, detecting whether the subject has fallen also uses a pose of the subject at a second time different from the first time. In some embodiments, the second time is at an end of the fall of the subject. In some embodiments, the pose of the subject is used to detect whether the subject has fallen by comparing a first pose of the subject at the first time to a second pose of the subject at the second time. In some embodiments, the pose of the subject is used to detect whether the subject has fallen by identifying a category of the pose of the subject, such as lying, sitting, standing, a horizontal position, vertical position, and/or diagonal position.

In some embodiments, after detecting that the subject has fallen, the device sends, to another device different from the device, an indication (e.g., notification, text, image, video, and/or audio) of fall detection corresponding to the subject (e.g., sending an indication of motion to another device described with respect to FIG. 16). In some embodiments, the indication of the fall detection corresponding to the subject includes one or more portions of the media content. In some embodiments, the other device is a device operated by emergency services. In some embodiments, the other device is operated by a previously configured trusted content of the subject. In some embodiments, the other device is a device connected to a same local network and/or user account corresponding to the subject.

Note that details of the processes described above with respect to process 2100 (e.g., FIG. 21) are also applicable in an analogous manner to the processes described herein. For example, process 2000 optionally includes one or more of the characteristics of the various processes described herein with reference to process 2100. For example, deblurring the media content in process 2100 can use the determination of the level of complexity of the environment in process 2000. For brevity, these details are not repeated herein.

In some embodiments, one or more of processes 300, 400, 500, 1100, 1800, 1900, 2000, and 2100 (FIGS. 3-5, FIG. 11, and FIGS. 18-21) is performed at a first computer system (as described herein) via a system process (e.g., an operating system process and/or a server system process) that is different from one or more applications executing and/or installed on the first computer system.

In some embodiments, one or more of processes 300, 400, 500, 1100, 1800, 1900, 2000, and 2100 (FIGS. 3-5, FIG. 11, and FIGS. 18-21) is performed at a first computer system (as described herein) by an application that is different from a system process.

In some embodiments, the instructions of the application, when executed, control the first computer system to perform one or more of processes 300, 400, 500, 1100, 1800, 1900, 2000, and 2100 (FIGS. 3-5, FIG. 11, and FIGS. 18-21) by calling an application programming interface (API) provided by the system process. In some embodiments, the application performs at least a portion of one or more of processes 300, 400, 500, 1100, 1800, 1900, 2000, and 2100 (FIGS. 3-5, FIG. 11, and FIGS. 18-21) without calling the API.

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, the application is an application that is pre-installed on the first computer system at purchase (e.g., a first party application). In some embodiments, the application is an application that is provided to the first computer system via an operating system update file (e.g., a first party application). In some embodiments, the application is an application that is provided via an application store. In some embodiments, the application store is pre-installed on the first computer system at purchase (e.g., a first party application store) and allows download of one or more applications. In some embodiments, the application store is a third party application store (e.g., an application store that is provided by another device, downloaded via a network, and/or read from a storage device). In some embodiments, the application is a third party application (e.g., an app that is provided by an application store, downloaded via a network, and/or read from a storage device). In some embodiments, the application controls the first computer system to perform one or more of processes 300, 400, 500, 1100, 1800, 1900, 2000, and 2100 (FIGS. 3-5, FIG. 11, and FIGS. 18-21) by calling an application programming interface (API) provided by the system process using one or more parameters.

In some embodiments, at least one API is a software module (e.g., a collection of computer-readable instructions) that provides an interface that allows a different set of instructions (e.g., API calling instructions) to access and use one or more functions, processes, procedures, data structures, classes, and/or other services provided by a set of implementation instructions of the system process. The API can define one or more parameters that are passed between the API calling instructions and the implementation instructions.

As described above, in some embodiments, an application controls a computer system to perform processes 300, 400, 500, 1100, 1800, 1900, 2000, and 2100 (FIGS. 3-5, FIG. 11, and FIGS. 18-21) by calling an application programming interface (API) provided by a system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, API 176 defines a first API call that can be provided by API calling instructions 174, wherein the definition for the first API call specifies call parameters described above with respect to processes 300, 400, 500, 1100, 1800, 1900, 2000, and 2100 (FIGS. 3-5, FIG. 11, and FIGS. 18-21).

In some embodiments, API 176 defines a first API call response that can be provided to an application by API calling instructions 174, wherein the first API call response includes parameters described above with respect to processes 300, 400, 500, 1100, 1800, 1900, 2000, and 2100 (FIGS. 3-5, FIG. 11, and FIGS. 18-21).

In some embodiments, the set of implementation instructions is a system software module (e.g., a collection of computer-readable instructions) that is constructed to perform an operation in response to receiving an API call via the API. In some embodiments, the set of implementation instructions is constructed to provide an API response (via the API) as a result of processing an API call.

In some embodiments, the set of implementation instructions is included in the device (e.g., 168) that runs the application. In some embodiments, the set of implementation instructions is included in an electronic device that is separate from the device that runs the application.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the techniques and their practical applications. Others skilled in the art are thereby enabled to best utilize the techniques and various examples with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

In some embodiments, content is automatically generated by one or more computer systems in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user. An AI process that generates generative content is sometimes referred to as a generative AI process.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly, a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example, when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other embodiments, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some embodiments, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

As described above, one aspect of the present technology is the gathering and use of data available from various sources to improve how a computer system manages sensor data. The present disclosure contemplates that in some instances, this gathered data can include personal information data that uniquely identifies or can be used to contact or locate a specific person. Such personal information data can include demographic data, location-based data, telephone numbers, email addresses, home addresses, or any other identifying information.

The present disclosure recognizes that the use of such personal information data, in the present technology, can be used to the benefit of users. For example, the personal information data can be used to change how a computer system manages sensor data. Accordingly, use of such personal information data enables better user interactions. Further, other uses for personal information data that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of image capture, the present technology can be configured to allow users to select to “opt in” or “opt out” of participation in the collection of personal information data during registration for services.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be displayed to users by inferring location based on non-personal information data or a bare minimum amount of personal information, such as the content being requested by the device associated with a user or other non-personal information.

1.-71. (canceled)

72. A method, comprising:
at a first device:
detecting, using data received from a second device external to the first device, an event;
after detecting, using the data received from the second device, the event, detecting, using data received from a third device external to the first device and the second device, continuation of the event; and
after detecting, using the data received from the third device, the continuation of the event, sending, to a fourth device external to the first device, the second device, and the third device, a notification including an indication of the data received from the second device and the data received from the third device.

73. The method of claim 72, wherein the event is detected using the data received from the second device and data received from a fifth device external to the first device, the second device, the third device, and the fourth device.

74. The method of claim 72, wherein the third device includes one or more cameras, and wherein the data received from the third device includes video captured via the one or more cameras.

75. The method of claim 74, wherein the second device is a first type of device, and wherein the third device is a second type of device different from the first type of device.

76. The method of claim 72, wherein the data received from the third device is first data received from the third device, the method further comprising:
after detecting, using the data received from the second device, the event, detecting, using second data received from the third device, that the event has ended based on a time that the second data has been detected.

77. The method of claim 72, wherein the continuation of the event is detected based on where the third device is located relative to the second device when the data is received from the third device.

78. The method of claim 72, wherein the continuation of the event is detected based on the data received from the third device corresponding to the data received from the second device.

79. The method of claim 78, wherein the continuation of the event is detected when the data received from the third device includes the same person as the data received from the second device.

80. The method of claim 78, wherein the continuation of the event is detected based on the data received from the third device being detected within a predefined period of time from when the data received from the second device is detected.

81. The method of claim 72, wherein the notification includes a list of multiple activities in chronological order.

82. The method of claim 72, wherein the notification includes a portion of the data received from the second device and a portion of the data received from the third device.

83. The method of claim 72, wherein the notification does not include a portion of the data received from the second device nor a portion of the data received from the third device.

84. The method of claim 72, wherein the notification includes:
in accordance with a determination that the event has a first priority, content of a first type; and
in accordance with a determination that the event has a second priority, content of a second type different from the first type, wherein the second priority is different the first priority.

85. The method of claim 72, wherein the notification includes:
in accordance with a determination that the event corresponds to a first subject, content corresponding to the first subject; and
in accordance with a determination that the event corresponds to a second subject, content corresponding to the second subject, wherein the second subject is different the first subject, and wherein the content corresponding to the second subject is different from the content corresponding to the first subject.

86. The method of claim 72, wherein the notification includes:
in accordance with a determination that the data received from the second device is more relevant to the event than the data received from the third device, a portion of the data from the second device; and
in accordance with a determination that the data received from the third device is more relevant to the event than the data received from the second device, a portion of the data from the third device.

87. The method of claim 72, wherein the indication includes a textual representation of an activity performed in the data received from the second device, the data received from the third device, or any combination thereof.

88. The method of claim 72, wherein the event is a first event, the method further comprising:
after sending the notification, detecting, via the second device, the second device, or any combination thereof, an activity being performed in an environment; and
in response to detecting the activity being performed in the environment:
in accordance with a determination that the activity corresponds to the first event, continuing detection of the first event; and
in accordance with a determination that the activity corresponds to a second event, detecting an occurrence of a second event different from the first event.

89. The method of claim 72, further comprising:
in response to detecting, using the data received from the second device, the event:
in accordance with a determination that the event is a first type of event, sending, to the fourth device, a notification corresponding to the event; and
in accordance with a determination that the event is a second type of event, forgoing send of, to the fourth device, the notification corresponding to the event, wherein the second type of event is different from the first type of event.

90. The method of claim 72, wherein the first device is a resident device.

91. The method of claim 72, wherein the first device is a server.

92. The method of claim 72, wherein detecting the continuation of the event includes identifying an object within the data received from the third device that was also identified within the data received from the second device.

93.-96. (canceled)

97. A non-transitory computer-readable storage medium storing one or more programs configured to be executed by one or more processors of a first device, the one or more programs including instructions for:
detecting, using data received from a second device external to the first device, an event;
after detecting, using the data received from the second device, the event, detecting, using data received from a third device external to the first device and the second device, continuation of the event; and
after detecting, using the data received from the third device, the continuation of the event, sending, to a fourth device external to the first device, the second device, and the third device, a notification including an indication of the data received from the second device and the data received from the third device.

98. A first device, comprising:
one or more processors; and
memory storing one or more programs configured to be executed by the one or more processors, the one or more programs including instructions for:
detecting, using data received from a second device external to the first device, an event;
after detecting, using the data received from the second device, the event, detecting, using data received from a third device external to the first device and the second device, continuation of the event; and
after detecting, using the data received from the third device, the continuation of the event, sending, to a fourth device external to the first device, the second device, and the third device, a notification including an indication of the data received from the second device and the data received from the third device.

99.-198. (canceled)
